(19) United States
(12) Patent Application Publication
(10) Pub. No.: US 2016/0335853 A1
(43) Pub. Date: Nov. 17, 2016

(54) GAMING MACHINE CAPABLE OF RUNNING FREE GAME

(71) Applicants: Universal Entertainment Corporation, Tokyo (JP); Aruze Gaming (Hong Kong) Limited, Kowloon (HK)

(72) Inventors: Jun HIRATO, Tokyo (JP); Hiroki MUNAKATA, Tokyo (JP); Hiroki NAKAMURA, Tokyo (JP); Ken YOSHIKAWA, Tokyo (JP)

(21) Appl. No.: 15/150,513

(22) Filed: May 10, 2016

(30) Foreign Application Priority Data
May 12, 2015 (JP) 2015-097763
May 12, 2015 (JP) 2015-097766

(51) Int. Cl. G07F 17/34; G07F 17/32

(52) U.S. Cl. CPC G07F 17/34; G07F 17/3213; G07F 17/3244

(57) ABSTRACT

A gaming machine executes the processes of: accepting the selection of a condition required to start a normal game from plural start conditions by an input device; incrementing the number of game play in a counter corresponding to a selected start condition, at the start of the normal game; awarding a benefit based on the result of the normal game displayed on a display device and the selected start condition; determining whether the number of game play in the counter reaches a threshold game play count, and awarding the right to run the free game for a predetermined number of times when the number of game play reaches the threshold game play count; and in the free game, based on the result of the free game displayed on the display device and the start condition corresponding to the counter reaching the threshold game play count, awarding the benefit.

### CROSS-REFERENCE TO RELATED APPLICATION

This application claims the benefit of Japanese Pat. App. No. 2015-097763, filed on May 12, 2015 and Japanese Pat. App. No. 2015-097766, filed on May 12, 2015 each of which application is incorporated herein by reference in its entirety.

### FIELD OF THE INVENTION

The present invention relates to a gaming machine that yields a rescue award, when a game continues without awarding of any benefit.

### BACKGROUND OF THE INVENTION

Traditionally, in a facility where gaming machines such as slot machines and the like are set up, games are played by betting various types of gaming medium such as a credit and the like in the slot machines. In each slot machine are set a plurality of result determination areas (areas for which determination of win or loss is carried out) on which a bet is placeable, and a benefit (payout) is awarded based on the number of result determination areas on which a bet is placed, the number of bet credits, and the game result (see for example, PTL 1 (Japanese Unexamined Patent Publication No. 2008-229017)).

Further, amongst the slot machines are those configured to perform an awarding (rescue) to the player, when the number of plays of the normal game resulting no benefit reaches a predetermined number (see for example PTL 2 (U.S. Pat. No. 5,910,048)). For example, a free game is awarded or a predetermined amount is paid out when the number of plays of the normal game resulting in no benefit reaches a predetermined value (so-called ceiling number).

### BRIEF SUMMARY OF THE INVENTION

When the free game is awarded as the above-described awarding (rescue), it may lead to unfairness if the rescue is conducted in the same manner no matter whether a betted credit amount is small or large.

For the reason above, an object of the present invention is to provide a gaming machine in which a credit amount betted in a normal game is taken into consideration in a free game which is awarded when games without any benefit are continued.

The present invention relates to a gaming machine including: an input device configured to allow selection of a condition required to start a normal game from plural start conditions;

a display device configured to display a result of the normal game and a result of a free game;
a storage unit configured to store, for the respective start conditions, counters each counting the number of game play incremented at the start of the normal game, and store, for each of the counters,
a threshold game play count indicating how long does it take until awarding of the right to run the free game; and
a controller programmed to execute the processes of:
(1a) accepting the selection of a condition required to start the normal game from the plural start conditions by the input device;
(1b) incrementing the number of game play in the counter corresponding to the start condition selected in the process (1a), at the start of the normal game;
(1c) awarding a benefit based on the result of the normal game displayed on the display device and the start condition selected in the process (1a);
(1d) determining whether the number of game play in the counter reaches the threshold game play count, and awarding the right to run the free game for a predetermined number of times when the number of game play reaches the threshold game play count;
(1e) in the free game, based on the result of the free game displayed on the display device and the start condition corresponding to the counter reaching the threshold game play count in the process (1d), awarding the benefit.

With the arrangement above, at the start of the normal game, the counter corresponding to the selected start condition is incremented, and the right to execute the free game for the predetermined number of times is awarded when the number of game play in the game play counter reaches the threshold game play count. As such, the counters for counting the number of game play are individually set for the respective start conditions, the conditions required for the player to start the normal game are diversified.

In addition to the above, in the free game, the benefit is awarded based on the result of the free game and the start condition corresponding to the counter having reached the threshold game play count. Therefore, because the start condition required to start the normal game is taken into consideration in the benefit in the free game, the player is encouraged to select the start condition required to start the normal game, in consideration of the payout in the free game.

The present invention relates to a gaming machine including: a credit type input device configured to allow betting with plural credit types which are different in a credit amount; a display device configured to display a result of a normal game and a result of a free game by rearranging symbols;

a storage unit configured to store, for the respective credit types, credit type counters each counting the number of game play incremented at the start of the normal game, and store, for each of the credit type counters, a threshold game play count indicating how long does it take until awarding of the right to run the free game; and
a controller programmed to execute the processes of:
(2a) accepting betting with a credit type by the credit type input device;
(2b) at the start of the normal game, incrementing the number of game play in the credit type counter corresponding to the credit type with which the betting is performed in the process (2a);
(2c) awarding a payout based on the result of the normal game displayed on the display device and the credit type with which the betting is performed in the process (2a);
(2d) determining whether the number of game play in the credit type counter reaches the threshold game play count, and awarding the right to run the free game for a predetermined number of times when the number of game play reaches the threshold game play count; and
(2e) in the free game, based on the result of the free game displayed on the display device and the credit type corresponding to the credit type counter reaching the threshold game play count in the process (2d), awarding the payout.

With the arrangement above, at the start of the normal game, the number of game play in the credit type counter corresponding to the credit type with which the betting is performed is incremented, and the right to run the free game for the predetermined number of times is awarded when the number of game play in the credit type counter reaches the threshold game play count. As such, because the credit type counters counting the number of game play are set for the respective credit types, the credit types with which the player places a bet are diversified.

In addition to the above, in the free game, the payout is awarded based on the result of the free game and the credit type corresponding to the credit type counter having reached the threshold game play count. Therefore, because the credit type with which the betting is performed in the normal game is taken into consideration in the payout in the free game, the player is encouraged to select the credit type with which the betting is performed in the normal game, in consideration of the payout in the free game.

In the present invention, the gaming machine is arranged such that,

the controller is programmed to
award the right to run the free game for the predetermined number of times when, in the process (2c), a predetermined condition is satisfied by the result of the normal game displayed on the display device.

According to this arrangement, the free game awarded as a result of the normal game and the free game awarded when the number of game play in the credit type counter reaches the threshold game play count are arranged to be identical. This simplifies the game design and the operation of the gaming machine. Furthermore, because the free game is shared, it is possible for the player to understand the rules of the free game soon.

According to the present invention, the gaming machine is arranged such that, the controller is programmed to further execute the processes of:

(2f) when the number of game play in the credit type counter reaches the threshold game play count, displaying a combination of predetermined symbols on the display device;
(2g) when a predetermined condition is satisfied by the result of the normal game, awarding the right to run the free game for the predetermined number of times; and
(2h) when the predetermined condition is satisfied by the result of the normal game, displaying the combination of the predetermined symbols on the display device.

According to the arrangement above, the combination of the symbols displayed on the display device when the number of game play in the credit type counter reaches the threshold game play count is arranged to be identical with the combination of the symbols displayed on the display device when the predetermined condition is satisfied in the normal game. On this account, when the right to execute the free game is awarded, it is difficult to tell from the outside (according to the combination of the symbols displayed on the display device) whether the right to execute the free game is awarded because the number of game play in the credit type counter reaches the threshold game play count or because the predetermined condition is satisfied as a result of the normal game. Therefore it is difficult to estimate the threshold game play count from the outside, and hence expectations on when the right to execute the free game game is awarded as the number of game play in the credit type counter reaches the threshold game play count are maintained.

According to the present invention, a gaming machine includes: a result determination area input device configured to allow selection of any of result determination areas;

a display device configured to display a result of a normal game and a result of a free game by rearranging symbols in the selected result determination area;
a storage unit configured to store, for the respective result determination areas, result determination area counters each counting the number of game play incremented at the start of the normal game, and store, for each of the result determination area counters, a threshold game play count indicating how long does it take until awarding of the right to run the free game; and
a controller programmed to execute the processes of:
(3a) accepting the selection of a result determination area by the result determination area input device;
(3b) incrementing the number of game play in the result determination area counter corresponding to the result determination area selected in the process (3a), at the start of the normal game;
(3c) on the display device, displaying the result of the normal game by rearranging the symbols in the result determination area selected in the process (3a), and awarding a payout based on the displayed result of the normal game;
(3d) determining whether the number of game play in the result determination area counter reaches the threshold game play count, and awarding the right to run the free game for a predetermined number of times when the number of game play reaches the threshold game play count; and
(3e) in the free game, displaying, on the display device, the result of the free game by rearranging the symbols in the result determination area corresponding to the result determination area counter reaching the threshold game play count in the process (3d), and awarding the payout based on the displayed result of the free game.

According to the arrangement above, in accordance with the start of the normal game, the number of game play of the result determination area counter corresponding to the selected result determination area is incremented, and the right to execute the free game for a predetermined number of times is awarded when the number of game play of the result determination area counter reaches the threshold game play count. As such, because the result determination area counters counting the number of game play are independently set for the respective result determination areas, the result determination areas selectable by the player are diversified.

In the free game, the result of the free game is displayed on the display device by rearranging the symbols in the result determination area corresponding to the result determination area counter reaching the threshold game play count, and the payout is awarded based on the displayed result of the free game. As such, the payout in the free game is influenced by the result determination area selected in the normal game, and hence the player is encouraged to select the result determination area in the normal game, in consideration of the payout in the free game.

In the present invention, the gaming machine is arranged such that, in the process (3c), the controller awards the right to execute the free game for the predetermined number of times, when a predetermined condition is satisfied by the result of the normal game displayed on the display device.

According to this arrangement, the free game awarded as a result of the normal game and the free game awarded when the number of game play in the result determination area counter reaches the threshold game play count are arranged to be identical. This simplifies the game design and the operation of the gaming machine. Furthermore, because the free game is shared, it is possible for the player to understand the rules of the free game soon.

In addition to the above, the gaming machine is arranged such that, the controller is programmed to further execute the processes of:

(3f) displaying a combination of predetermined symbols on the display device when the number of game play in the result determination area counter reaches the threshold game play count;
(3g) awarding the right to execute the free game for the predetermined number of times when a predetermined condition is satisfied by the result of the normal game; and
(3h) displaying the combination of the predetermined symbols on the display device when the predetermined condition is satisfied by the result of the normal game.

According to the arrangement above, the combination of the symbols displayed on the display device when the number of game play in the result determination area counter reaches the threshold game play count is arranged to be identical with the combination of the symbols displayed on the display device when the predetermined condition is satisfied in the normal game. On this account, when the right to execute the free game is awarded, it is difficult to tell from the outside (according to the combination of the symbols displayed on the display device) whether the right to execute the free game is awarded because the number of game play in the result determination area counter reaches the threshold game play count or because the predetermined condition is satisfied as a result of the normal game. Therefore it is difficult to estimate the threshold game play count from the outside, and hence expectations on when the right to execute the free game game is awarded as the number of game play in the result determination area counter reaches the threshold game play count are maintained.

The present invention relates to a gaming machine including: a credit type input device configured to allow betting with plural credit types which are different in a credit amount; a result determination area input device configured to allow selection of any of result determination areas;

a display device configured to display a result of a normal game and a result of a free game by rearranging symbols in the selected result determination area;
a storage unit configured to store, for the respective credit types corresponding to the result determination areas, game play counters each counting the number of game play incremented at the start of the normal game, and store, for each of the game play counters, a threshold game play count indicating how long does it take until awarding of the right to run the free game; and a controller programmed to execute the processes of:
(4a) accepting betting with a credit type by the credit type input device, and accepting the selection of a result determination area by the result determination area input device;
(4b) incrementing the number of game play in the game play counter corresponding to the result determination area and the credit type accepted in the process (4a), at the start of the normal game;
(4c) awarding a payout based on the result of the normal game displayed on the display device and the credit type and the result determination area accepted in the process (4a);
(4d) determining whether the number of game play in the game play counter reaches the threshold game play count, and awarding the right to run the free game for a predetermined number of times when the number of game play reaches the threshold game play count;
(4e) in the free game, awarding a payout based on the result of the free game displayed on the display device and the result determination area and the credit type corresponding to the game play counter reaching the threshold game play count in the process (4d).

According to the arrangement above, in accordance with the start of the normal game, the number of game play in the game play counter corresponding to the selected result determination area and the selected credit type is incremented, and the right to execute the free game for a predetermined number of times is awarded when the number of game play in the game play counter reaches the threshold game play count. As such, because a game play counter for counting the number of game play is independently set for each of the credit types corresponding to the result determination areas, the credit types based on which the player places a bet and the result determination areas selectable by the player are diversified.

In addition to the above, in the free game, a payout is awarded based on a result of the free game and the result determination area and the credit type corresponding to the game play counter having reached the threshold game play count. On this account, because the credit type with which a bet is placed in the normal game and the selected result determination area are taken into consideration in the free game payout, the player is encouraged to select a credit type with which a bet is placed in the normal game and a result determination area, in consideration of the payout in the free game.

According to the present invention, the gaming machine is arranged such that, in the process (4c), the controller awards the right to execute the free game for the predetermined number of times, when a predetermined condition is satisfied by the result of the normal game displayed on the display device.

According to this arrangement, the free game awarded as a result of the normal game and the free game awarded when the number of game play in the game play counter reaches the threshold game play count are arranged to be identical. This simplifies the game design and the operation of the gaming machine. Furthermore, because the free game is shared, it is possible for the player to understand the rules of the free game soon.

According to the present invention, the gaming machine is arranged such that, the controller is programmed to further execute the processes of:

(4f) displaying a combination of predetermined symbols on the display device when the number of game play in the game play counter reaches the threshold game play count;
(4g) awarding the right to execute the free game for the predetermined number of times when a predetermined condition is satisfied by the result of the normal game;
(4h) displaying the combination of the predetermined symbols on the display device when the predetermined condition is satisfied by the result of the normal game.

According to the arrangement above, the combination of the symbols displayed on the display device when the number of game play in the game play counter reaches the threshold game play count is arranged to be identical with the combination of the symbols displayed on the display device when the predetermined condition is satisfied in the normal game. On this account, when the right to execute the free game is awarded, it is difficult to tell from the outside (according to the combination of the symbols displayed on the display device) whether the right to execute the free game is awarded because the number of game play in the game play counter reaches the threshold game play count or because the predetermined condition is satisfied as a result of the normal game. Therefore it is difficult to estimate the threshold game play count from the outside, and hence expectations on when the right to execute the free game game is awarded as the number of game play in the game play counter reaches the threshold game play count are maintained.

According to the present invention, the gaming machine is arranged such that, the controller is programmed to further execute the process of resetting the number of game play in the game play counter reaching the threshold game play count, after the process (4c).

According to this arrangement, when the value of the game play counter reaches the threshold game play count, the right to execute the free game is awarded and only the value of the game play counter having reached the threshold game play count is reset. Values of the game play counters having not yet reached their threshold game play counts are maintained.

This induces the player to select the result determination area and the bet type corresponding to the game play counter which has not yet reached the threshold game play count.

In addition to the above, the present invention relates to a method of controlling a gaming machine including: an input device configured to allow selection of a condition required to start a normal game from plural start conditions;

a display device configured to display a result of the normal game and a result of a free game;
a storage unit configured to store, for the respective start conditions, counters each counting the number of game play incremented at the start of the normal game, and store, for each of the counters, a threshold game play count indicating how long does it take until awarding of the right to run the free game; and
a controller,
the method including, under control of the controller, the steps of:
(1a) accepting the selection of a condition required to start the normal game from the plural start conditions by the input device;
(1b) incrementing the number of game play of the counter corresponding to the start condition selected in the step (1a), at the start of the normal game;
(1c) awarding a benefit based on the result of the normal game displayed on the display device and the start condition selected in the step (1a);
(1d) determining whether the number of game play in the counter reaches the threshold game play count, and awarding the right to run the free game for a predetermined number of times when the number of game play reaches the threshold game play count;
(1e) in the free game, based on the result of the free game displayed on the display device and the start condition corresponding to the counter reaching the threshold game play count in the step (1d), awarding the benefit.

According to the method above, at the start of the normal game, the counter corresponding to the selected start condition is incremented, and the right to execute the free game for the predetermined number of times is awarded when the value of the game play counter reaches the threshold game play count. As such, the counters for counting the number of game play are individually set for the respective start conditions, the conditions required for the player to start the normal game are diversified.

In addition to the above, in the free game, the benefit is awarded based on the result of the free game and the start condition corresponding to the counter having reached the threshold game play count. Therefore, because the start condition required to start the normal game is taken into consideration in the benefit in the free game, the player is encouraged to select the start condition required to start the normal game, in consideration of the payout in the free game.

The present invention relates to a gaming machine including: a result determination area input device configured to allow selection of any of result determination areas;

a display device configured to display a result of a normal game and a result of a free game by rearranging symbols in the result determination area;
a storage unit configured to store, for the respective result determination areas, result determination area counters each counting the number of game play incremented at the start of the normal game, for each of the result determination area counters, a threshold game play count indicating how long does it take until awarding of the right to run the free game,
free game payout rate random determination tables in which payout rates are associated with random determination probabilities, and
a free game payout rate random determination table determination table in which the free game payout rate random determination tables are associated with the result determination areas; and a controller programmed to execute the processes of:
(1a) accepting the selection of a result determination area by the result determination area input device;
(1b) incrementing the number of game play in the result determination area counter corresponding to the result determination area selected in the process (1a), at the start of the normal game;
(1c) on the display device, displaying the result of the normal game by rearranging the symbols in the result determination area selected in the process (1a), and awarding the right to execute the free game when a predetermined condition is satisfied by the displayed result of the normal game;
(1d) determining whether the number of game play in the result determination area counter reaches the threshold game play count, and awarding the right to run the free game for a predetermined number of times when the number of game play reaches the threshold game play count;
(1e) when running the free game awarded in the process (1c), selecting one of the free game payout rate random determination tables based on the result determination area selected in the normal game in which the predetermined condition is satisfied and the free game payout rate random determination table determination table,
and when running the free game awarded in the process (1d), selecting one of the free game payout rate random determination tables based on the result determination area corresponding to the result determination area counter reaching the threshold game play count in the process (1d) and the free game payout rate random determination table determination table;
(1f) based on the free game payout rate random determination table selected in the process (1e), randomly determining the payout rate; and
(1g) running the free game and awarding, as a free game payout, a value calculated by multiplying the payout based on the result of the free game by the payout rate determined in the process (1f).

According to the arrangement above, the free game awarded when a predetermined condition is satisfied in the normal game and the free game awarded when the number of game play in the result determination area counter reaches the threshold game play count are able to share the free game payout rate random determination table for determining the payout rate for multiplication in the free game and the free game payout rate random determination table determination table for determining the free game payout rate random determination table.

On this account, the free game is run on the same conditions irrespective of the way of shifting to the free game (i.e., the free game is enjoyed without feeling the sense of unfairness).

In the present invention, the gaming machine is arranged such that,

the payout rates are provided in stages from a low payout rate to a high payout rate, and
the controller is programmed to further execute the process of
after determining the payout rate in the process (1f), displaying the payout rates step by step on the display device from the low payout rate to the determined payout rate.

According to this arrangement, on the display device, a process that a low payout rate is changed to the determined payout rate is displayed step by step. In this way, an effect that the payout rate progresses is performed. This increases the expectation on the free game payout awarded in the free game.

In the present invention, the gaming machine is arranged such that,

the symbols include plural types of symbols from a symbol corresponding to the low payout rate to a symbol corresponding to the high payout rate, and
the controller is programmed to further execute the process of
after determining the payout rate in the process (1f), changing the type of the symbols from the symbol corresponding to the low payout rate to the symbol corresponding to the determined payout rate.

According to the arrangement above, the type of the symbols is changed from the symbol corresponding to the low payout rate to the symbol corresponding to the determined payout rate. As such, an effect that the symbol corresponding to the payout rate progresses is performed. This increases the expectation on the free game payout awarded in the free game.

The present invention relates to a method of controlling a gaming machine which includes: a result determination area input device configured to allow selection of any of result determination areas;

a display device configured to display a result of a normal game and a result of a free game by rearranging symbols in the result determination area;
a storage unit configured to store, for the respective result determination areas, result determination area counters each counting the number of game play incremented at the start of the normal game;
for each of the result determination area counters, a threshold game play count indicating how long does it take until awarding of the right to run the free game,
free game payout rate random determination tables in which payout rates are associated with random determination probabilities, and
a free game payout rate random determination table determination table in which the free game payout rate random determination tables are associated with the result determination areas; and a controller,
the method comprising, under control of the controller, the steps of:
(1a) accepting the selection of a result determination area by the result determination area input device;
(1b) incrementing the number of game play of the result determination area counter corresponding to the result determination area selected in the step (1a), at the start of the normal game;
(1c) on the display device, displaying the result of the normal game by rearranging the symbols in the result determination area selected in the step (1a), and awarding the right to execute the free game when a predetermined condition is satisfied by the displayed result of the normal game;
(1d) determining whether the number of game play in the result determination area counter reaches the threshold game play count, and awarding the right to run the free game for a predetermined number of times when the number of game play reaches the threshold game play count;
(1e) when running the free game awarded in the step (1c), selecting one of the free game payout rate random determination tables based on the result determination area selected in the normal game in which the predetermined condition is satisfied and the free game payout rate random determination table determination table, and
when running the free game awarded in the step (1d), selecting one of the free game payout rate random determination tables based on the result determination area corresponding to the result determination area counter reaching the threshold game play count in the step (1d) and the free game payout rate random determination table determination table;
(1f) based on the free game payout rate random determination table selected in the step (1e), randomly determining the payout rate; and
(1g) running the free game and awarding, as a free game payout, a value calculated by multiplying the payout based on the result of the free game by the payout rate determined in the step (1f).

According to the method above, the free game awarded when a predetermined condition is satisfied in the normal game and the free game awarded when the number of game play in the result determination area counter reaches the threshold game play count are able to share the free game payout rate random determination table for determining the payout rate for multiplication in the free game and the free game payout rate random determination table determination table for determining the free game payout rate random determination table.

On this account, the free game is run on the same conditions irrespective of the way of shifting to the free game (i.e., the free game is enjoyed without feeling the sense of unfairness).

It is possible to provide a gaming machine in which a credit amount betted in a normal game is taken into consideration in a free game which is awarded when games without any benefit are continued.

### BRIEF DESCRIPTION OF THE DRAWINGS

FIG. 1 shows the outline of game content of a slot machine according to an embodiment of the present invention.

FIG. 2 shows a functional flow of the slot machine of the embodiment of the present invention.

FIG. 3 shows a game system including the slot machine of the embodiment of the present invention.

FIG. 4 shows the overall structure of the slot machine of the embodiment of the present invention.

FIG. 5 shows a control panel of the slot machine of the embodiment of the present invention.

FIG. 6 illustrates active areas of “WAYS BET” in the slot machine of the embodiment of the present invention.

FIG. 7 illustrates an example of result determination in the “WAYS BET” in the slot machine related to the embodiment of the present invention.

FIG. 8 shows symbol arrays on normal game video reels (WAYS BET1 type) of the slot machine related to the embodiment of the present invention.

FIG. 9 shows symbol arrays on normal game video reels (WAYS BET2 type) of the slot machine related to the embodiment of the present invention.

FIG. 10 shows symbol arrays on normal game video reels (WAYS BET3 type) of the slot machine related to the embodiment of the present invention.

FIG. 11 shows symbol arrays on normal game video reels (WAYS BET4 type) of the slot machine related to the embodiment of the present invention.

FIG. 12 shows symbol arrays on normal game video reels (WAYS BET5 type) of the slot machine related to the embodiment of the present invention.

FIG. 13 shows symbol arrays on free game video reels (WAYS BET1 type) of the slot machine related to the embodiment of the present invention.

FIG. 14 shows symbol arrays on free game video reels (WAYS BET2 type) of the slot machine related to the embodiment of the present invention.

FIG. 15 shows symbol arrays on free game video reels (WAYS BET3 type) of the slot machine related to the embodiment of the present invention.

FIG. 16 shows symbol arrays on free game video reels (WAYS BET4 type) of the slot machine related to the embodiment of the present invention.

FIG. 17 shows symbol arrays on free game video reels (WAYS BET5 type) of the slot machine related to the embodiment of the present invention.

FIG. 18 graphically shows the symbols in the slot machine related to the embodiment of the present invention.

FIG. 19 graphically shows the symbols in the slot machine related to the embodiment of the present invention.

FIG. 20 graphically shows the symbols in the slot machine related to the embodiment of the present invention.

FIG. 21 is a block diagram showing an internal structure of the slot machine related to the embodiment of the present invention.

FIG. 22 shows a symbol combination table of the slot machine related to the embodiment of the present invention.

FIG. 23 shows a game play counter in the slot machine related to the embodiment of the present invention.

FIG. 24 is an explanatory diagram of a free game payout rate random determination table determination table of the slot machine related to the embodiment of the present invention.

FIG. 25 is an explanatory diagram of a mystery feature winning table of the slot machine related to the embodiment of the present invention.

FIG. 26 illustrates a special reel position in the slot machine related to the embodiment of the present invention.

FIG. 27 is a flowchart of a main control process in the slot machine of the embodiment of the present invention.

FIG. 28 is a flowchart of a start-check process of the slot machine related to the embodiment of the present invention.

FIG. 29 is a flowchart of a free game process of the slot machine related to the embodiment of the present invention.

FIG. 30 shows the screen display specification in the normal game in the slot machine related to the embodiment of the present invention.

FIG. 31 shows HELP screen display specification on the slot machine of the embodiment of the present invention in the normal state.

FIG. 32 shows the screen display specification in the normal game in the slot machine related to the embodiment of the present invention.

FIG. 33 shows the screen display specification in the normal game in the slot machine related to the embodiment of the present invention.

FIG. 34 shows the screen display specification in the free game in the slot machine related to the embodiment of the present invention.

FIG. 35 shows the screen display specification in the free game in the slot machine related to the embodiment of the present invention.

FIG. 36 shows the screen display specification in the free game in the slot machine related to the embodiment of the present invention.

FIG. 37 shows the flow of a win effect of the slot machine related to the embodiment of the present invention.

FIG. 38 shows the flow of a win effect of the slot machine related to the embodiment of the present invention.

FIG. 39 shows the flow of a win effect of the slot machine related to the embodiment of the present invention.

FIG. 40 shows the flow of a win effect of the slot machine related to the embodiment of the present invention.

FIG. 41 shows the flow of a win effect of the slot machine related to the embodiment of the present invention.

FIG. 42 shows a win signboard (in the normal game) the slot machine related to the embodiment of the present invention.

FIG. 43 shows a win signboard (in the normal game) the slot machine related to the embodiment of the present invention.

FIG. 44 shows a win signboard (in the free game) the slot machine related to the embodiment of the present invention.

FIG. 45 shows a win signboard (in the free game) the slot machine related to the embodiment of the present invention.

FIG. 46 explains an effect sound output when three feature symbols appear on the slot machine related to the embodiment of the present invention.

FIG. 47 explains an effect sound output when three feature symbols appear on the slot machine related to the embodiment of the present invention.

FIG. 48 shows a free game introduction effect in the slot machine related to the embodiment of the present invention.

FIG. 49 shows a free game introduction effect in the slot machine related to the embodiment of the present invention.

FIG. 50 shows a free game introduction effect in the slot machine related to the embodiment of the present invention.

FIG. 51 shows a free game introduction effect in the slot machine related to the embodiment of the present invention.

FIG. 52 shows a free game introduction effect in the slot machine related to the embodiment of the present invention.

FIG. 53 shows a free game introduction effect in the slot machine related to the embodiment of the present invention.

FIG. 54 shows a free game introduction effect in the slot machine related to the embodiment of the present invention.

FIG. 55 shows a free game introduction effect in the slot machine related to the embodiment of the present invention.

FIG. 56 shows a free game introduction effect in the slot machine related to the embodiment of the present invention.

FIG. 57 shows a free game introduction effect in the slot machine related to the embodiment of the present invention.

FIG. 58 shows a free game introduction effect in the slot machine related to the embodiment of the present invention.

FIG. 59 shows a free game introduction effect in the slot machine related to the embodiment of the present invention.

FIG. 60 shows a free game introduction effect in the slot machine related to the embodiment of the present invention.

FIG. 61 shows a free game introduction effect when reaching a threshold game play count or when winning a mystery feature in the slot machine related to the embodiment of the present invention.

FIG. 62 shows a free game introduction effect when reaching a threshold game play count or when winning a mystery feature in the slot machine related to the embodiment of the present invention.

FIG. 63 shows a free game introduction effect when reaching a threshold game play count or when winning a mystery feature in the slot machine related to the embodiment of the present invention.

FIG. 64 shows a free game introduction effect when reaching a threshold game play count or when winning a mystery feature in the slot machine related to the embodiment of the present invention.

FIG. 65 shows a re-trigger effect in the slot machine related to the embodiment of the present invention.

FIG. 66 is an explanatory diagram of a normal screen displayed on an upper image display panel of the slot machine.

FIG. 67 is an explanatory diagram of a display screen when a graph-switch button is operated.

FIG. 68 is an explanatory diagram of a display screen when a graph-switch button is operated.

FIG. 69 is an explanatory diagram of a display screen when a graph-switch button is operated.

FIG. 70 is an explanatory diagram of a display screen when a graph-switch button is operated.

FIG. 71 is an explanatory diagram of a display screen when a graph-switch button is operated.

FIG. 72 is an explanatory diagram of a display screen when a graph-switch button is operated.

FIG. 73 is an explanatory diagram of a display screen when a graph-switch button is operated.

FIG. 74 is an explanatory diagram of a display screen when a graph-switch button is operated.

FIG. 75 is an explanatory diagram of a display screen when a graph-switch button is operated.

FIG. 76 is an explanatory diagram of a display screen when a graph-switch button is operated.

FIG. 77 is an explanatory diagram of a display screen when a graph-switch button is operated.

FIG. 78 is an explanatory diagram of a line-graph on a graph screen.

FIG. 79 is an explanatory diagram of a line-graph on a graph screen.

FIG. 80 is an explanatory diagram of a line-graph on a graph screen.

FIG. 81 is an explanatory diagram of a line-graph on a graph screen.

FIG. 82 is an explanatory diagram of a bar-graph on a graph screen.

FIG. 83 is an explanatory diagram of a bar-graph on a graph screen.

FIG. 84 is an explanatory diagram of a bar-graph on a graph screen.

FIG. 85 is an explanatory diagram of a block-graph on a graph screen.

FIG. 86 is an explanatory diagram of a block-graph on a graph screen.

FIG. 87 is an explanatory diagram of a block-graph on a graph screen.

FIG. 88 is an explanatory diagram of the specification of switching an active and inactive states of the graph screen based on an AUDIT setting.

FIG. 89 is an explanatory diagram of the specification of switching an active and inactive states of the graph screen based on an AUDIT setting.

FIG. 90 shows a win meter information display of the slot machine related to the embodiment of the present invention.

FIG. 91 shows GAMBLE specification of the slot machine related to the embodiment of the present invention.

FIG. 92 shows GAMBLE specification of the slot machine related to the embodiment of the present invention.

FIG. 93 shows GAMBLE specification of the slot machine related to the embodiment of the present invention.

FIG. 94 shows GAMBLE specification of the slot machine related to the embodiment of the present invention.

FIG. 95 shows GAMBLE specification of the slot machine related to the embodiment of the present invention.

FIG. 96 shows GAMBLE specification of the slot machine related to the embodiment of the present invention.

FIG. 97 shows GAMBLE specification of the slot machine related to the embodiment of the present invention.

FIG. 98 shows RESIDUAL GAMBLE in the slot machine related to the embodiment of the present invention.

FIG. 99 shows RESIDUAL GAMBLE in the slot machine related to the embodiment of the present invention.

FIG. 100 shows RESIDUAL GAMBLE in the slot machine related to the embodiment of the present invention.

FIG. 101 shows a system font display region of the slot machine of the embodiment of the present invention.

FIG. 102 shows a HELP specification in the slot machine related to the embodiment of the present invention.

FIG. 103 shows a HELP specification in the slot machine related to the embodiment of the present invention.

FIG. 104A shows arrangement of screen touch buttons of the slot machine related to the embodiment of the present invention.

FIG. 104B shows arrangement of screen touch buttons of the slot machine related to the embodiment of the present invention.

FIG. 104C shows arrangement of screen touch buttons of the slot machine related to the embodiment of the present invention.

FIG. 104D shows arrangement of screen touch buttons of the slot machine related to the embodiment of the present invention.

FIG. 105A shows arrangement of screen touch buttons of the slot machine related to the embodiment of the present invention.

FIG. 105B shows arrangement of screen touch buttons of the slot machine related to the embodiment of the present invention.

FIG. 105C shows arrangement of screen touch buttons of the slot machine related to the embodiment of the present invention.

FIG. 105D shows arrangement of screen touch buttons of the slot machine related to the embodiment of the present invention.

FIG. 106 shows arrangement of screen touch buttons of the slot machine related to the embodiment of the present invention.

FIG. 107 shows a sound volume switching touch button of the slot machine of the embodiment of the present invention.

FIG. 108 shows AUDIT national flag switch setting in the slot machine of the embodiment of the present invention.

FIG. 109 shows AUDIT national flag switch setting in the slot machine of the embodiment of the present invention.

FIG. 110 shows AUDIT national flag switch setting in the slot machine of the embodiment of the present invention.

FIG. 111 shows AUDIT national flag switch setting in the slot machine of the embodiment of the present invention.

FIG. 112 shows a game play counter in a slot machine of another embodiment of the present invention.

FIG. 113 shows a game play counter in a slot machine of another embodiment of the present invention.

### DETAILED DESCRIPTION OF THE PREFERRED EMBODIMENT

### Embodiment Overview

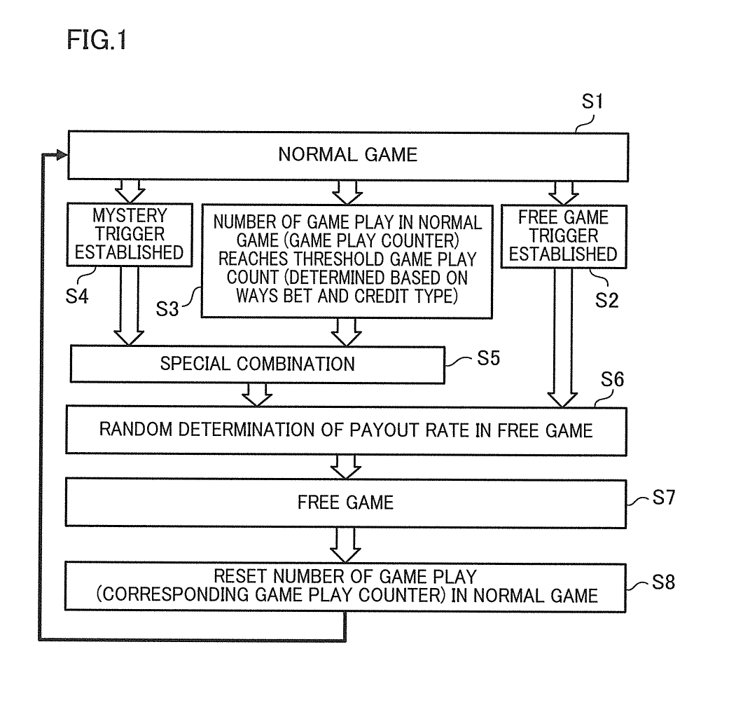

The following will describe a gaming machine of an embodiment of the present invention with reference to figures. FIG. 1 shows the outline of games run in a slot machine related to the embodiment of the present invention.

The present embodiment deals with an example where the gaming machine is a slot machine configured to run a normal game which awards a benefit (payout, free game, etc.) based on a combination of a plurality of symbols rearranged in a result determination area selected. To be more specific, a slot machine includes: a credit type input device (e.g., a control panel 30) by which betting can be done with plural credit types which are different in credit amount; a result determination area input device (e.g., the control panel 30) by which any result determination area is selectable from plural result determination areas (later-described WAYS BET1, WAYS BET2, WAYS BET3, WAYS BET4, and WAYS BET5); a display device (lower image display panel 141) configured to display results of a normal game and a free game by rearranging symbols in the selected result determination area; a storage unit (RAM 73) configured to store game play counters each counting the number of game play incremented after the start of the normal game, for the respective credit types corresponding to the respective result determination areas, and store threshold game play counts each indicating how long does it take until the awarding of the right to run the free game, for the respective game play counters; and a controller (e.g., a main CPU 71, a ROM 72, and a RAM 73) programmed to execute processes described below. The credit type input device is equivalent to an input device by which a condition required to start the normal game is selectable from plural start conditions (e.g., plural types of BET payout rates or plural types of WAYS BET).

The steps are specifically as follows. Namely, in the slot machine, the credit type input device accepts betting with a credit type, the result determination area input device accepts the selection of the result determination area, and the normal game is run so that a benefit is awarded based on a combination of symbols rearranged in the selected result determination area and the credit type of the betting (S1). When a free game trigger is established in the normal game (S2), a payout rate of a payout awarded as a result of the running of the free game is randomly determined (S6), and the free game is run (S7).

When the number of game play of the normal game (i.e., the value of the game play counter) reaches a threshold game play count (which is determined for each of the credit types corresponding to the respective result determination areas) (S3), predetermined symbols are arranged on the display device (S5), and then random determination of a payout rate of the payout awarded as a result of the free game is performed (S6) and the free game is run (S7). In this regard, in the free game which is awarded when the number of game play (value of the game play counter) in the normal game reaches a threshold game play count, a payout is awarded based on a result of the free game displayed on the display device and a result determination area and a credit type corresponding to the game play counter having reached the threshold game play count.

Furthermore, when a mystery trigger (predetermined condition) is established in the normal game (S4), after the arrangement of the predetermined symbols on the display device (S5), a payout rate of a payout awarded when the free game is run is randomly determined (S6), and the free game is run (S7).

After the end of the free game in S7, the number of game play (value of the game play counter) of the normal game is reset (S8). Then, the process returns to the normal game (S1).

### DEFINITIONS

The slot machine is a type of a gaming machine. While the present embodiment deals with the slot machine as an example of the gaming machine, the slot machine may be a different type of machine on condition that a normal game can be individually run by the machine and a free game developing from the normal game can be run by the machine.

Each of the normal game and the free game in the present embodiment is a slot game of rearranging symbols.

The symbols encompasses “PHOENIX”, “TURTLE”, “FISH”, “FROG”, “PIG”, “ACE”, “KING”, “QUEEN”, “JACK”, “TEN”, “NINE”, “WILD”, and “FEATURE”.

A coin, paper money, or electrically valuable information corresponding to these is used as a gaming value (credit). Note that the gaming value in the present invention is not particularly limited. Examples of the gaming value include game media such as medals, tokens, cyber money, tickets, and the like. A ticket is not particularly limited, and a later-mentioned barcoded ticket may be adopted for example.

The free game of the present embodiment may be any type of game on condition that the gaming state thereof is different from that of the normal game. The free game is a game which is executable with a smaller amount of gaming values bet than in the normal game. Note that “bet of fewer amounts of gaming values” encompasses a bet of zero gaming value. The “free game” therefore may be a game runnable without a bet of a gaming value, which free game awards an amount of gaming values based on symbols rearranged. In other words, the “free game” is a game which starts without consumption of a gaming value. In the meanwhile, the “normal game” is executable on condition that a gaming value is bet, and a gaming value is awarded for an amount corresponding to rearranged symbols, as a result of the normal game. In other words, the “normal game” is a game which starts with consumption of a gaming value.

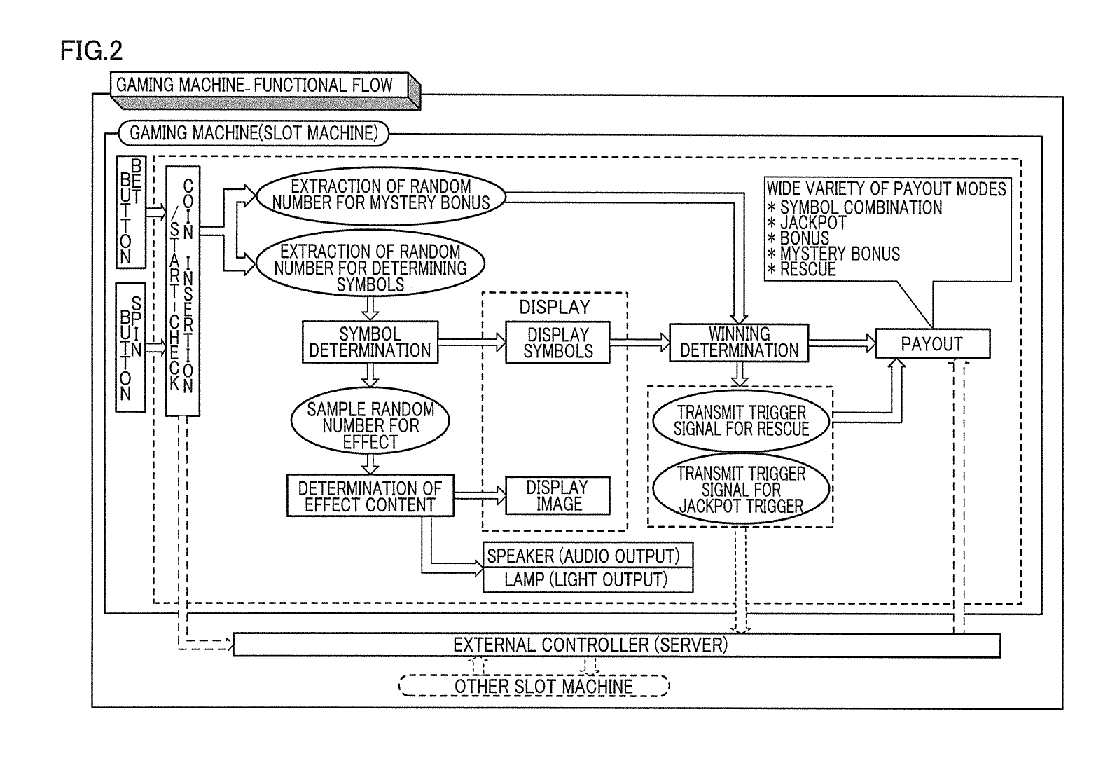

The term “rearrangement” indicates that the symbols are rearranged after the arrangement of the symbols is dismissed. The term “arrangement” indicates a state in which the symbols are visually recognizable by an external player.

[Explanation of Function Flow Diagram] The following describes basic functions of the slot machine related to the embodiment of the present invention, with reference to FIG. 2. FIG. 2 shows a functional flow of the slot machine of the embodiment of the present invention.

(Start-Check)

First, the slot machine checks whether or not a BET button has been pressed by a player, and subsequently checks whether or not a spin button has been pressed by the player.

<Symbol Determination>

Next, when a spin button has been pressed by the player, the slot machine extracts a random number for symbol determination, and determines symbols to be displayed for the player at the time of stopping the scroll of the symbol array, for respective video reels displayed on a display.

<Symbol Display>

Then the slot machine starts the scroll of the symbol array of each video reel, and stops the scroll so that the determined symbols are displayed for the player.

<Result Determination>

Subsequently, as the rotation of the symbol array of each video reel is stopped, the slot machine determines whether the combination of the symbols displayed for the player is a combination related to winning.

<Payout>

When the combination of the symbols displayed for the player is a combination related to winning, the slot machine offers, to the player, benefit according to the combination. For example, when a combination of symbols related to a payout of coins has been displayed, the slot machine pays out coins of the number corresponding to the combination of symbols to the player.

When a combination of symbols associated with a free game trigger is displayed, the slot machine starts the free game. In the embodiment of the present invention, as the free game, a game (free game) which executes the random determination of the symbols to be stopped a predetermined number of times without consumption of coins.

In addition to the above, the slot machine has other benefits such as mystery feature, in addition to the benefit above. With the mystery feature, a predetermined number of play of free game is awarded when a winning is achieved in dedicated random determination. When a spin button is pressed, the slot machine samples a random number for the mystery bonus, and whether a mystery feature trigger is established is randomly determined.

A rescue function built in the present embodiment is a function for rescuing the player from a situation of not being able to play the free game for a long period of time (a function of awarding a return (rescue) to a player, if a predetermined benefit is not awarded in a predetermined number of plays of the game).

The administrator of the slot machine is able to select whether rescue is active or inactive. When the rescue is activated, the slot machine starts to count the number of plays of the game played. When the counted number of plays of the game played reaches a predetermined number without awarding of a large amount of payout in the free game and the like, the slot machine awards a predetermined benefit.

When a combination of symbols associated with a jackpot trigger is displayed, the slot machine may pay out coins corresponding to a jackpot amount to the player. As the jackpot, at least one of the coins consumed by the player at each slot machine is accumulated as a jackpot amount, and when the jackpot trigger is established at a slot machine, coins corresponding to the accumulated jackpot amount is paid out to that slot machine. In the present case, the slot machine calculates an amount (accumulative amount) accumulated to the jackpot amount each time the game is played, and sends the calculation result to an external controller. The external controller adds the accumulative amount sent from each slot machine to the jackpot amount.

<Determination of Effect>

The slot machine produces an effect by displaying an image on a display, outputting light from a lamp, and outputting sound from a speaker. The slot machine samples an effect-use random number and determines the content of an effect based on randomly determined symbols or the like.

[Overall Structure of Game System]

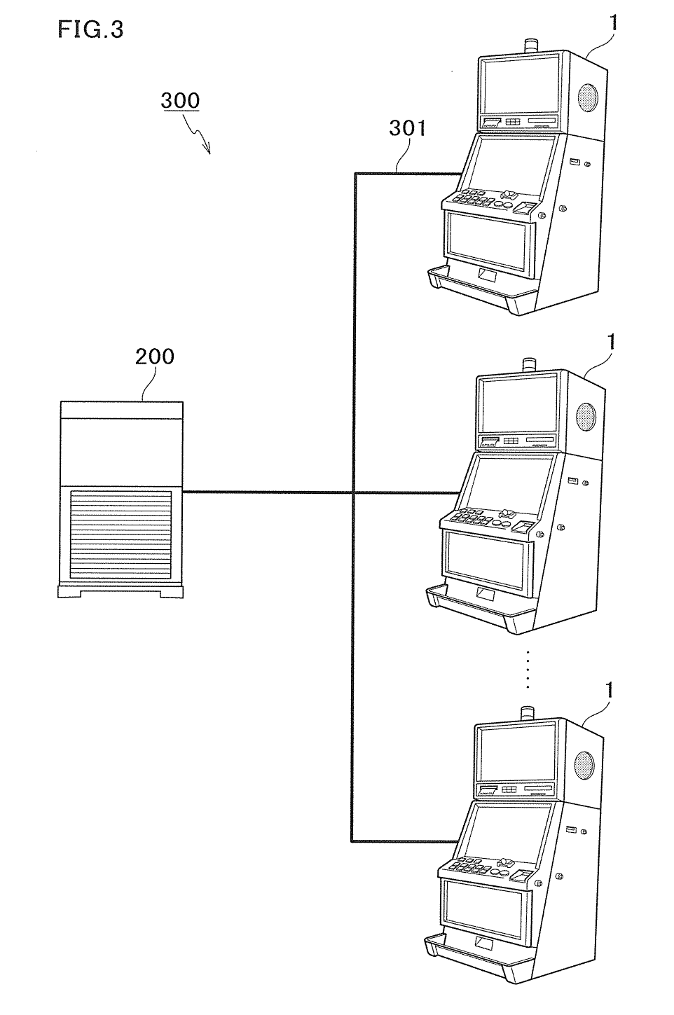

The basic functions of the slot machine have been described as above. Now, referring to FIG. 3, a game system including the slot machine will be described. FIG. 3 shows a game system including the slot machine of the embodiment of the present invention.

A game system 300 includes a plurality of slot machines 1 and an external controller 200 connected with the slot machines 1 via a communication line 301.

The external controller 200 is for controlling the plurality of slot machines 1. In the present embodiment, the external controller 200 is a so-called hall server installed in a gaming facility where the plurality of slot machines 1 are provided. Each of the slot machines 1 has a unique identification number, and the external controller 200 identifies which one of the slot machines 1 transmitted data, by referring to the identification number. Further, the external controller 200 determines transmission target of data with the identification number when transmitting data to a slot machine 1.

It is to be noted that the game system 300 may be constructed within a single gaming facility where various games can be performed, such as a casino, or may be constructed among a plurality of gaming facilities. Further, when the game system 300 is constructed in a single gaming facility, the gaming system may be constructed in each floor or section of the gaming facility. The communication line 301 may be a wired or wireless line, and can adopt a dedicated line, an exchange line or the like.

[Overall Structure of Slot Machine]

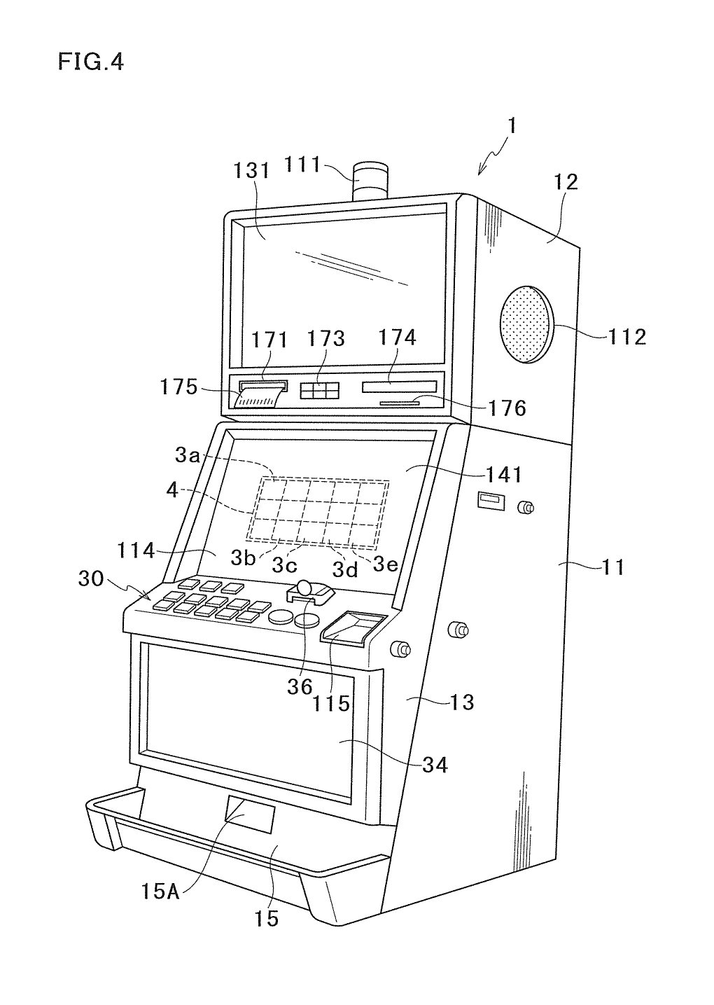

Now, referring to FIG. 4, the overall structure of the slot machine 1 will be described. FIG. 4 shows the overall structure of the slot machine of the embodiment of the present invention.

A coin, a paper money, or electrically valuable information corresponding to these is used as a gaming value in the slot machine 1. In the embodiment of the present invention, furthermore, a later-described ticket with barcode is also used. It is to be noted that the gaming medium is not limited to these, and for example a medal, a token, cyber money or the like can be adopted.

The slot machine 1 includes a cabinet 11, a top box 12 installed on the upper side of the cabinet 11, and a main door 13 provided at the front surface of the cabinet 11.

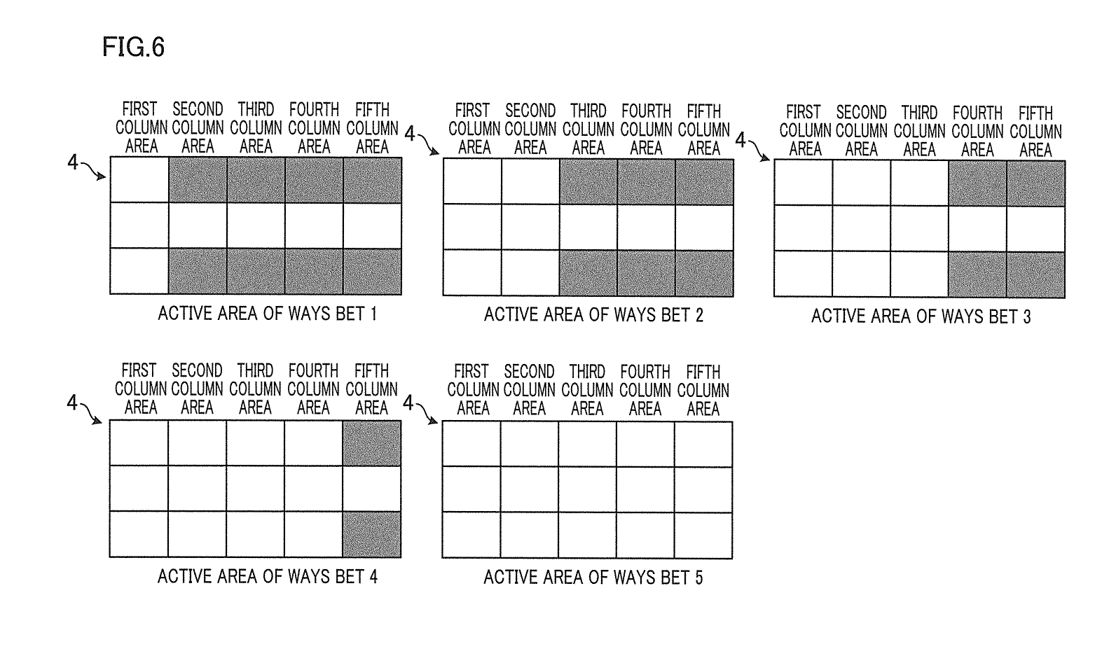

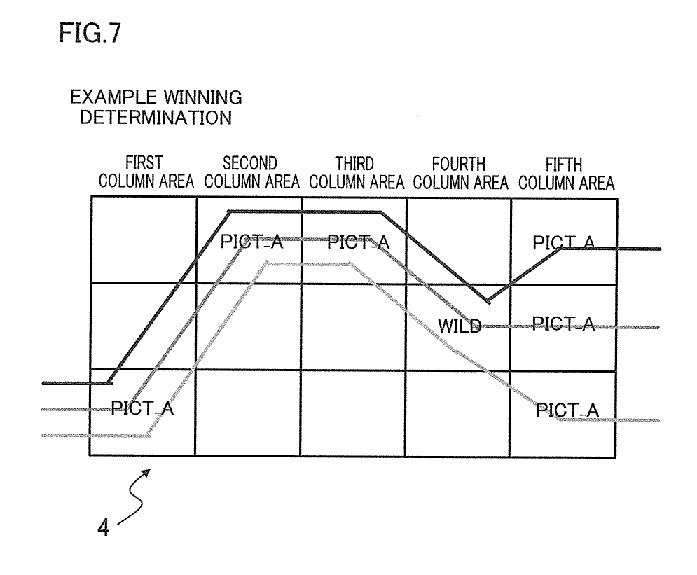

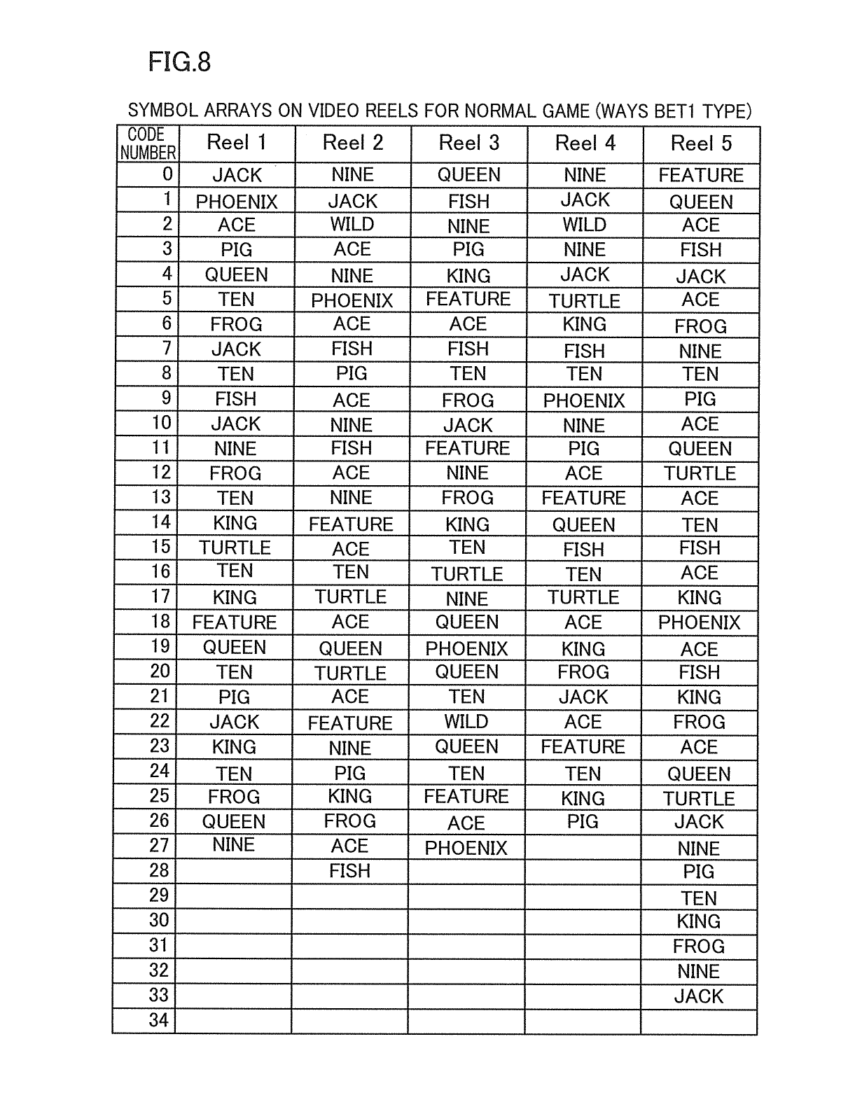

At the center of the main door 13, a lower image display panel 141 is provided. The lower image display panel 141 is a liquid crystal panel and constitute a display. The lower image display panel 141 has a symbol display area 4. The symbol display area 4 includes 5 array areas (first array area to fifth array area) each of which is divided into three areas: the upper stage, the middle stage, and the lower stage, as shown in FIG. 6 and FIG. 7. In the first array area to fifth array area, five video reels 3 (3a, 3b, 3c, 3d, and 3e) are displayed, respectively. In the embodiment of the present invention, the video reels are for expressing in the form of a video rotation and stop of symbols depicted on the circumferential surfaces of mechanical reels. To each of the video reels 3 is allocated a symbol array including predetermined symbols (see, e.g., FIGS. 8 to 17 which will be described later).

In the symbol display area 4, the symbol array allocated to each video reel 3 (3a, 3b, 3c, 3d, 3e) scrolls and stops after elapse of a predetermined time. As a result, parts of the respective symbol arrays (three successive symbols in the embodiment of the present invention) are displayed for the player. In each of the first array area to the fifth array area of the symbol display area 4, one symbol is displayed in each of the three areas of the array area, i.e., the upper stage, the middle stage, and the lower stage, according to the corresponding video reel 3. To put it differently, 15 symbols forming a 5 by 3 matrix are displayed in the symbol display area 4.

In the embodiment of the present invention, “LEFT TO RIGHT” type is adopted for determining the winning. By selecting any of the five stages of WAYS BET (WAYS BET1, WAYS BET2, WAYS BET3, WAYS BET4, WAYS BET5), a result determination area to be subjected to result determination is selected out of 15 areas of the 5 by 3 matrix of the symbol display area 4 (see FIG. 6). Then a winning occurs when a predetermined number of symbols stopped in the result determination areas of first array area to fifth array area, which areas are subjected to result determination, are linked (see FIG. 7).

Specifically, as shown in FIG. 6, when “WAYS BET1” is selected, the areas out of the symbol display area 4 subjected to result determination (areas activated) are: the upper stage, the middle stage, and the lower stage of the first array area; the middle stage of the second array area; the middle stage of the third array area; the middle stage of the fourth array area; and the middle stage of the fifth array area. Further, when “WAYS BET2” is selected, the areas out of the symbol display area 4 subjected to result determination (areas activated) are: the upper stage, the middle stage, and the lower stage of the first array area; the upper stage, the middle stage, and the lower stage of the second array area; the middle stage of the third array area; the middle stage of the fourth array area; and the middle stage of the fifth array area. Further, when “WAYS BET3” is selected, the areas out of the symbol display area 4 subjected to result determination (areas activated) are: the upper stage, the middle stage, and the lower stage of the first array area; the upper stage, the middle stage, and the lower stage of the second array area; the upper stage, the middle stage, and the lower stage of the third array area; the middle stage of the fourth array area; and the middle stage of the fifth array area. Further, when “WAYS BET4” is selected, the areas out of the symbol display area 4 subjected to result determination (areas activated) are: the upper stage, the middle stage, and the lower stage of the first array area; the upper stage, the middle stage, and the lower stage of the second array area; the upper stage, the middle stage, and the lower stage of the third array area; the upper stage, the middle stage, and the lower stage of the fourth array area; and the middle stage of the fifth array area. Further, when “WAYS BET5” is selected, the areas out of the symbol display area 4 subjected to result determination (areas activated) are: the upper stage, the middle stage, and the lower stage of the first array area; the upper stage, the middle stage, and the lower stage of the second array area; the upper stage, the middle stage, and the lower stage of the third array area; the upper stage, the middle stage, and the lower stage of the fourth array area; and the upper stage, the middle stage, and the lower stage of the fifth array area.

For example, as shown in FIG. 7, when the “WAYS BET5” is selected, all the areas out of the symbol display area 4 are subjected to result determination (activated). As shown in FIG. 7, when a certain symbol (PICT_A, encompassing WILD symbol) occurs in the lower stage of the first array area, the upper stage of the second array area, the upper stage of the third array area, the middle stage of the fourth array area, and the upper stage, the middle stage, and the lower stage of the fifth array area, there are 3 wins in which the symbol occurs in five linked positions from the first array area to the fifth array area (LEFT TO RIGHT). In the “LEFT TO RIGHT” type, the symbols may appear to be scattered in the first sight; however, if they are linked throughout the first array area to the fifth array area, it is determined as a winning. Although the present embodiment adopts the “LEFT TO RIGHT” type, it is possible to adopt a line type which regards as a winning line a line connecting any of three areas out of each symbol array of the video reel.

The lower image display panel 141 includes a touch panel 114. The player is allowed to input instructions by touching the lower image display panel 141.

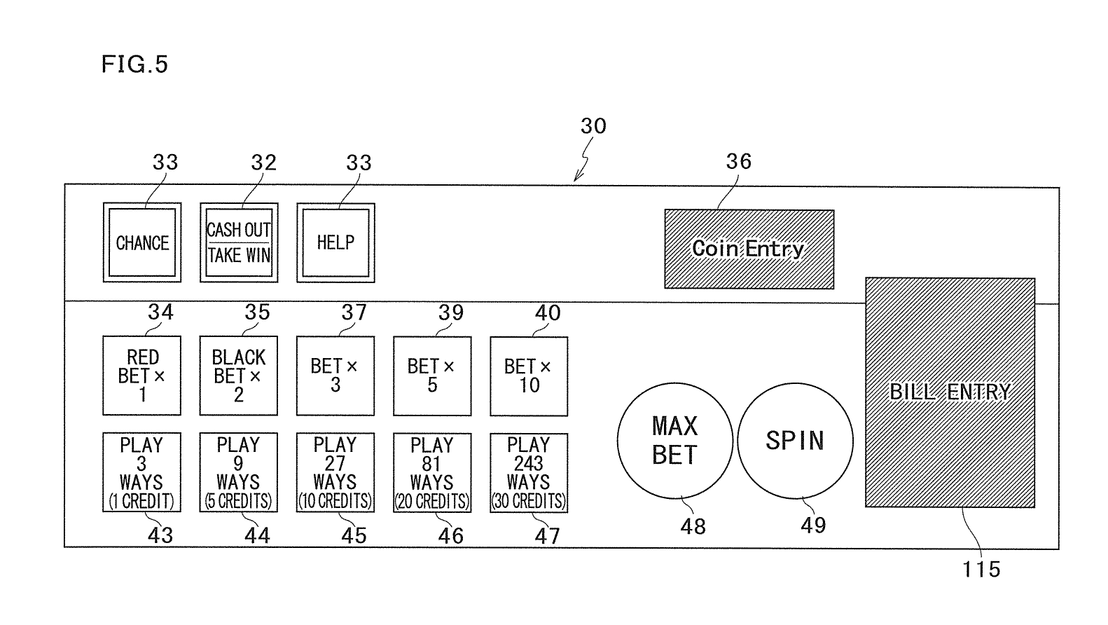

As shown in FIG. 4 and FIG. 5, below the lower image display panel 141 are provided various buttons on the control panel 30 (input device), a coin entry 36 which guides coins into the cabinet 11, and a bill entry 115.

The control panel 30 shown in FIG. 5 includes: a change button 31, a cashout/take win button 32, and a help button 33 arranged in the left side area of the upper stage; a 1-bet button 34, a 2-bet button 35, a 3-bet button 37, a 5-bet button 39, a 10-bet button 40, a WAYS BET1 button 43, a WAYS BET2 button 44, a WAYS BET3 button 45, a WAYS BET4 button 46, and a WAYS BET5 button 47 in the left side area of the lower stage. Further, a coin entry 36 and a bill entry 115 for accepting a bar code-attached ticket, paper money or the like are arranged in the right side area of the upper stage, and a BET button 48 and a spin button 49 are arranged in the right side area of the lower stage.

The change button 31 is an operation button to be used when temporarily leaving the seat, or when requesting a staff person of the gaming facility for an exchange. The cashout/take win button 32 is an operation button to be used for cashing out coins (credits) stored in the slot machine 10. The help button 33 is pressed when the operating method of a game is unclear. When the help button 33 is pressed, various types of help information are displayed on the upper image display panel 131 and the lower image display panel 141.

The WAYS BET1 button 43, the WAYS BET2 button 44, the WAYS BET3 button 45, the WAYS BET4 button 46, and WAYS BET5 button 47 are buttons for determined result determination areas to be subjected to result determination (to be activated), out of 15 areas (the 5 by 3 matrix) of the symbol display area 4. To determine the areas to be subjected to result determination by the WAYS BET1 button 43, 1 credit is required. To determine the areas to be subjected to result determination by the WAYS BET2 button 44, 5 credits are required. To determine the areas to be subjected to result determination by the WAYS BET3 button 45, 10 credits are required. To determine the areas to be subjected to result determination by the WAYS BET4 button 46, 20 credits are required. To determine the areas to be subjected to result determination by the WAYS BET5 button 47, 30 credits are required.

The 1-BET button 34 is a button to determine ×1 as the multiplying factor relative to the payout (1BET). The 2-BET button 35 is a button to determine ×2 as the multiplying factor relative to the payout (2BET). The 3-BET button 37 is a button to determine ×3 as the multiplying factor relative to the payout (3BET). The 5-BET button 39 is a button to determine ×5 as the multiplying factor relative to the payout (5BET). The 10-BET button 40 is a button to determine ×10 as the multiplying factor relative to the payout (10BET). The MAX BET button 48 is a button to determine the maximum (×10) as the multiplying factor relative to the payout. As described above, five credit types are selectable (corresponding to credit type input device).

In the present embodiment, the credit amount to be placed as a bet is determined by means of selecting any of the foregoing five stages of WAYS BET (i.e., WAYS BET, WAYS BET2, WAYS BET3, WAYS BET4, WAYS BET5) and any of the foregoing five types of BET buttons (i.e., 1-BET Button 34, 2-BET button 35, 3-BET button 37, 5-BET button 39, 10-BET button 40), and a normal game is started thereafter.

Specifically, the credit amount bet for starting the normal game is a product resulting from multiplication of the number of credits required by the selected WAYS BET by the credit value corresponding to the selected bet button. The number of credits required for the WAYS BET is 1 credit for WAYS BET1, 5 credits for WAYS BET2, 10 credits for WAYS BET3, 20 credits for WAYS BET4, and 30 credits for WAYS BET5. For example, when the WAYS BET1 and 2-BET button 35 are selected, 2 credits, which is a product of 1×2, are placed as the bet. Further, when the WAYS BET3 and 3-BET button 37 are selected, 30 credits, which is a product of 10×3, are placed as the bet. Further, when the WAYS BET5 and 10-BET button 40 are selected, 300 credits, which is a product of 30×10, are placed as the bet.

The spin button 49 is a button for starting scroll of the video reels 3 (3a, 3b, 3c, 3d, and 3e). The spin button 49 also serves as a button for use in selection making in relation to the progress of the game.

The coin entry 36 is used for receiving coins into the cabinet 11. The bill entry 115 validates paper money, and accepts genuine paper money and a barcode attached ticket 175 into the cabinet 11.

An upper image display panel 131 is provided at the front face of the top box 12. The upper image display panel 131 is a liquid crystal panel and constitute a display. The upper image display panel 131 displays images related to effects and images showing introduction of the game contents and explanation of the game rules. Further, the top box 12 is provided with a speaker 112 and a lamp 111. The slot machine 1 produces effects by displaying images, outputting sounds, and outputting the light.

A ticket printer 171, a card slot 176, a data display 174, and a keypad 173 are provided on the lower side of the upper image display panel 131.

The ticket printer 171 prints on a ticket a barcode representing encoded data of the credit amount, date and time, the identification number of the slot machine 1, and the like, and then outputs the ticket as the ticket 175 with a barcode. The player is able to play games by causing the slot machine to read the ticket 175 with the barcode and to exchange the ticket 175 with the barcode for paper money or the like at a predetermined location in the gaming facility (e.g., a counter in the casino).

The card slot 176 is provided to insert a card storing predetermined data thereto. The card stores, for example, data for identifying the player and data regarding the playing history of the player. From and to the card inserted into the card slot 176, data is read and written by a later-described card reader 172. The card may store data equivalent to coins, paper money, or credits.

The data display 174 is constituted by a fluorescent display, LEDs and the like, and displays the data read by the card reader 172 and the data inputted by the player via the keypad 173, for example. The keypad 173 is provided to input instructions and data regarding the issuance of a ticket or the like.

[Symbol Arrays on Video Reels]

Next, with reference to FIGS. 8 to 17, the following describes a configuration of the symbol arrays on the video reels 3 of the slot machine 1.

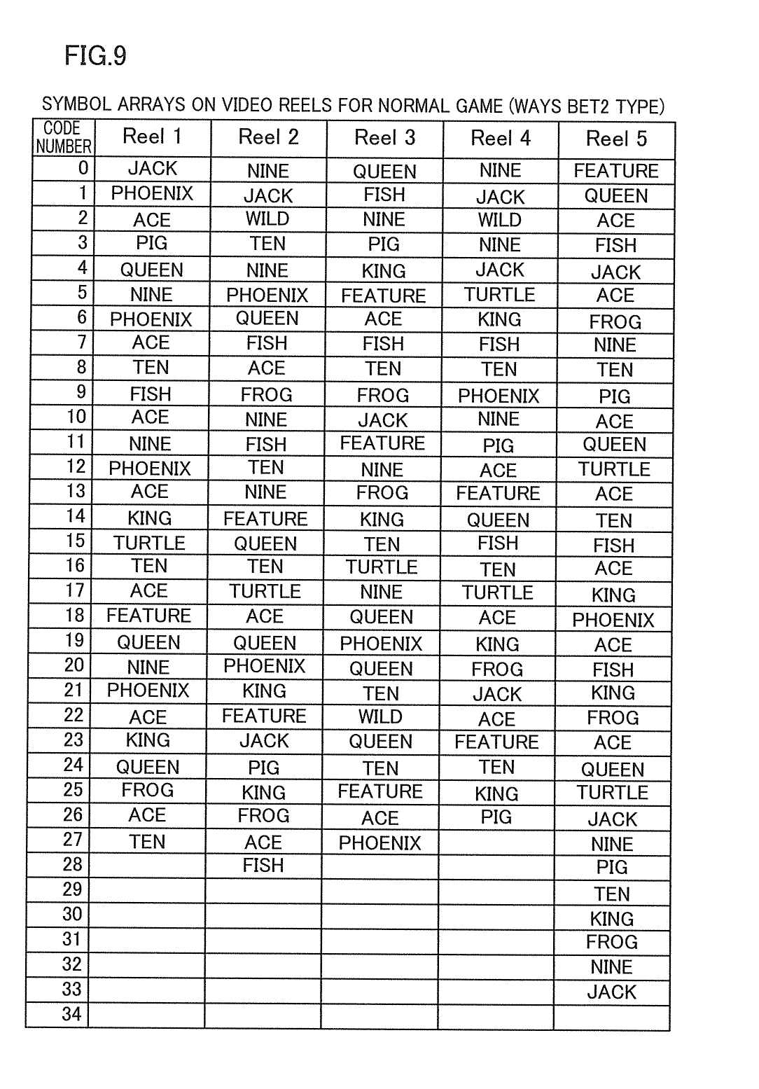

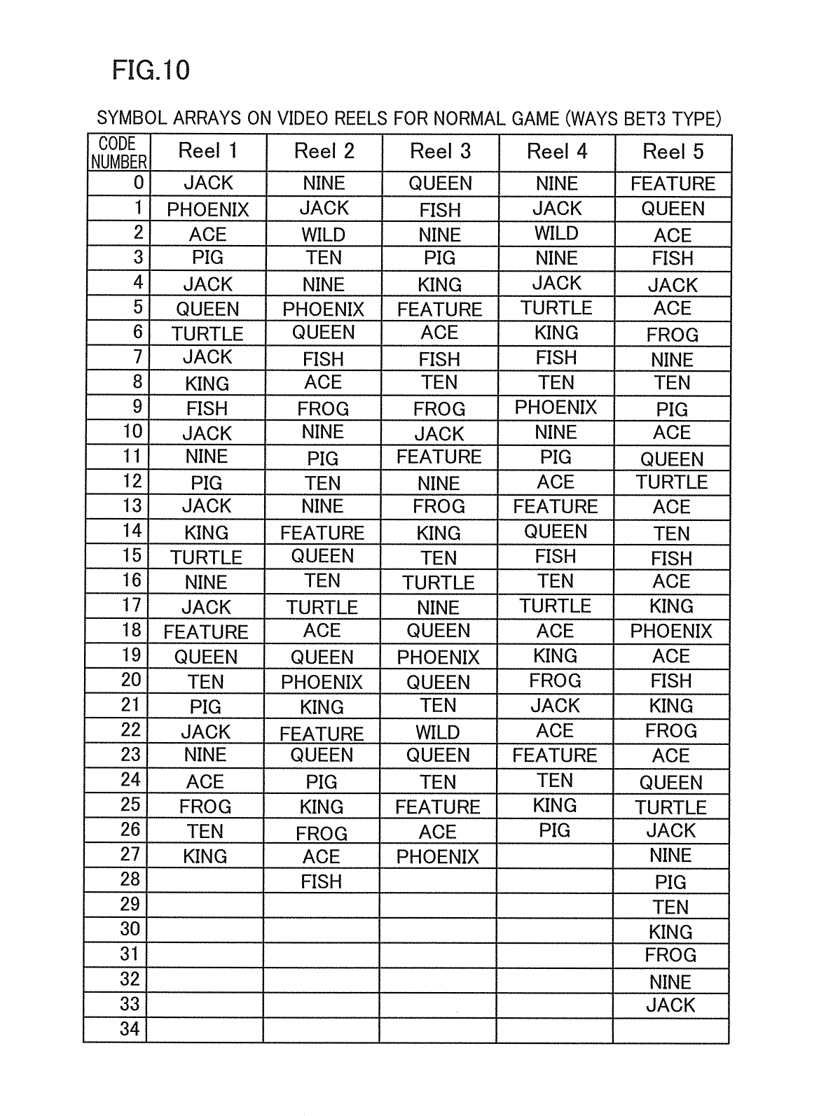

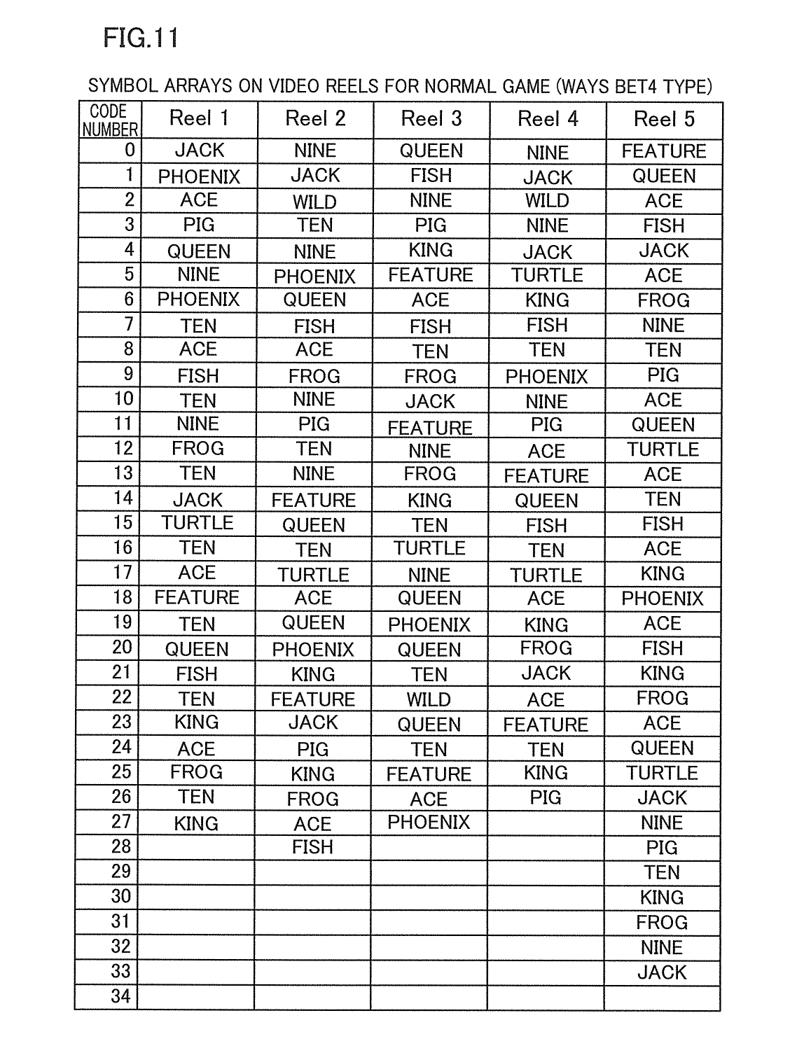

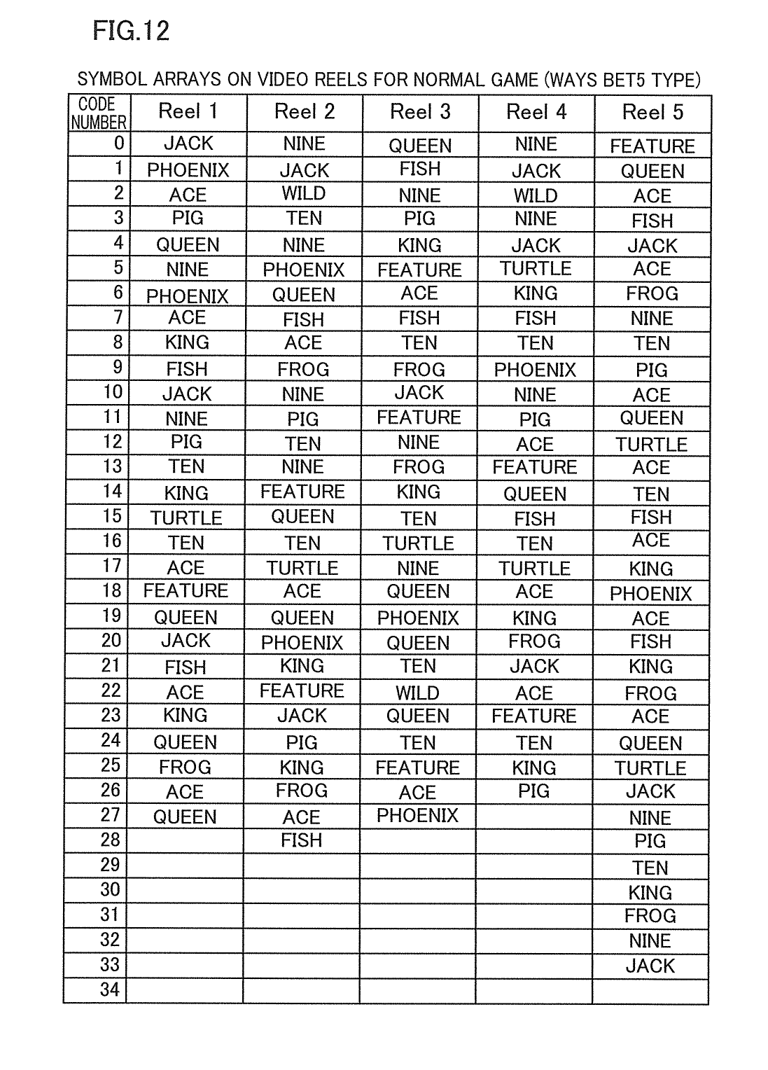

As shown in FIGS. 8 to 12, to a first video reel (“Reel 1”) 3a, a second video reel (“Reel2”) 3b, a third video reel (“Reel3”) 3c, a fourth video reel (“Reel4”) 3d, a fifth video reel (“Reel5”) 3e of the normal game video reel 3, symbol arrays each constituted by corresponding to code numbers “0” to “33” are allocated, respectively. The video reel 3 for the normal game, which has the symbol arrays shown in FIG. 8, is used when the WAYS BET1 is selected. The video reel 3 for the normal game, which has the symbol arrays shown in FIG. 9, is used when the WAYS BET2 is selected. The video reel 3 for the normal game, which has the symbol arrays shown in FIG. 10, is used when the WAYS BET3 is selected. The video reel 3 for the normal game, which has the symbol arrays shown in FIG. 11, is used when the WAYS BET4 is selected. The video reel 3 for the normal game, which has the symbol arrays shown in FIG. 12, is used when the WAYS BET5 is selected.

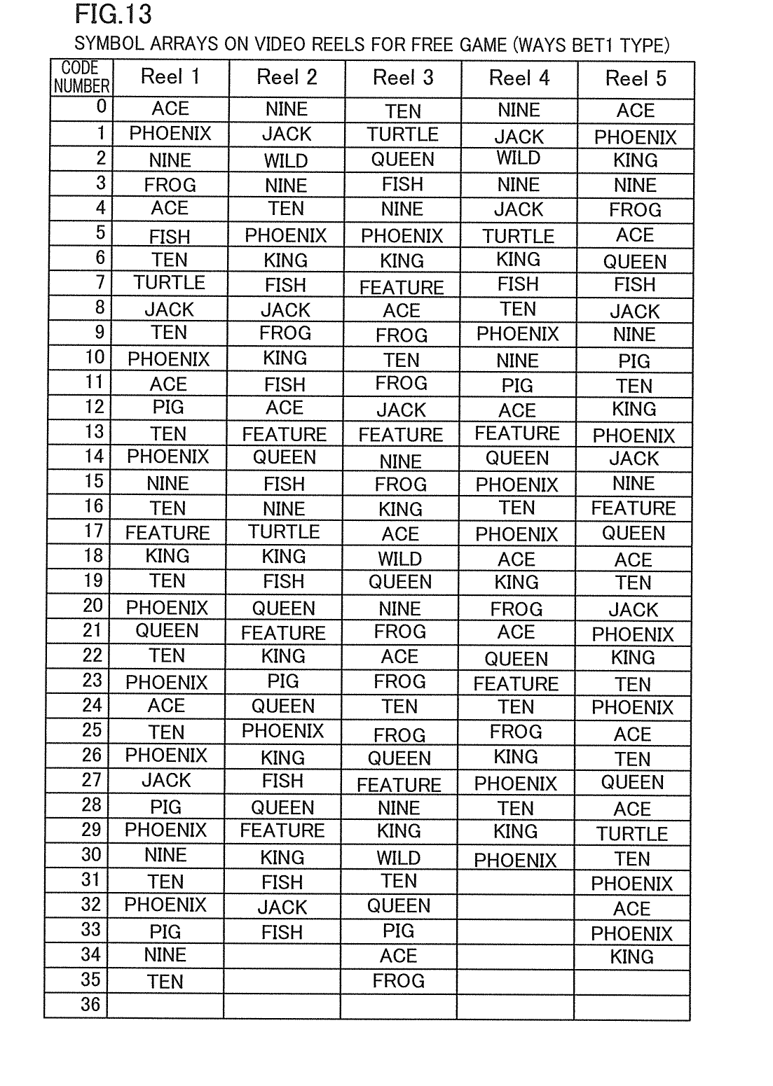

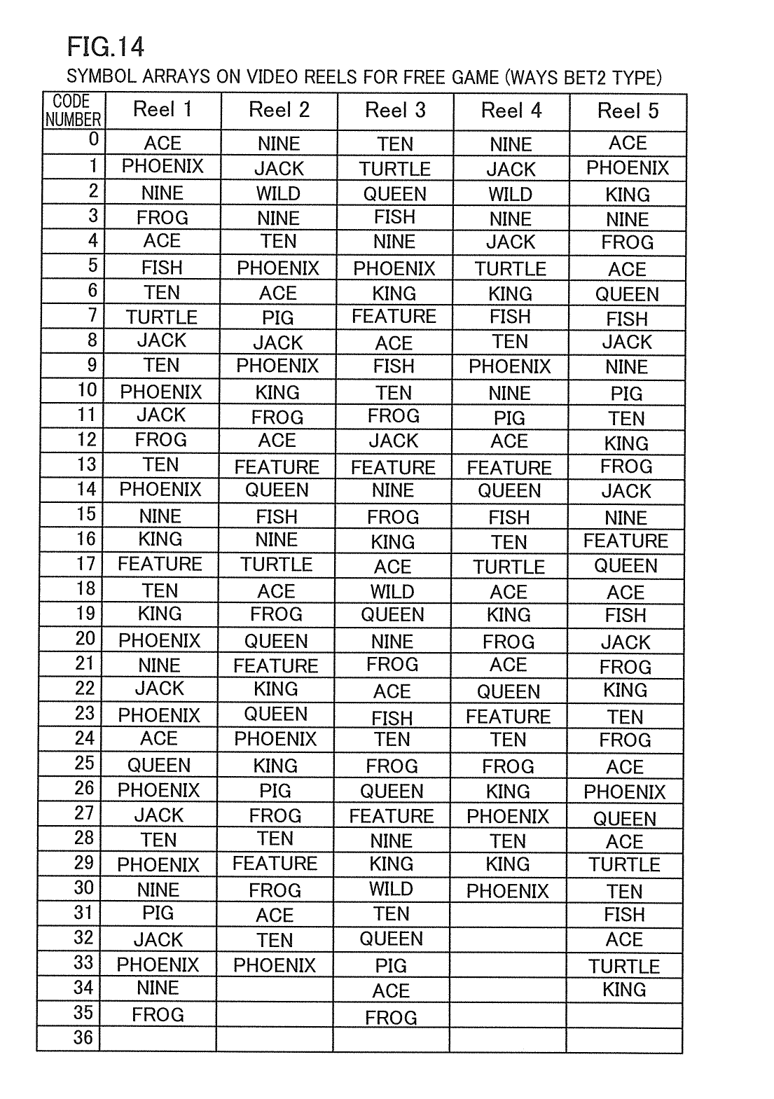

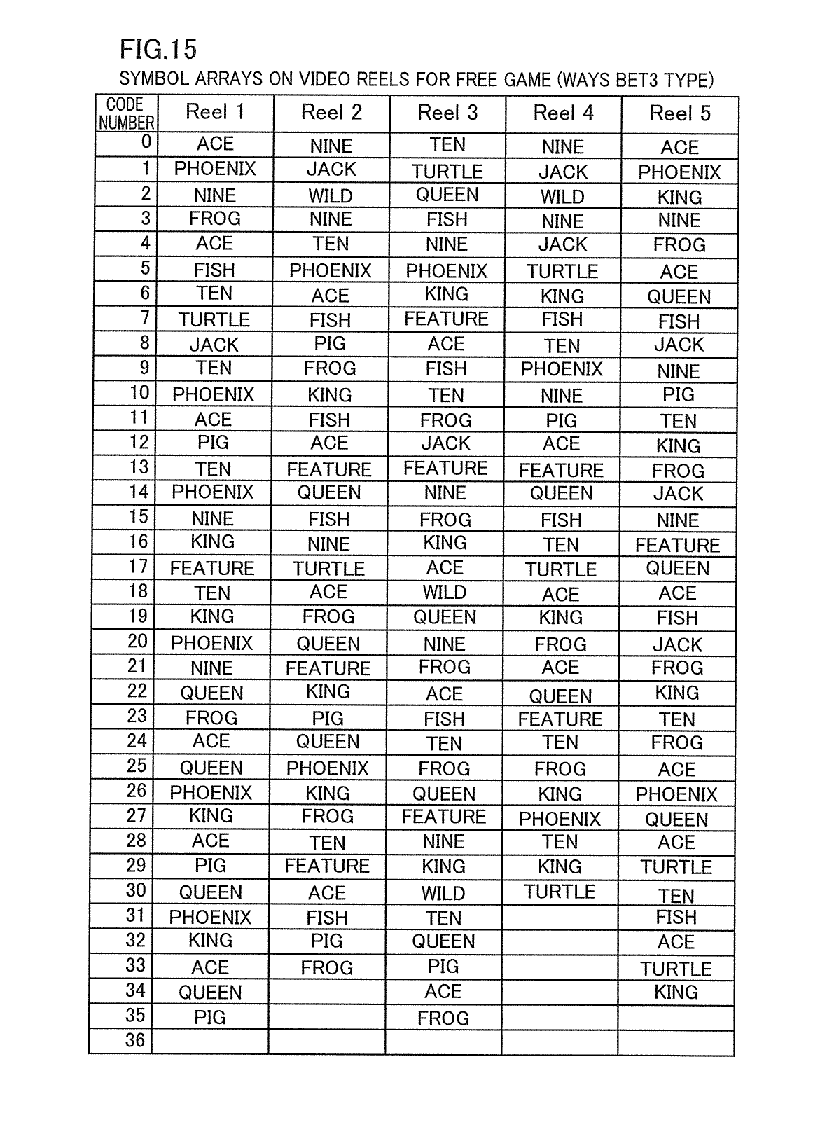

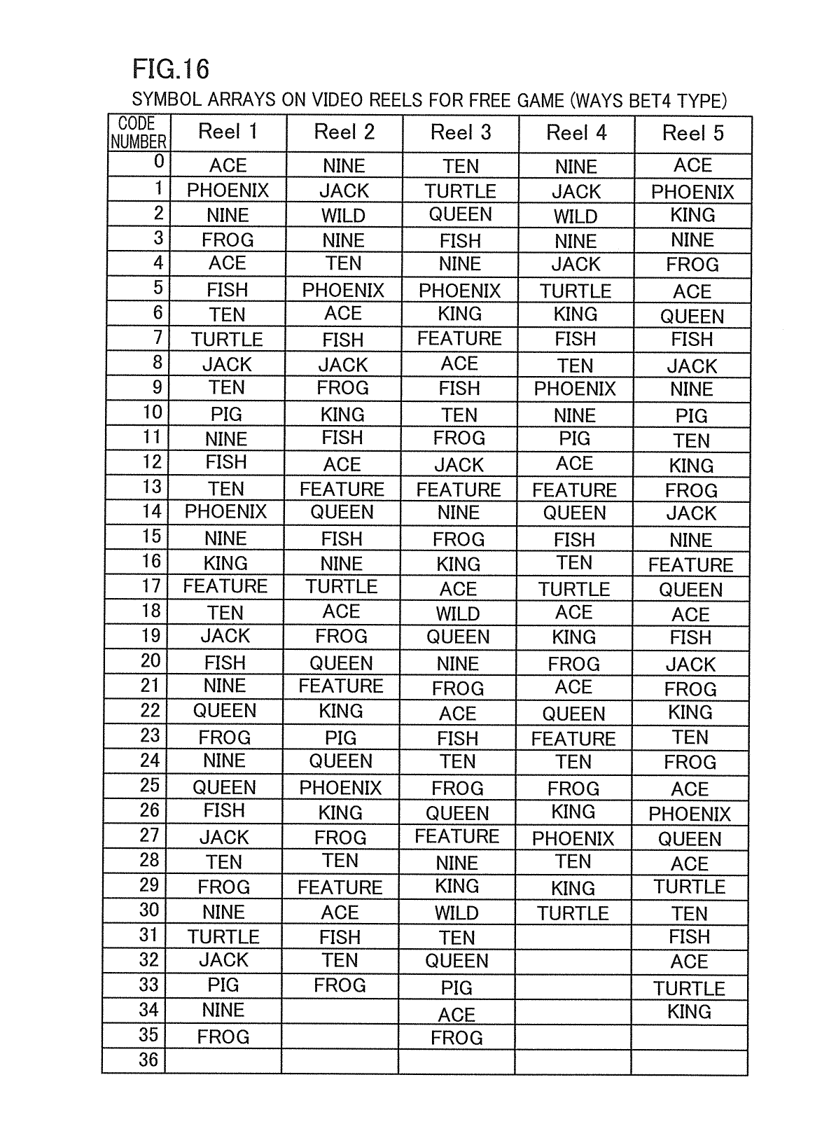

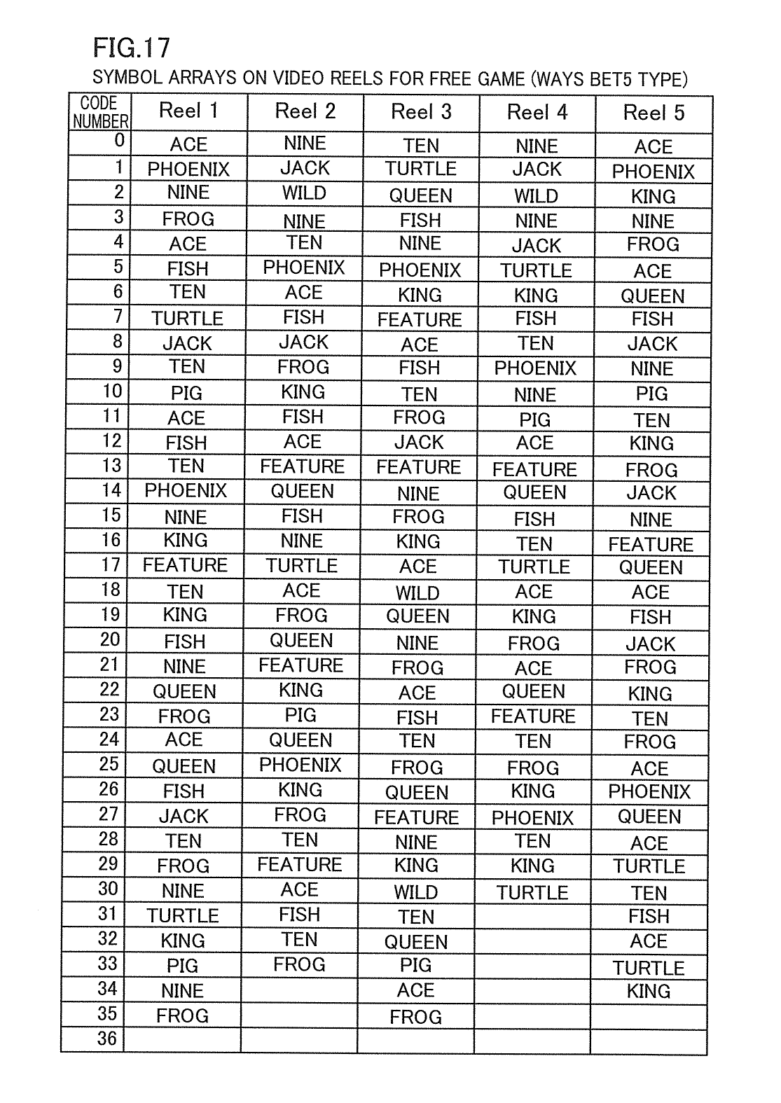

As shown in FIGS. 13 to 17, to a first video reel (“Reel 1”) 3a, a second video reel (“Reel2”) 3b, a third video reel (“Reel3”) 3c, a fourth video reel (“Reel4”) 3d, a fifth video reel (“Reel5”) 3e of the free game video reel 3, symbol arrays each constituted by symbols corresponding to code numbers “0” to “35” are allocated, respectively. The video reel 3 for the free game, which has the symbol arrays shown in FIG. 13, is used when the WAYS BET1 is selected. The video reel 3 for the free game, which has the symbol arrays shown in FIG. 14, is used when the WAYS BET2 is selected. The video reel 3 for the free game, which has the symbol arrays shown in FIG. 15, is used when the WAYS BET3 is selected. The video reel 3 for the free game, which has the symbol arrays shown in FIG. 16, is used when the WAYS BET4 is selected. The video reel 3 for the free game, which has the symbol arrays shown in FIG. 17, is used when the WAYS BET5 is selected.

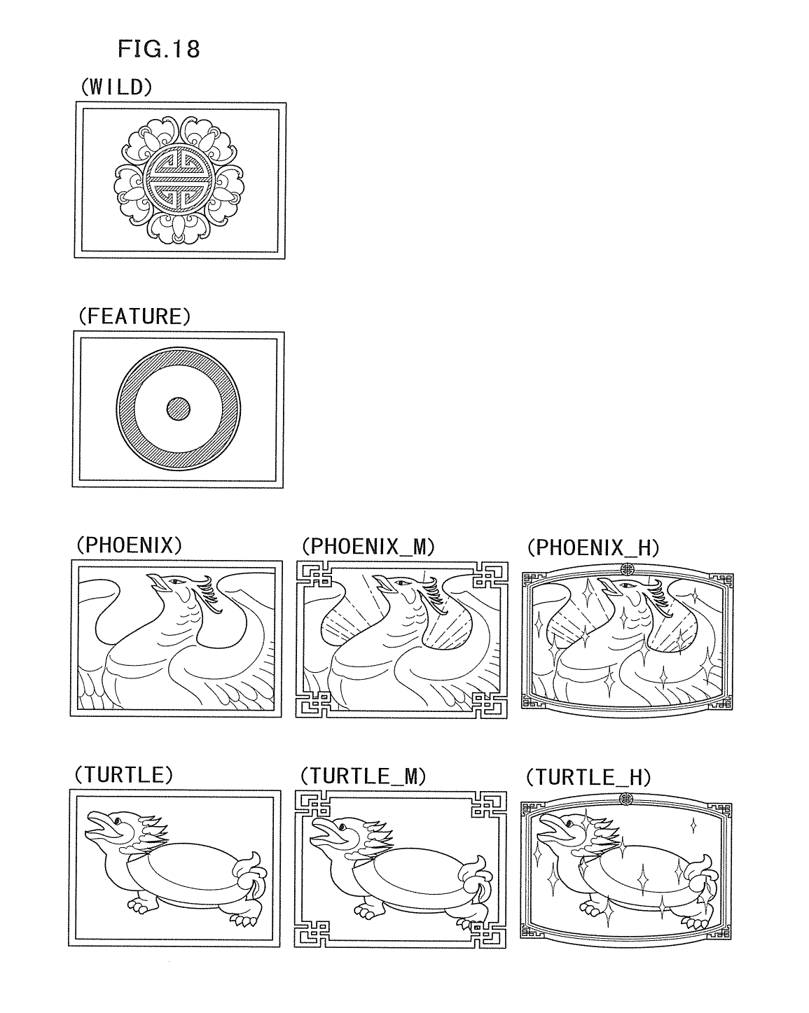

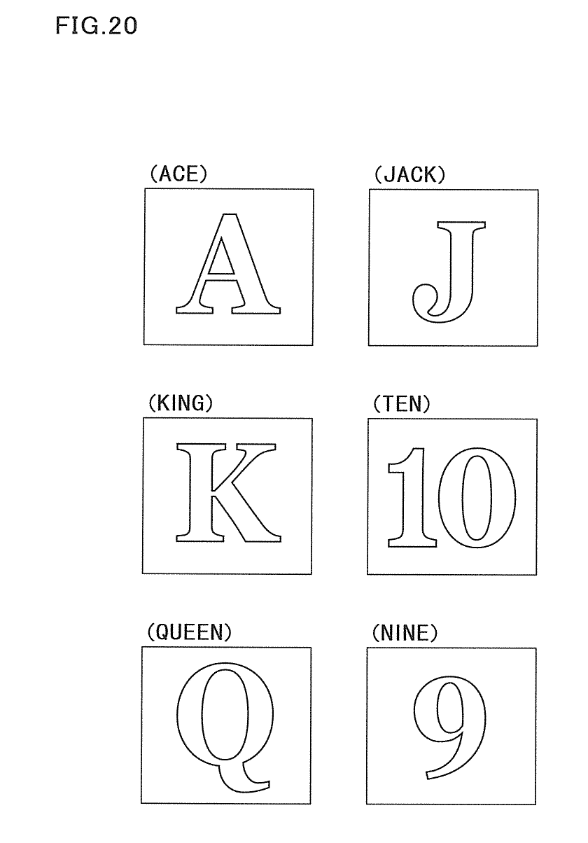

Further, as shown in FIGS. 18 to 20, the types of symbols arrayed on each video reel 3 include: normal symbols, a wild symbol which is an almighty symbol that could substitute for any other symbol, and a feature symbol that constitutes a condition for a winning (feature win) which awards the right to play the free game. The normal symbols are for example, “PHOENIX”, “TURTLE”, “FISH”, “FROG”, “PIG”, “ACE”, “KING”, “QUEEN”, “JACK”, “TEN”, and “NINE” (which are graphically shown in FIG. 18 to FIG. 20).

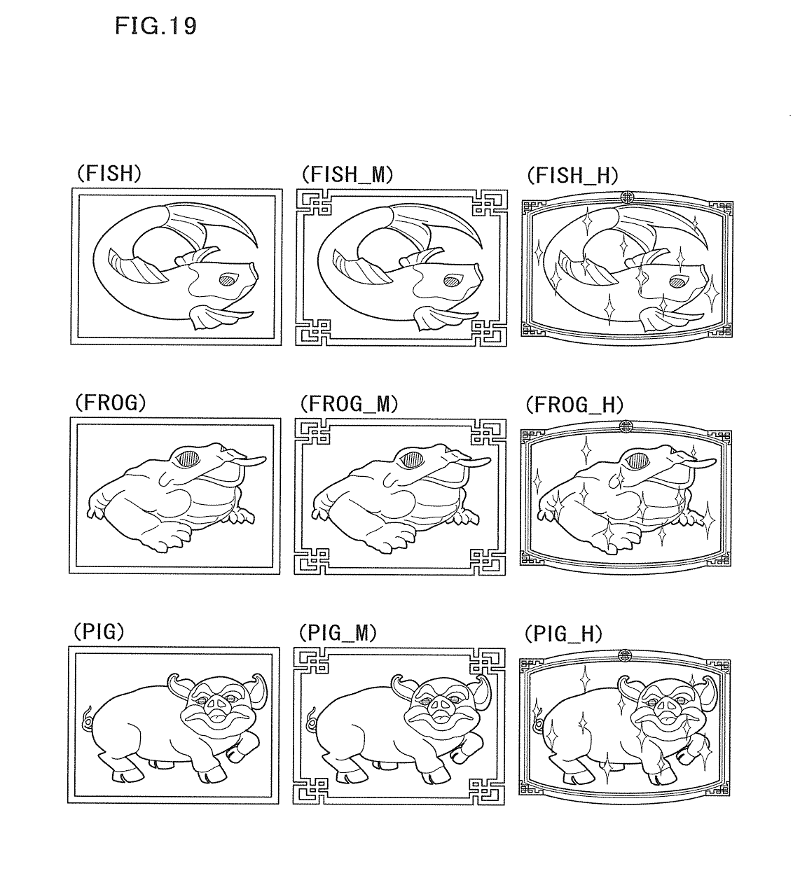

Symbol graphical images of “PHOENIX” include, as shown in FIG. 18, a symbol graphical image of normal-class “PHOENIX”, a symbol graphical image of middle-class “PHOENIX_M”, and a symbol graphical image of high-class “PHOENIX_H”. Symbol graphical images of “TURTLE” include, as shown in FIG. 18, a symbol graphical image of normal-class “TURTLE”, a symbol graphical image of middle-class “TURTLE_M”, and a symbol graphical image of high-class “TURTLE_H”. Symbol graphical images of “FISH” include, as shown in FIG. 19, a symbol graphical image of normal-class “FISH”, a symbol graphical image of middle-class “FISH_M”, and a symbol graphical image of high-class “FISH_H”. Symbol graphical images of “FROG” include, as shown in FIG. 19, a symbol graphical image of normal-class “FROG”, a symbol graphical image of middle-class “FROG_M”, and a symbol graphical image of high-class “FROG_H”. Symbol graphical images of “PIG” include, as shown in FIG. 19, a symbol graphical image of normal-class “PIG”, a symbol graphical image of middle-class “PIG_M”, and a symbol graphical image of high-class “PIG_H”. Each of symbol graphical images of “ACE”, “KING”, “QUEEN”, “JACK”, “TEN”, “NINE”, “WILD”, “FEATURE”, and the like is formed of a single type as shown in FIG. 18 to FIG. 20.

[Structures of Circuits Provided to Slot Machine]

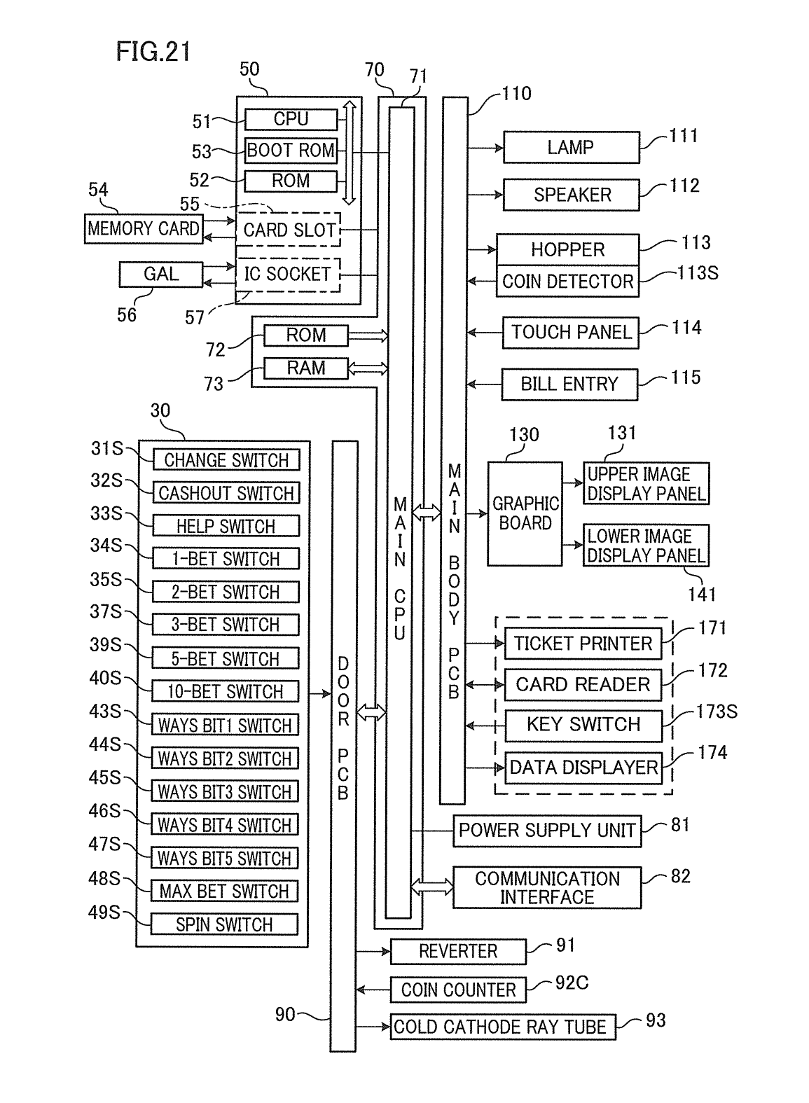

Now, referring to FIG. 21, the configuration of a circuit in the slot machine 1 will be described. FIG. 21 is a block diagram showing an internal structure of the slot machine related to the embodiment of the present invention.

A gaming board 50 is provided with a CPU 51, a ROM 52, and a boot ROM 53, which are mutually connected by an internal bus; a card slot 55 corresponding to a memory card 54; and an IC socket 57 corresponding to a GAL (Generic Array Logic) 56.

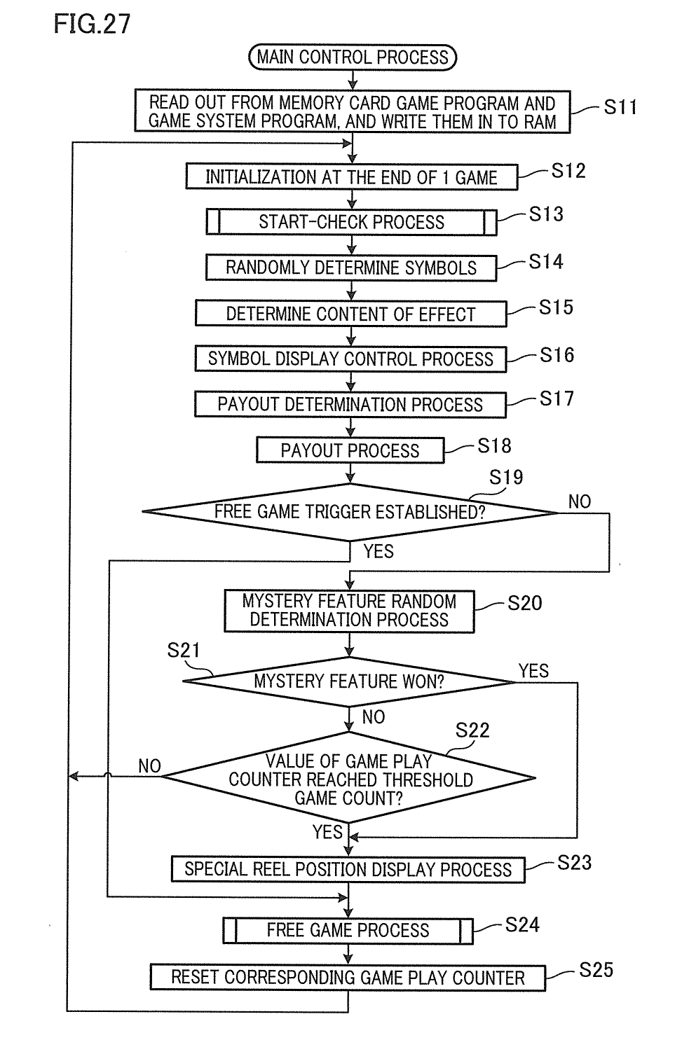

The memory card 54 includes a nonvolatile memory, and stores a game program and a game system program. The game program includes a program related to game progression, a random determination program, and a program for producing effects by images and sounds (see e.g., FIG. 27 to FIG. 29 described later). Furthermore, the game program includes data (see FIGS. 8 to 17) defining the arrangement of the symbol array allocated to each video reel 3.

The random determination program is a program for randomly determining to-be-stopped symbol on the video reels 3. The to-be-stopped symbol is data for determining three symbols to be displayed to the symbol display area 4 out of plural symbols forming each symbol array. The slot machine 1 of the embodiment of the present invention determines, as the to-be-stopped symbols, the symbols to be displayed in a predetermined area (e.g. the middle stage) out of the three areas provided for each of the video reels 151-155 of the symbol display area 4. This way symbols to be displayed in the three areas (the upper stage area, the middle stage area, and the lower stage area) corresponding to each video reel 3 of the symbol display area 4.

The aforementioned random determination program includes symbol determination data. The symbol determination data is data that specifies random numbers so that each of the symbols forming the symbol array is determined at an equal probability for each of the video reels 3. For example, for the first video reel (“Reel 1”) 3a of the normal game video reel 3 shown in FIG. 8, the data specifies the random numbers such that 28 symbols (with the code numbers “0” to “27”) constituting the symbol array are determined at the same probability (i.e., 1/28). However, because the number of the symbols in 28 symbols is different between the types, the probability of the selection is different between the types of the symbols (i.e., the types are differently weighted). For example, in FIG. 8, the symbol array of the first video reel 3a (“Reel 1”) of the normal game video reel 3 includes six “TEN” symbols and 1 “PHOENIX” symbol. Therefore the former is selected at the probability of “6/28” whereas the latter is selected at the probability of “1/28”.

While in the embodiment of the present invention the data is arranged to differentiate the number of symbols constituting the symbol array between the video reels 3 (29 symbols for the video reel 3a (Reel1), 29 symbols for the video reel 3b (Reel2), 28 symbols for the video reel 3c (Reel3), 27 symbols for video reel 3d (Reel4), and 34 symbols for the video reel 3e (Reel5)), the number of symbols constituting the symbol column may be identical between the video reels 3. For example, each of all symbol arrays of the video reels 3a to 3e of the video reels 3 may be constituted by 50 symbols. This arrangement increases the degree of freedom in setting the probabilities of the selection of the symbols of different types in each video reel 3.

Further, the card slot 55 is configured so that the memory card 54 can be inserted thereinto and removed therefrom, and is connected to a motherboard 70 by an IDE bus.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents and settings of the game to be played on the slot machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the pre-authentication program, and the like. The authentication program is a program (falsification check program) for authenticating the game program and the game system program. The preliminary authentication program is a program for authenticating the aforementioned authentication program. The authentication program and the pre-authentication program are written along a procedure (authentication procedure) for proving that the program to be the subject has not been falsified.

The motherboard 70 is provided with a main CPU 71, a ROM 72, a RAM 73, and a communication interface 82. The ROM 72 and the RAM 73 correspond to the storage unit.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted. Further, through the gaming board 50, a process of loading the game program and the game system program stored in the memory card 54 is started.

The processor of the present invention includes the main CPU 71, the ROM 72, and the RAM 73 above and the memory card 54 storing the game program and the game system program, and controls the slot machine by causing the CPU 71 to execute the game program and the game system program. Needless to say, the processor may alternatively store the game program and the game system program in the ROM 72 instead of the memory card 54.

The RAM 73 stores data and programs which are used in operation of the main CPU 71. For example, when the process of loading the aforementioned game program, game system program or authentication program is executed, the RAM 73 can store the program. The RAM 73 is provided with working areas used for operations when these programs are executed. Examples of the areas include: an area that stores counters for the number of games, the bet amount, the payout amount, the credit amount and the like; and an area that stores symbols (code numbers) randomly determined.

The communication interface 82 is for communicating with the external controller 200 such as a server, through the communication line 301. Further, the motherboard 70 is connected with a later-described door PCB (Printed Circuit Board) 90 and a main body PCB 110 by respective USBs. The motherboard 70 is also connected with a power supply unit 81. When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71. The door PCB 90 is connected with a control panel 30, a reverter 91, a coin counter 92C and a cold cathode tube 93.

For each of the buttons, the control panel 30 includes: a change switch 31S, a cashout switch 32S, a help switch 33S, a 1-bet switch 34S, a 2-bet switch 35S, a 3-bet switch 37S, a 5-bet switch 39S, a 10-bet switch 40S, a WAYS BET1 switch 43S, a WAYS BET2 switch 44s, a WAYS BET3 switch 45s, a WAYS BET4 switch 46s, a WAYS BET5 switch 47s, a MAX bet switch 48s, and a spin switch 49s. Each of the switches outputs a signal to the main CPU 71 upon detection of the pressing of the button corresponding thereto by the player.

The coin counter 92C checks whether a coin inserted into the coin receiving slot 36 is genuine in terms of the material, shape, or the like. When determining that the coin is genuine, the coin counter 92C outputs a signal to the main CPU 71. Non-genuine coins are ejected through a coin payout exit 15A.

The reverter 91 operates based on a control signal output from the main CPU 71, and distributes valid coins validated by the coin counter 92C into a hopper 113 or a cash box (not illustrated). That is, coins are distributed into the hopper 113 when the hopper 113 is not filled with coins, while coins are distributed into the cash box when the hopper 113 is filled with coins.

The cold cathode tube 93 functions as a backlight installed on the rear face side of the upper image display panel 131 and the lower image display panel 141, and turns on based on a control signal outputted from the main CPU 71.

To the main body PCB 110 are connected the lamp 111, the speaker 112, a hopper 113, a coin detector 113S, the touch panel 114, the bill entry 115, a graphic board 130, a ticket printer 171, a card reader 172, a key switch 173S and the data display 174.

The lamp 111 turns on based on a control signal outputted from the main CPU 71. The speakers 112 output BGM sound or the like in accordance with a control signal output from the main CPU 71.

The hopper 113 operates based on a control signal outputted from the main CPU 71, and pays out a designated number of coins from the coin payout exit 15A to the coin tray 15. The coin detector 113S outputs a signal to the main CPU 71 upon detection of coins paid out by the hopper 113.

The touch panel 114 detects a place on the lower image display panel touched by the player's finger or the like, and outputs to the main CPU 71 a signal corresponding to the detected place. Upon acceptance of a valid bill, the bill entry 115 outputs to the main CPU 71 a signal corresponding to the face amount of the paper money.

The graphic board 130 controls image display executed by the respective upper image display panel 131 and lower image display panel 141, based on a control signal outputted from the main CPU 71. The symbol display area 4 of the lower image display panel 141 displays the five video reels 3 by which the scrolling and stop motions of the symbol arrays included in the respective video reels 3 are displayed. The graphic board 130 is provided with a VDP generating image data, a video RAM temporarily storing the image data generated by the VDP, and the like.

The graphic board 130 is provided with the VDP (Video Display Processor) generating image data based on a control signal outputted from the main CPU 71, the video RAM temporarily storing the image data generated by the VDP, and the like. It is to be noted that the image data used for generating image data by the VDP is included in the game program that has been read from the memory card 54 and stored into the RAM 73.

Based on a control signal outputted from the main CPU 71, the ticket printer 171 prints on a ticket a barcode representing encoded data of the credit amount stored in the RAM 73, date and time, the identification number of the slot machine 1, and the like, and then outputs the ticket as the ticket 175 with a barcode.

The card reader 172 reads data stored in a card inserted into the card slot 176 and transmits the data to the main CPU 71, or writes data into the card based on a control signal outputted from the main CPU 71.

The key switch 173S is provided in the keypad 173, and outputs a predetermined signal to the main CPU 71 when the keypad 173 has been operated by the player.

The data display 174 displays data read by the card reader 172 and data inputted by the player through the keypad 173, based on a control signal outputted from the main CPU 71.

[Arrangement of Symbol Combination Table]

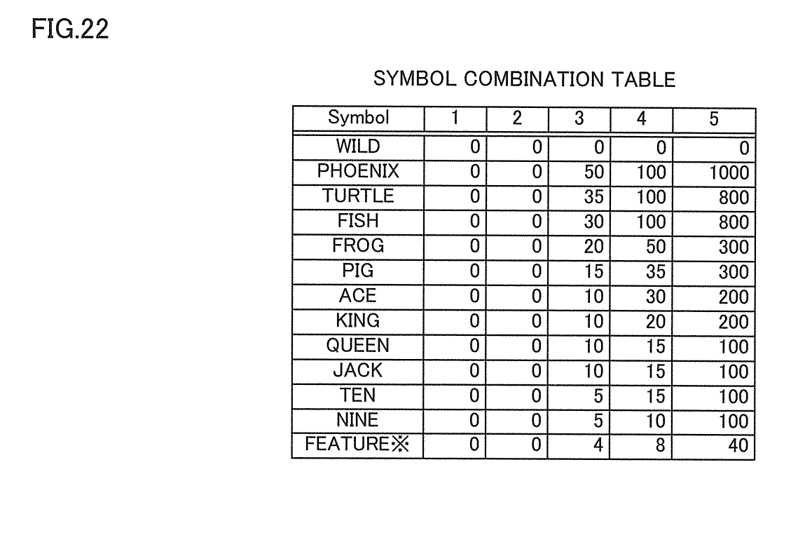

Now, symbol combination tables will be described with reference to FIG. 22. FIG. 22 shows a symbol combination table of the slot machine of the embodiment of the present invention.

The symbol combination tables of the present embodiment define the combinations of symbols (the number of symbols) with which a winning (WIN) is achieved and payout amounts. In the slot machine 1, a win is achieved when the scroll of the symbol array of each video reel 3 is stopped and symbols displayed in the symbol display area 4 forms a line which goes through the first array area to the fifth array area within the result determination area set to be the subject of the result determination by the WAYS BET. In accordance with the type of winning, a benefit such as the payout of coins is awarded to the player. In the present embodiment, the symbol combination table shown in FIG. 22 is referred to in the payout of the normal game and the free game.

Basically, a winning is achieved when a predetermined number of symbols of a single kind are arranged linked to one another, as in a 3Kind, 4Kind, or a 5Kind combination, through the first array area to the fifth array area, within the result determination area set as the subject to result determination, by the WAYS BET button. The above symbols of a single kind may be, “PHOENIX”, “TURTLE”, “FISH”, “FROG”, “PIG”, “ACE”, “KING”, “QUEEN”, “JACK”, “TEN”, and “NINE”. The symbol of “WILD” is substituted by any of the following symbols: “PHOENIX”, “TURTLE”, “FISH”, “FROG”, “PIG”, “ACE”, “KING”, “QUEEN”, “JACK”, “TEN”, and “NINE”. Regarding the “FEATURE” symbol, a payout and the right to play the free game are awarded if “FEATURE” symbol occurs in three or more consecutive positions through the first array area to the fifth array area (when 3 or more Kind combination of the “FEATURE” is formed), irrespective of the area turned active by the WAYS BET button.

For example, when the “WAYS BET5” is selected, all the areas out of the symbol display area 4 are subjected to result determination (activated). When the scroll of the symbol arrays on the video reels 3 is stopped and the “PHOENIX” symbol occurs in the lower stage of the first array area, the upper stage of the second array area, the upper stage of the third array area, the middle stage of the fourth array area, and the lower stage of the fifth array area, there is a win in which the symbol occurs in five linked positions from the first array area to the fifth array area (5Kind combination of “PHOENIX” is formed). In this case, the symbol combination table shown in FIG. 22 is referred to, and a payout amount of “1000” is determined. Based on the determined payout amount, coins are paid out. The coins are paid out in the form of: actual output of coins from the coin payout exit 15A; adding the number of coins to the credits; or issuance of a barcode ticket.

Further, for a winning related to, “PHOENIX”, “TURTLE”, “FISH”, “FROG”, “PIG”, “ACE”, “KING”, “QUEEN”, “JACK”, “TEN”, “NINE”, “FEATURE”, a product of the value associated with the credit type of the normal game multiplied by the value defined in the symbol combination table is paid out. For example, when a winning related to three “PHOENIX” symbols is achieved (when 3Kind combination of “PHOENIX” is formed in a unit game where 10 bet is placed by the 10-BET button 40, the awarded credits will be 50×10=500. When winning “FEATURE”, the right to execute the free game is awarded.

(Game Play Counter)

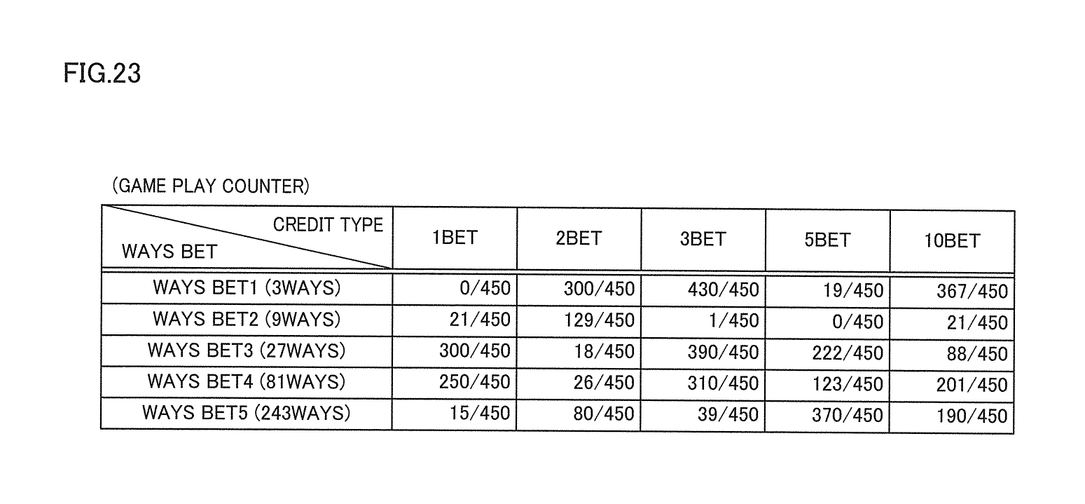

As shown in FIG. 23, in the present embodiment, the RAM 73 is provided with 25 game play counters in total each configured to count the number of play of the game at each start of the normal game to correspond to five types of WAYS BET (WAYS BET1, WAYS BET2, WAYS BET3, WAYS BET4, and WAYS BET5 in the present embodiment) and five credit types (1BET, 2BET, 3BET, 5BET, and 10BET in the present embodiment).

Furthermore, as shown in FIG. 23, in each game play counter, a threshold game play count is set at “450”. For example, when starting the normal game, if the WAYS BET1 button 43 and the 3-BET button 37 are selected, the game play counter corresponding to the WAYS BET1 (3WAYS) and the 3BET is incremented by “1” (“430/450” is updated to “431/450”). Similarly, when starting the normal game, if the WAYS BET5 button 47 and the 10-BET button 40 are selected, the game play counter corresponding to the WAYS BET5 (243WAYS) and the 10BET is incremented by “1” (“190/450” is updated to “191/450”). In this way, in the present embodiment, the RAM 73 is provided with 25 game play counters to correspond to five types of WAYS BET and five credit types, and each game play counter is able to independently store the number of play of the game. While in the present embodiment the threshold game play counts of the respective game play counter are identical (“450”), the threshold game play counts may be different between the game play counters or each determined by random determination.

With the game play counters described above, at the start of the normal game, the game play counter corresponding to the selected WAYS BET and the selected credit type is incremented, and the right to execute the free game 10 times is awarded when the value of the game play counter reaches the threshold game play count. As such, because 25 game play counters corresponding to the types of the WAYS BET and the credit types are independently provided, the credit types based on which the player places a bet and the types of the WAYS BET selectable by the player are diversified.

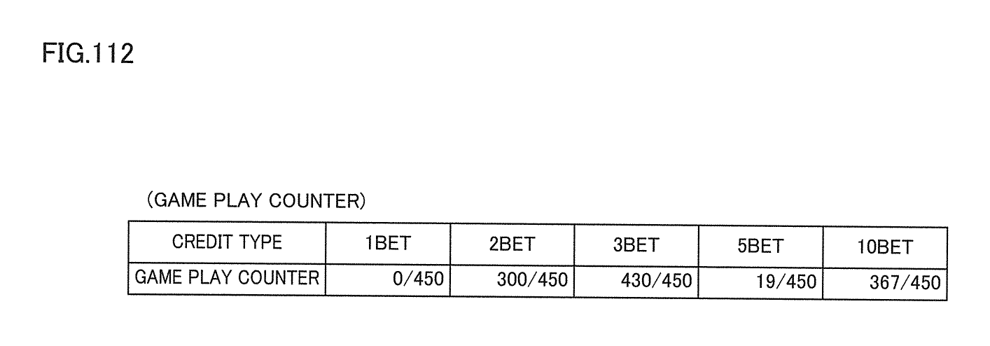

In the description above, 25 game play counters are provided in total to correspond to five types of WAYS BET and five credit types. Alternatively, as shown in FIG. 112, only five game play counters corresponding to five credit types may be provided. In this case, when starting the normal game, the game play counter corresponding to the selected credit type is incremented by “1” (irrespective of the selected type of the WAYS BET).

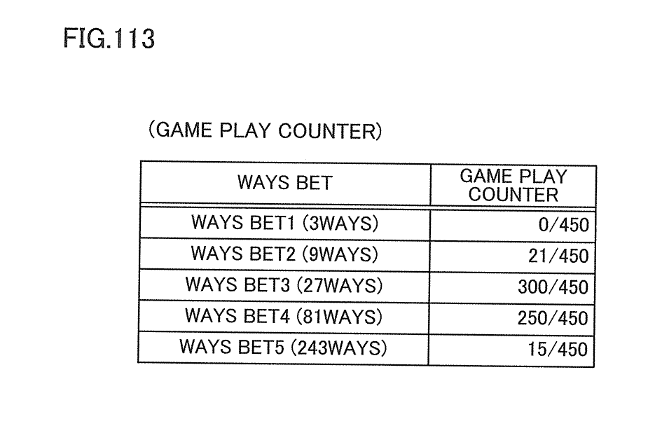

In addition to the above, as shown in FIG. 113, only five game play counters corresponding to five types of the WAYS BET may be provided. In this case, when starting the normal game, the game play counter corresponding to the selected type of the WAYS BET is incremented by “1” (irrespective of the selected credit type).

(Free Game Payout Rate Random Determination Table Determination Table)

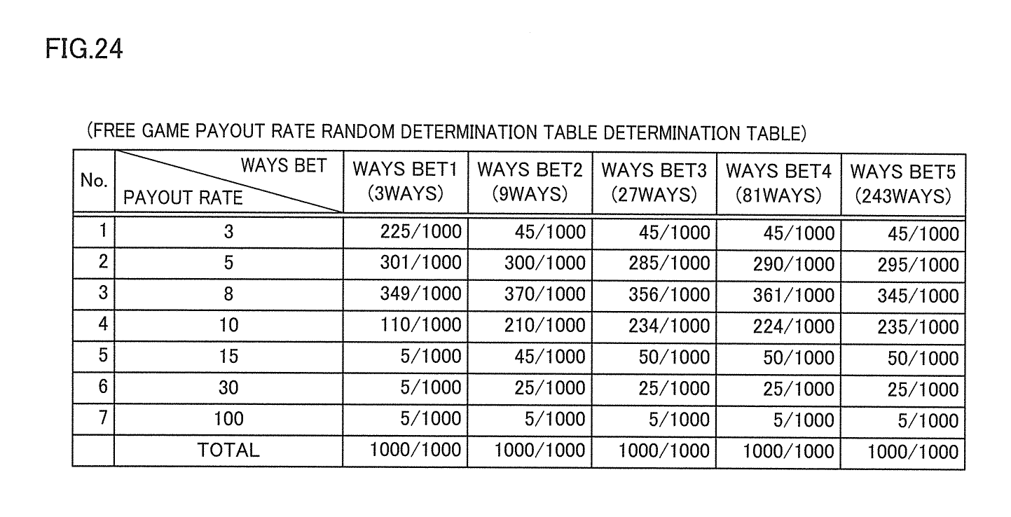

The following describes a free game payout rate random determination table determination table with reference to FIG. 24. The free game payout rate random determination table determination table is referred to in a later-described free game payout rate random determination table determination process.

As shown in FIG. 24, in the free game payout rate random determination table determination table, “five types of free game payout rate random determination tables in which seven types of payout rates from ×3 to ×100 are associated with random determination probabilities” and “five types of WAYS BET” are associated with one another.

To be more specific, in the free game payout rate random determination table associated with the WAYS BET1 (3WAYS), a payout rate ×3 is associated with a random determination probability of 225/1000, a payout rate ×5 is associated with a random determination probability of 301/1000, a payout rate ×8 is associated with a random determination probability of 349/1000, a payout rate ×10 is associated with a random determination probability of 110/1000, a payout rate ×15 is associated with a random determination probability of 5/1000, a payout rate ×30 is associated with a random determination probability of 5/1000, and a payout rate ×100 is associated with a random determination probability of 5/1000.

In the free game payout rate random determination table associated with the WAYS BET2 (9WAYS), a payout rate ×3 is associated with a random determination probability of 45/1000, a payout rate ×5 is associated with a random determination probability of 300/1000, a payout rate ×8 is associated with a random determination probability of 370/1000, a payout rate ×10 is associated with a random determination probability of 210/1000, a payout rate ×15 is associated with a random determination probability of 45/1000, a payout rate ×30 is associated with a random determination probability of 25/1000, and a payout rate ×100 is associated with a random determination probability of 5/1000.

In the free game payout rate random determination table associated with the WAYS BET3 (27WAYS), a payout rate ×3 is associated with a random determination probability of 45/1000, a payout rate ×5 is associated with a random determination probability of 285/1000, a payout rate ×8 is associated with a random determination probability of 356/1000, a payout rate ×10 is associated with a random determination probability of 234/1000, a payout rate ×15 is associated with a random determination probability of 50/1000, a payout rate ×30 is associated with a random determination probability of 25/1000, and a payout rate ×100 is associated with a random determination probability of 5/1000.

In the free game payout rate random determination table associated with the WAYS BET4 (81WAYS), a payout rate ×3 is associated with a random determination probability of 45/1000, a payout rate ×5 is associated with a random determination probability of 290/1000, a payout rate ×8 is associated with a random determination probability of 361/1000, a payout rate ×10 is associated with a random determination probability of 224/1000, a payout rate ×15 is associated with a random determination probability of 50/1000, a payout rate ×30 is associated with a random determination probability of 25/1000, and a payout rate ×100 is associated with a random determination probability of 5/1000.

In the free game payout rate random determination table associated with the WAYS BET5 (243WAYS), a payout rate ×3 is associated with a random determination probability of 45/1000, a payout rate ×5 is associated with a random determination probability of 295/1000, a payout rate ×8 is associated with a random determination probability of 345/1000, a payout rate ×10 is associated with a random determination probability of 235/1000, a payout rate ×15 is associated with a random determination probability of 50/1000, a payout rate ×30 is associated with a random determination probability of 25/1000, and a payout rate ×100 is associated with a random determination probability of 5/1000.

The free game payout rate random determination table determination table is referred to when, at the time of the awarding of the right to execute the free game, the free game payout rate random determination table, based on which the payout rate by which the payout awarded in the free game is multiplied is determined, is selected based on the WAYS BET selected in the normal game (when the free game trigger is established or the mystery feature is won) or based on the WAYS BET corresponding to the game play counter having reached the threshold game play count.

For example, when the value of the game play counter corresponding to the WAYS BET1 (3WAYS) and the 3BET reaches the threshold game play count “450”, with reference to the free game payout rate random determination table determination table shown in FIG. 24, the free game payout rate random determination table associated with the WAYS BET1 (3WAYS) is selected. By the random determination of the payout rate based on the free game payout rate random determination table associated with the WAYS BET1 (3WAYS), the payout rate by which the payout awarded in the free game is multiplied is determined.

For example, when the normal game is run with the WAYS BET3 (27WAYS) and the 5BET and the free game trigger is established or the mystery feature is won, with reference to the free game payout rate random determination table determination table shown in FIG. 24, the free game payout rate random determination table associated with the WAYS BET3 (27WAYS) is selected. By the random determination of the payout rate based on the free game payout rate random determination table associated with the WAYS BET3 (27WAYS), the payout rate by which the payout awarded in the free game is multiplied is determined.

With the above-described free game payout rate random determination table determination table, the free game awarded when the free game trigger is established or the mystery feature is won as a result of the normal game and the free game awarded when the value of the game play counter reaches the threshold game play count are able to share the free game payout rate random determination table for determining the payout rate by which the payout is multiplied in the free game and the free game payout rate random determination table determination table for selecting the free game payout rate random determination table. On this account, the free game is run on the same conditions irrespective of the way of shifting to the free game (i.e., the free game is enjoyed without feeling the sense of unfairness).

(Mystery Feature Winning Table)

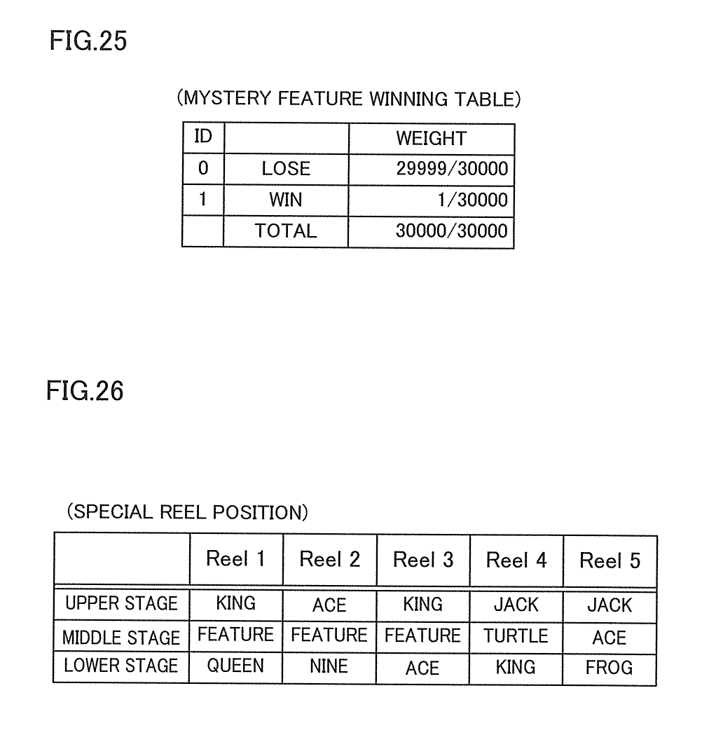

The following describes a mystery feature winning table with reference to FIG. 25. The mystery feature winning table is stored in the RAM 73, and is read out in a later-described mystery feature random determination process.

The mystery feature winning table is a table for use in determining whether or not the mystery feature is won. As shown in FIG. 25, “not-win” is associated with a probability of 29999/30000, and “win” is associated with 1/30000.

(Special Reel Position)

A special reel position will be described with reference to FIG. 26. The special reel position is a combination of symbols rearranged in the symbol display area 4 under a predetermined condition. The special reel position in the present embodiment is arranged such that, in 15 areas forming a 5 by 3 matrix in the symbol display area 4, symbols “KING”, “FEATURE”, and “QUEEN” are rearranged on the upper stage, the middle stage, and the lower stage of the first array area (Reel1), the symbols “ACE”, “FEATURE”, and “NINE” are rearranged on the upper stage, the middle stage, and the lower stage of the second array area (Reel2), the symbols “KING”, “FEATURE”, and “ACE” are rearranged on the upper stage, the middle stage, and the lower stage of the third array area (Reel3), the symbols “JACK”, “TURTLE”, and “KING” are rearranged on the upper stage, the middle stage, and the lower stage of the fourth array area (Reel4), and the symbols “JACK”, “ACE”, and “FROG” are rearranged on the upper stage, the middle stage, and the lower stage of the fifth array area (Reel5). In the present embodiment, the symbols above are rearranged in the symbol display area 4 as the special reel position, when the value of the game play counter reaches the threshold game play count or the mystery feature is won in the normal game.

According to the arrangement above, the combination of the symbols displayed in the symbol display area 4 when the value of the game play counter reaches the threshold game play count is arranged to be identical with the combination of the symbols displayed in the symbol display area 4 when the mystery feature is won in the normal game. On this account, when the right to execute the free game is awarded, it is difficult to tell from the outside (according to the combination of the symbols displayed in the symbol display area 4) whether the right to execute the free game is awarded because the value of the game play counter reaches the threshold game play count or because the mystery feature is won as a result of the normal game. Therefore it is difficult to estimate the threshold game play count from the outside, and hence expectations on when the right to execute the free game game is awarded as the value of the game play counter reaches the threshold game play count are maintained.

[Contents of Program]

Now, the program to be executed by the slot machine 1 is described with reference to FIG. 27 to FIG. 29.

(Main Control Process)

First, with reference to FIG. 27, a main control process is described. It should be noted that the normal game is run in the main control process.

First, when the slot machine 1 is powered on, the main CPU 71 reads an authenticated game program and a game system program from a memory card 54 via a gaming board 50, and then write them in the RAM 73 (Step S11).

Next, the main CPU 71 executes an initializing process at the end of each round of the game (Step S12). This process clears data in a working area of the RAM 73, which becomes unnecessary at the end of each round of game, e.g., the amount of bet, symbols randomly determined, and the like.

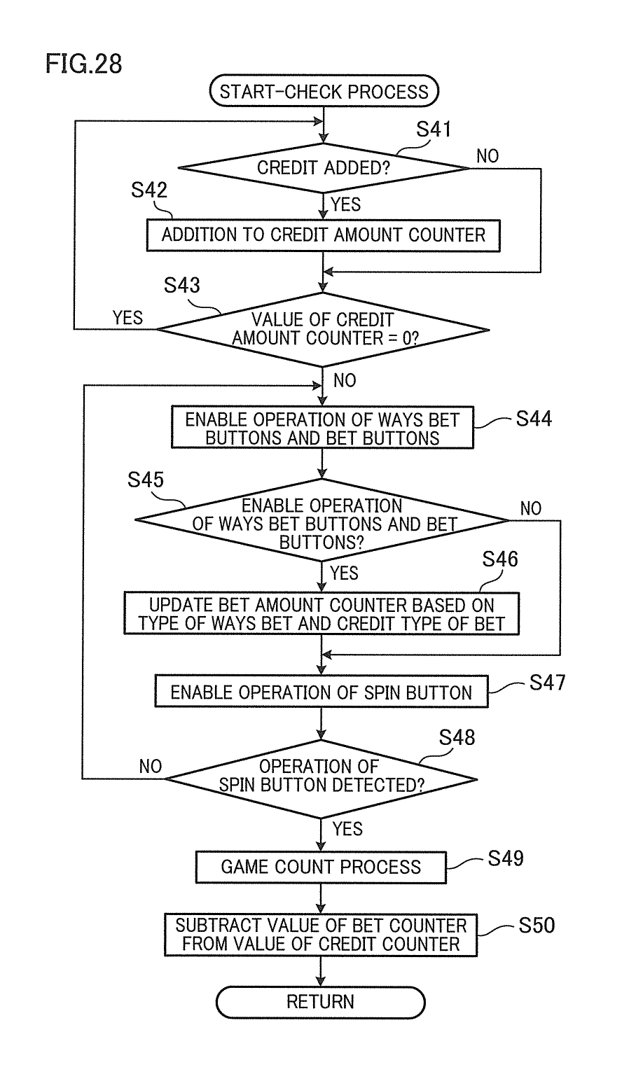

Next, the main CPU 71 executes a start-check process described later with reference to FIG. 28 (step S13). In this process is carried out input checking and the like, to: the 1-bet switch 34S, the 2-bet switch 35S, the 3-bet switch 37S, the 5-bet switch 39S, 10-bet switch 40S, the WAYS BET1 switch 43S, the WAYS BET2 switch 44S, the WAYS BET3 switch 45S, the WAYS BET4 switch 46S, the WAYS BET5 switch 47S, the spin switch 49S, and the like.

Next, the main CPU 71 executes a symbol random determination process (S14). In this process, symbols to be stopped are determined based on random numbers for symbol determination. In the present embodiment, a symbol array corresponding to the WAYS BET selected in S45 of a start-check process which will be described later with reference to FIG. 28 is used (see FIG. 8 to FIG. 12).

Specifically, the main CPU 71 first samples random numbers for symbol determination. The main CPU 71 then randomly determines symbols to be stopped on the video reels 3 (3a, 3b, 3c, 3d, and 3e). The main CPU 71 executes random determination for each of the video reels 3 (3a, 3b, 3c, 3d, and 3e), and determines any one of the symbols as the symbols to be stopped. The symbols are determined at equal probabilities. The main CPU 71 stores the symbols determined as to stop on each video reel 3 in a symbol storing area in the RAM 73.

The main CPU 71 then executes an effect contents determination process (S15). The main CPU 71 samples an effect-use random number and randomly determines any of a plurality of predetermined contents of effect.

Next, the main CPU 71 executes a symbol display control process (step S16). In the process, the scroll of the symbol array on each video reel 3 is started, and the symbols determined as the symbols to stop in the symbol random determination process of S14 are stopped at a predetermined positions (e.g. the middle stage in the symbol display area 4). That is, 15 symbols including the symbols to be stopped are displayed in the symbol display area 4. For example, the symbol with the code number “10” is to be stopped in the middle stage area, the symbols with the code numbers “9” and “11” are displayed in the upper stage and the lower stage of the symbol display area 4, respectively.

Next, the main CPU 71 executes a payout amount determination process (step S17). In this process, a symbol combination table (see FIG. 22) stored in the RAM 73 is referred to, to determine whether the symbols stopped in the symbol display area 4 include symbols linked to one another through the first array area to the fifth array area in the WAYS BET set as the subject of the result determination area, thus achieving a win. In accordance with the type of winning and the credit type used in betting, a benefit such as the payout or the right to play the free game is awarded to the player. The payout awarded is stored in a payout amount storage area of the RAM 73.

Next, the S18 executes a payout process (step S18). The main CPU 71 adds a value stored in the payout amount storage area to a value stored in the credit counter stored in the credit amount storage area provided in the RAM 73.

Next, the main CPU 71 determines whether or not a free game trigger is met (S19). In the present embodiment, the trigger for transition to the free game is the “FEATURE” symbol occurs in three or more consecutive positions through the first array area to the fifth array area, irrespective of the area activated by a WAYS BET button. The main CPU 71, when determining that the free game trigger has been established (S19: YES), executes a later described free game process (step S24).

Next, the main CPU 71, when determining that the free game trigger is not established in the step S19 (S19: NO), executes the mystery feature random determination process (S20). In the mystery feature random determination process, a random number is sampled to determine whether or not the mystery feature results in the winning or not winning, based on the mystery feature winning table (see FIG. 25) stored in RAM 73.

Next, the main CPU 71 determines whether or not the mystery feature is won (S21). When the mystery feature is won (S21: YES), a special reel position display process is executed (S23). In the special reel position display process, as described above, in 15 areas forming a 5 by 3 matrix in the symbol display area 4, symbols “KING”, “FEATURE”, and “QUEEN” are rearranged on the upper stage, the middle stage, and the lower stage of the first array area (Reel1), the symbols “ACE”, “FEATURE”, and “NINE” are rearranged on the upper stage, the middle stage, and the lower stage of the second array area (Reel2), the symbols “KING”, “FEATURE”, and “ACE” are rearranged on the upper stage, the middle stage, and the lower stage of the third array area (Reel3), the symbols “JACK”, “TURTLE”, and “KING” are rearranged on the upper stage, the middle stage, and the lower stage of the fourth array area (Reel4), and the symbols “JACK”, “ACE”, and “FROG” are rearranged on the upper stage, the middle stage, and the lower stage of the fifth array area (Reel5), as the special reel position.

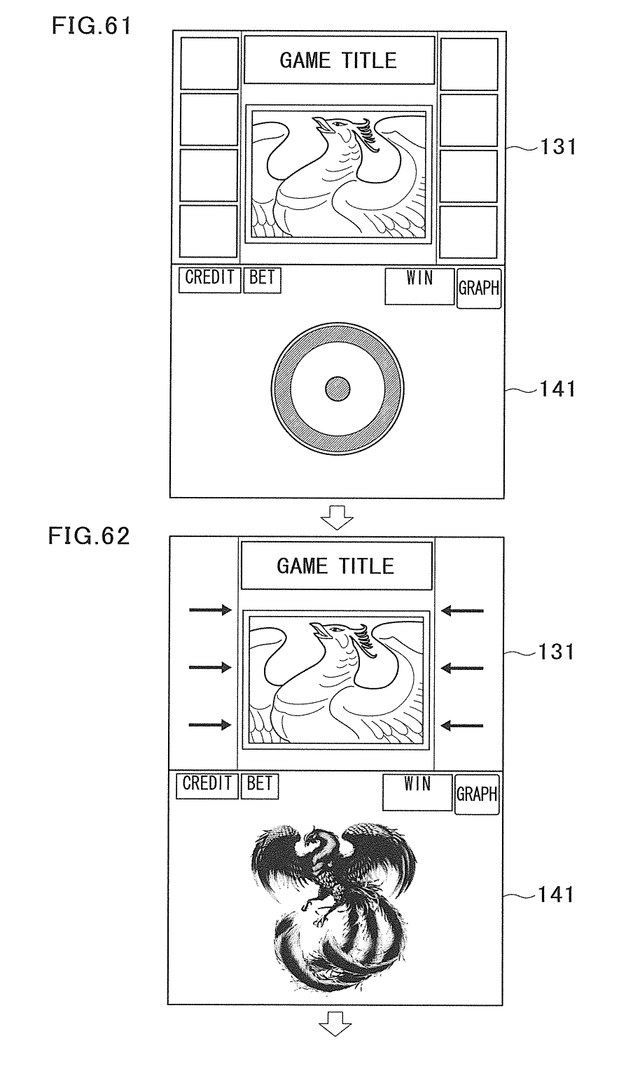

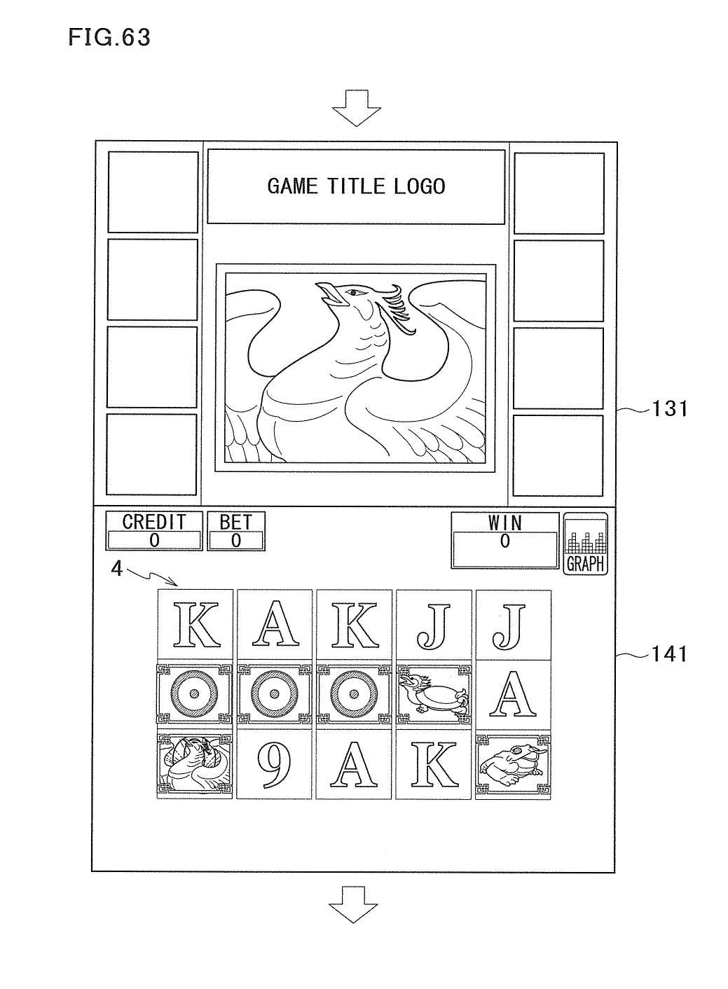

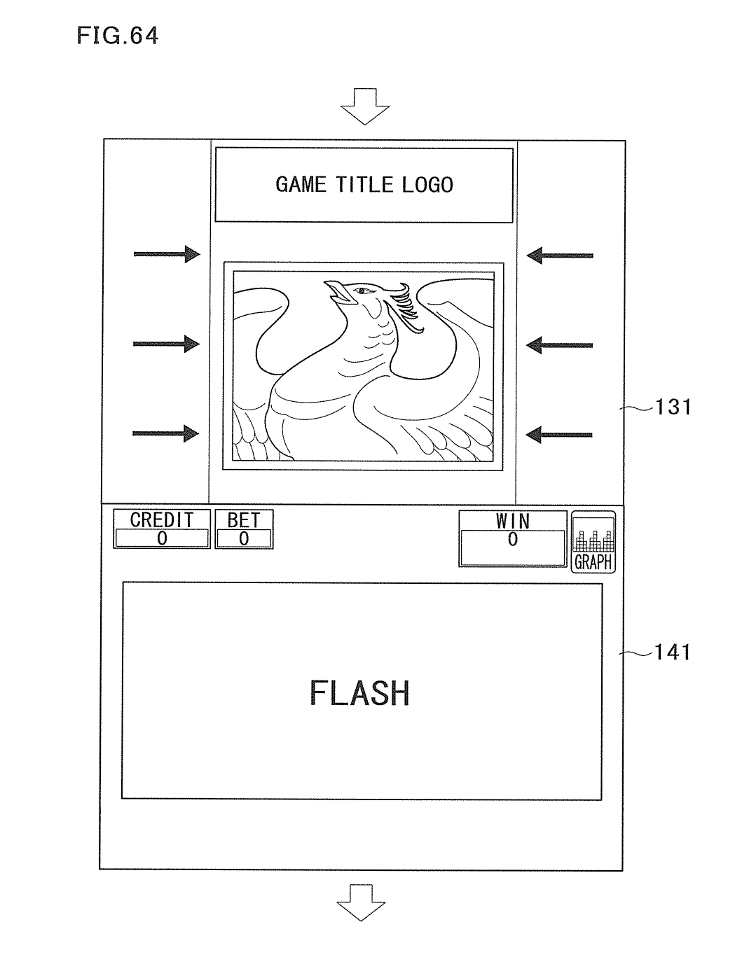

In the present embodiment, when the mystery feature is won, as shown in FIG. 61 and FIG. 62, animation of the “PHOENIX” is displayed on the lower image display panel 141, and then the symbols in the special reel position are rearranged in the symbol display area 4 of the lower image display panel 141 as shown in FIG. 63. Thereafter, a flashing image effect is executed on the lower image display panel 141 as shown in FIG. 64.

On the other hand, if the mystery feature is not won (S21: NO), whether or not the value on the game play counter counted in the game play count process (later-described S49) in the start-check process has reached the threshold game play count of 450 (S22) is determined. If the value on the game play counter has not yet reached the threshold game play count of 450 (S22: NO), the process transits to S12.

In the meanwhile, when the value of the game play counter reaches “450” which is the threshold game play count (S22: YES), the special reel position display process is executed (S23). In the present embodiment, also when the value of the game play counter reaches the threshold game play count, as shown in FIG. 61 and FIG. 62, the animation of the “PHOENIX” is displayed on the lower image display panel 141, and then the symbols in the special reel position are rearranged in the symbol display area 4 of the lower image display panel 141 as shown in FIG. 63. Thereafter, a flashing image effect is executed on the lower image display panel 141 as shown in FIG. 64.

Subsequently, after the step S23, a later-described free game process is executed (step S24).

After the free game process in S24, a corresponding value of the game play counter is reset (to zero) (S25).

To be more specific, when the value of the game play counter reaches the threshold game play count, in case of the execution of the free game process, only the value of the game play counter having reached the threshold game play count is reset, whereas the values of the other 24 game play counters are maintained.

When the free game process is executed after the establishment of the free game trigger or after the winning of the mystery feature, the resetting is done only for the game play counter corresponding to the type of the WAYS BET and the credit type selected in the start-check process of S13. For example, when the WAYS BET5 and the 5BET are selected in the start-check process in S13, only the value of the game play counter corresponding to the WAYS BET5 (243WAYS) and the 5BET is reset, whereas the values of the other 24 game play counters are maintained. Alternatively, when the free game process is executed after the establishment of the free game trigger or after the winning of the mystery feature, the values of all (25) game play counters each corresponding to the type of the WAYS BET and the credit type may be reset.

As described above, when the value of the game play counter reaches the threshold game play count, the right to execute the free game is awarded, and only the value of the game play counter having reaches the threshold game play count is reset, and the values of the game play counters which have not reached the threshold game play count are maintained. This induces the player to select the WAYS BET and the bet type corresponding to a game play counter which has not reached the threshold game play count.

After S25, the process transits to the step S12.

(Start-Check Process)

Next, the start-check process is described reference to FIG. 28.

First, the main CPU 71 reads a barcode attached ticket 175 through the bill entry 115, and determines if there is an addition of a credit (step S41). When determining that there is addition of a credit (S41: YES), the main CPU 71 adds the specified amount of credits to the value stored in the credit counter stored in the credit amount storage area of the RAM 73 (step S42). It should be noted that the subject to be read by the bill entry 115 includes paper money, an IC card and the like, in addition to the barcode attached ticket 175.

After the step S42 or when determining in the step S41 that there is no addition of credits (S41: NO), the main CPU 71 determines whether or not the value of the credit counter stored in the credit amount storage area is 0 (step S43). The process then transits to the step S41, if the value of the credit counter stored in the credit amount storage area is 0 (S43: YES).

On the other hand, when the main CPU 71 determines that the value of the credit counter stored in the credit amount storage area is not 0 (S43: NO), the main CPU 71 enables operation of the WAYS BET buttons (WAYS BET1 button 43, WAYS BET2 button 44, WAYS BET3 button 45, WAYS BET4 button 46, WAYS BET5 button 47) and the bet buttons (1-bet button 34, 2-bet button 35, 3-bet button 37, 5-bet button 39, 10-bet button 40, and MAX BET button 48) (step S44). By selecting any of the five types of WAYS BET buttons, a result determination area to be subjected to result determination is selected out of 15 areas of the 5 by 3 matrix of the symbol display area 4 (see FIG. 6).

Next, the main CPU 71 determines if an operation of the WAYS BET button or the bet button is detected (step S45). When the main CPU 71 detects pressing of the WAYS BET button by the player through the WAYS BET switch (WAYS BET1 switch 43S, WAYS BET2 switch 44s, WAYS BET3 switch 45s, WAYS BET4 switch 46s, WAYS BET5 switch 47s) and detects pressing of the bet button by the player through the bet switch (1-bet switch 34S, 2-bet switch 35S, 3-bet switch 37S, 5-bet switch 39S, 10-bet switch 40S, MAX bet switch 48S), the main CPU 71 updates the value of the bet amount counter stored in the bet amount storage area provided in the RAM 73, based on the product of the amount of credit necessary for the selected WAYS BET (1 credit for WAYS BET1, 5 credits for WAYS BET2, 10 credits for WAYS BET3, 20 credits for WAYS BET 4, and 30 credits for WAYS BET5) multiplied by the amount of credit corresponding to the bet button operated (step S46).

After step S46 or when no operation of the WAYS BET button or the bet button is detected in step S45 (S45: NO), the main CPU 71 enables operation of the spin button 49 (S47).

After the step S47, the main CPU 71 determines whether or not an operation of the spin button 49 is detected (step S48). When the main CPU 71 determines that an operation of the spin button 49 is not detected (S48:NO), the process moves to the step S44.

On the other hand, when the main CPU 71 determines that the operation of the spin button 49 has been detected (S48: YES), the game play count process is executed (step S49). In the game play count process, the value of the game play counter (see FIG. 23) corresponding to the type of the WAYS BET and the credit type received in S45 is incremented by 1. For example, when the WAYS BET1 button 43 and the 3-BET button 37 are selected in S45, the game play counter corresponding to the WAYS BET1 (3WAYS) and the 3BET is incremented by “1” (i.e., updated from “430/450” to “431/450”).

After the step S49, the main CPU 71 subtracts the value on the bet amount counter calculated in the step S46 from the value of the credit counter stored in the credit amount storage area (step S50). Then, the start-check process is terminated.

(Free Game Process)

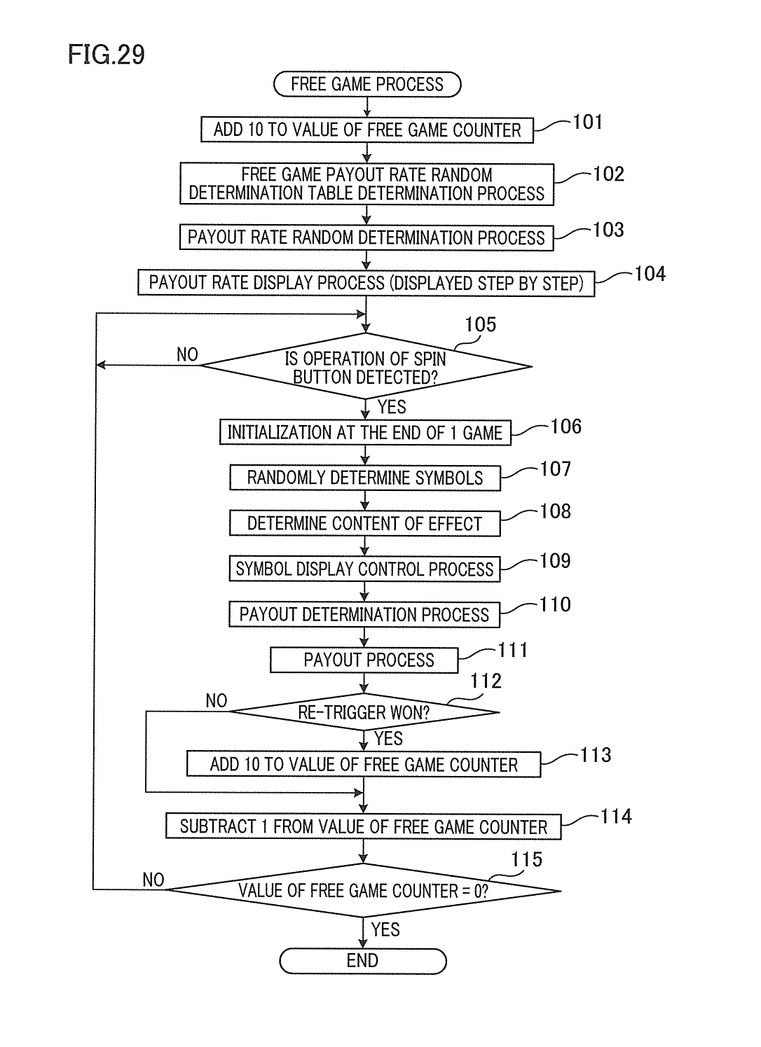

The following describes a free game process with reference to FIG. 29. FIG. 29 is a flowchart of a free game process of the slot machine related to the embodiment of the present invention.

To begin with, the main CPU 71 adds “10” to the free game play counter in the RAM 73 (S101).

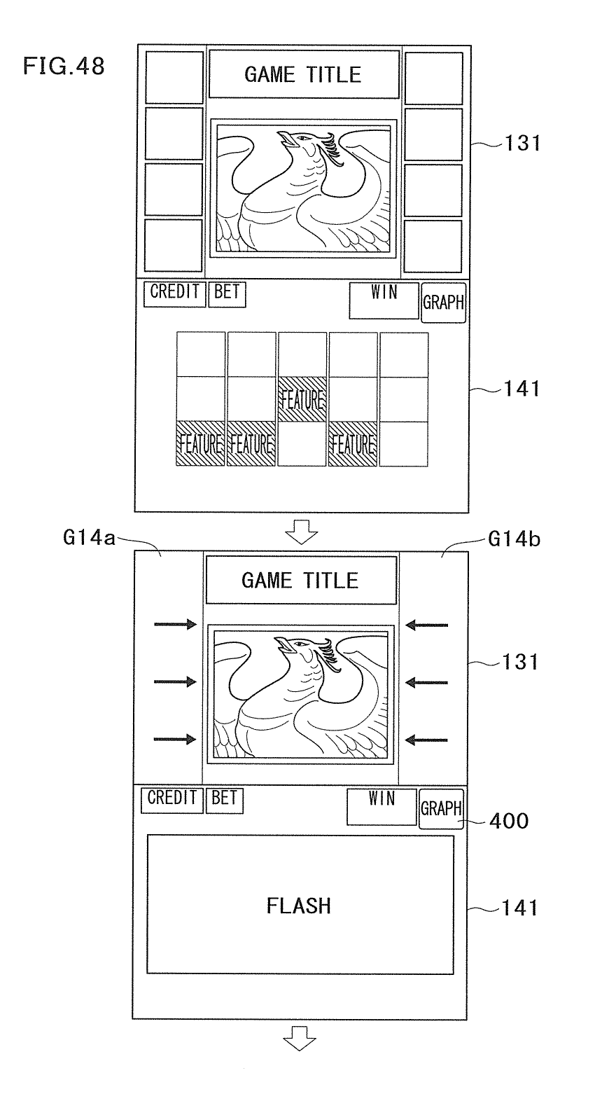

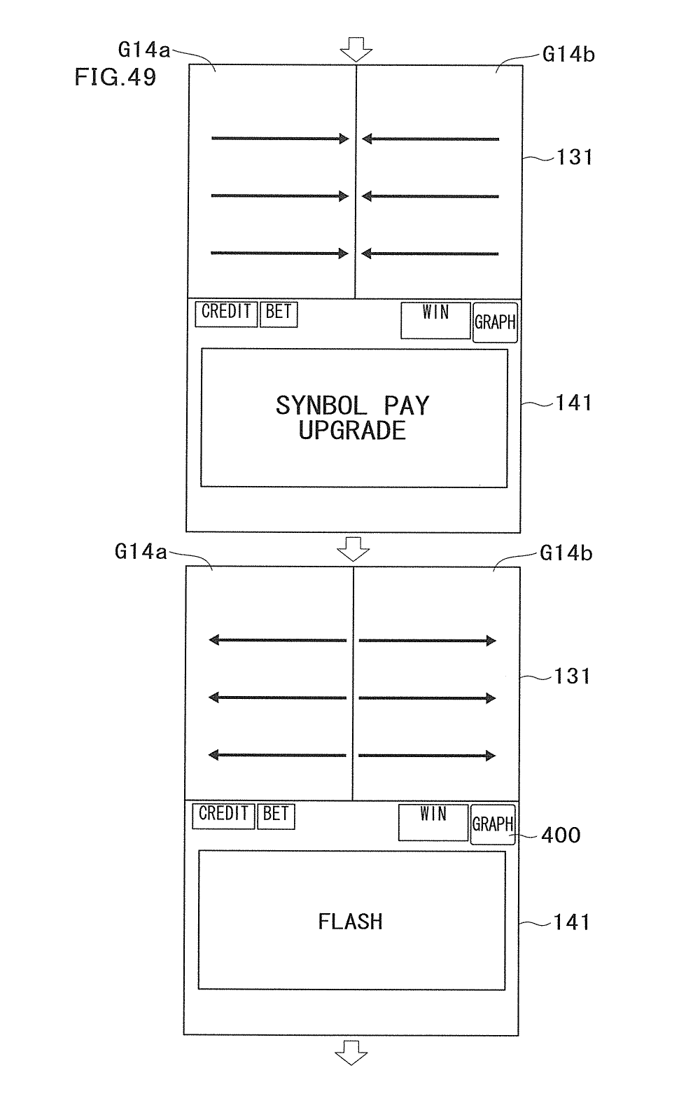

When shifting to the free game process occurs, as shown in FIG. 48, on the upper image display panel 131, the door display portions G14a and G14b enlarge the display areas inward, so that the graphic images displayed on the upper image display panel 131 are hidden as the doors are closed. Then, as shown in FIG. 49, when the door display portions G14a and G14b simulate the closing doors, an effect sound of doors closing is output. At this stage, a message “SYMBOL PAY UPGRADE” is displayed on the lower image display panel 141 as shown in FIG. 49.

Subsequently, the main CPU 71 executes a free game payout rate random determination table determination process (S102). In this free game payout rate random determination table determination process, when the free game trigger is established in S19 or the mystery feature is won in S21, the free game payout rate random determination table by which the payout rate by which the payout awarded in the free game is multiplied is determined is selected based on the type of the WAYS BET selected in S45 and the free game payout rate random determination table determination table.

Then the main CPU 71 execute a payout rate random determination process (S103). To be more specific, random determination is performed based on the free game payout rate random determination table selected in S102, so that the payout rate by which the payout awarded in the free game is multiplied is determined.

For example, in the free game payout rate random determination table determination process (S102), when the WAYS BET3 (27WAYS) and the 5BET are selected in S45 and the normal game is run and the free game trigger is established in S19 or the mystery feature is won in S21, the free game payout rate random determination table associated with the WAYS BET3 (27WAYS) is selected with reference to the free game payout rate random determination table determination table in FIG. 24. In the payout rate random determination process (S103) based on the free game payout rate random determination table associated with the WAYS BET3 (27WAYS), the payout rate by which the payout awarded in the free game is multiplied is determined.

To be more specific, in the payout rate random determination process (S103) based on the free game payout rate random determination table associated with the WAYS BET3 (27WAYS), as shown in FIG. 24, the payout rate is randomly determined based on the random determination probabilities (WEIGHT) as follows: a random determination probability of 45/1000 for the payout rate ×3; a random determination probability of 285/1000 for the payout rate ×5; a random determination probability of 356/1000 for the payout rate ×8, a random determination probability of 234/1000 for the payout rate ×10; a random determination probability of 50/1000 for the payout rate ×15, a random determination probability of 25/1000 for the payout rate ×30, and a random determination probability of 5/1000 for the payout rate ×100.

In the free game payout rate random determination table determination process (S102), when in S22 the value of the game play counter has reached the threshold game play count, the free game payout rate random determination table for determining the payout rate by which the payout awarded in the free game is multiplied, based on the type of the WAYS BET and the free game payout rate random determination table determination table corresponding to the game play counter having reached the threshold game play count.

For example, when the value of the game play counter corresponding to the WAYS BET1 (3WAYS) and the 3BET reaches “450” which is the threshold game play count, the free game payout rate random determination table associated with the WAYS BET1 (3WAYS) is selected with reference to the free game payout rate random determination table determination table shown in FIG. 24. In the payout rate random determination process (S103) based on the free game payout rate random determination table associated with the WAYS BET1 (3WAYS), the payout rate by which the payout awarded in the free game is multiplied is determined.

To be more specific, as shown in FIG. 24 in the payout rate random determination process (S103) based on the free game payout rate random determination table associated with the WAYS BET1 (3WAYS), the payout rate is randomly determined based on the random determination probabilities (WEIGHT) as follows: a random determination probability of 225/1000 for a payout rate ×3, a random determination probability of 301/1000 for a payout rate ×5, a random determination probability of 349/1000 for a payout rate ×8, a random determination probability of 110/1000 for a payout rate ×10, a random determination probability of 5/1000 for a payout rate ×15, a random determination probability of 5/1000 for a payout rate ×30, and a random determination probability of 5/1000 for a payout rate ×100.

After S103, the main CPU 71 executes a payout rate display process (S104). As detailed later, in this payout rate display process, a value calculated by multiplying the payout amount (see FIG. 22) in the symbol combination table referred to in the free game by the payout rate determined in S103 is displayed as a free game payout.

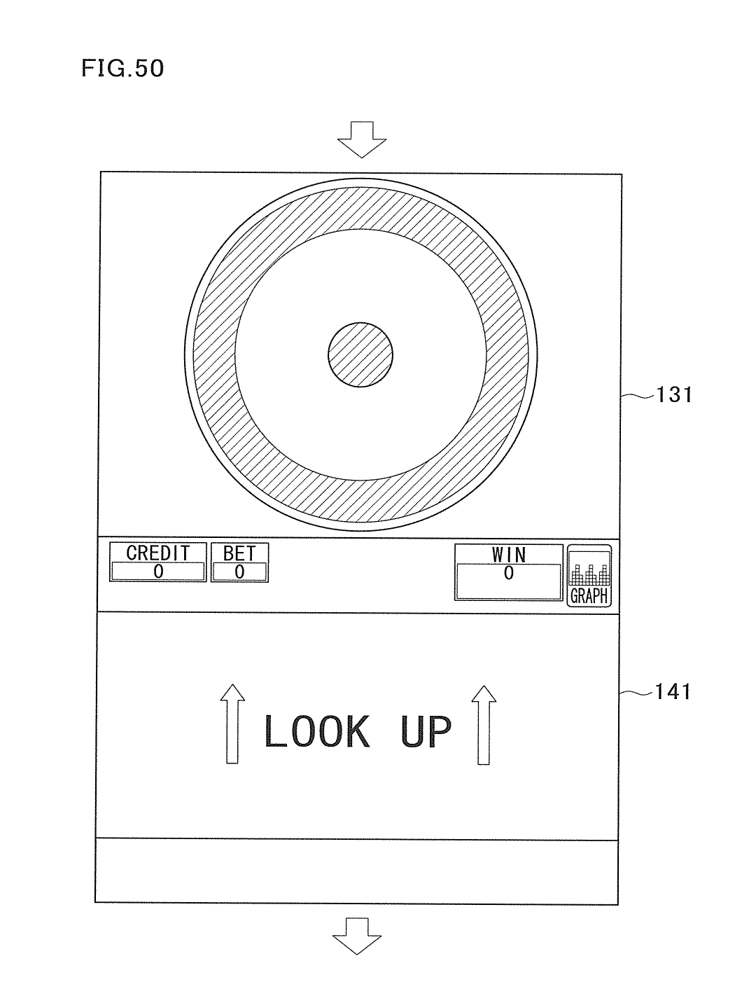

To be more specific, to begin with, as shown in FIG. 49, an image effect of opening the door display portions G14a and G14b left and right is performed. Thereafter, when the door display portions G14a and G14b are opened, a message “LOOK UP” is displayed on the lower image display panel 141 as shown in FIG. 50.

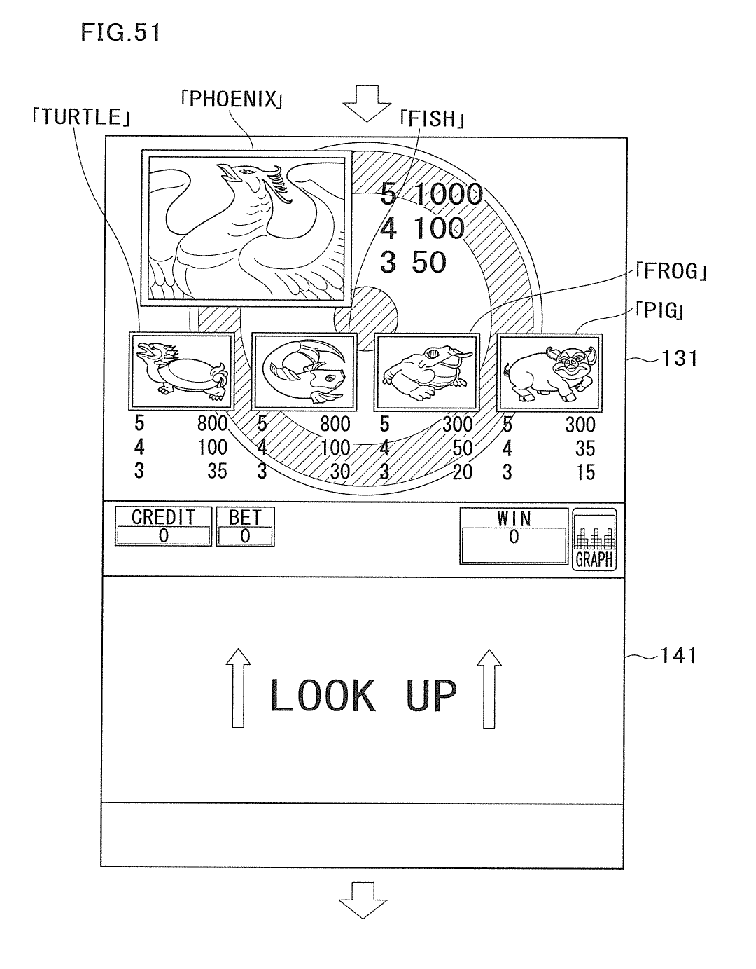

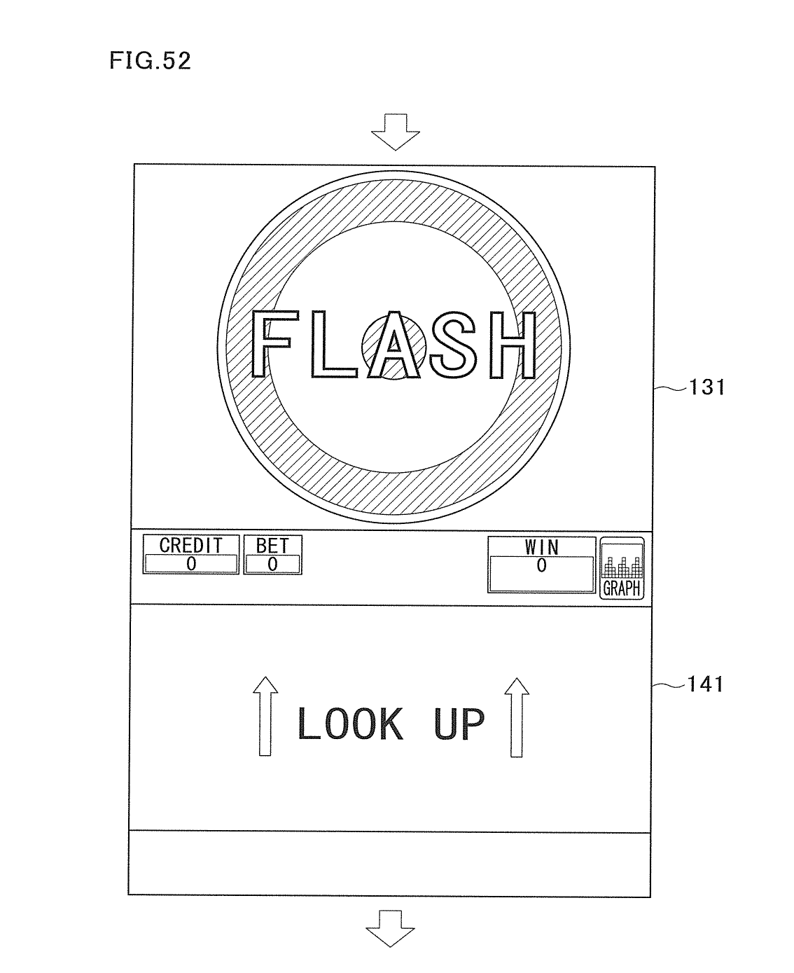

Thereafter, as shown in FIG. 51, a payout amount indicated in the symbol combination table shown in FIG. 22 is displayed on the upper image display panel 131 as a payout amount (payout) to be awarded when 3Kind, 4Kind, or 5Kind of each of the symbols “PHOENIX”, “TURTLE”, “FISH”, “FROG”, and “PIG” is established. When each payout amount (payout) is displayed on the upper image display panel 131, a flashing image effect is executed on the entire screen as shown in FIG. 52.

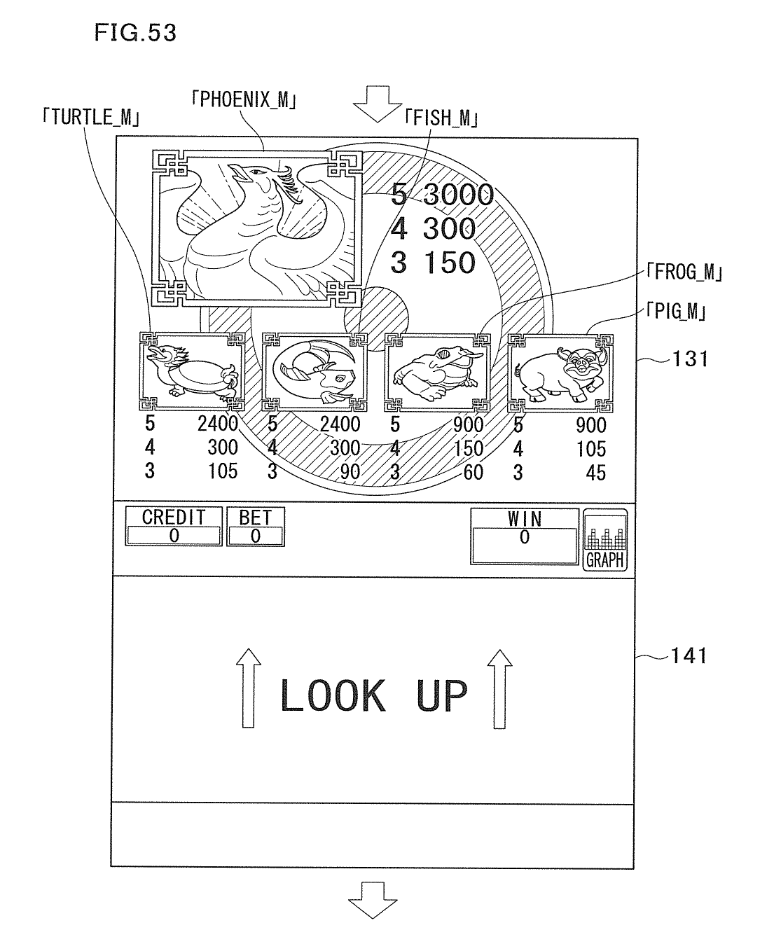

Subsequently, as shown in FIG. 53, a value calculated by multiplying the payout amount indicated by the symbol combination table shown in FIG. 22 by the payout rate ×3 is displayed on the upper image display panel 131, as a payout amount (payout) to be awarded when 3Kind, 4Kind, or 5Kind of each of the symbols “PHOENIX”, “TURTLE”, “FISH”, “FROG”, and “PIG” is established. At this stage, as shown in FIG. 53, an image effect of changing the symbol graphical image of the normal-class “PHOENIX” to the symbol graphical image of the middle-class “PHOENIX_M” is performed on the upper image display panel 131 to indicate that the payout rate is the payout rate ×3 or higher. Similarly, an image effect of changing the symbol graphical images of normal-class “TURTLE”, “FISH”, “FROG”, and “PIG” to the symbol graphical images of the middle-class “TURTLE_M”, “FISH_M”, “FROG_M”, and “PIG_M” is performed.

Furthermore, a display effect is performed such that the previous payout amount displayed on the upper image display panel 131 is incremented step by step in units of 1. For example, when the previous payout amount “1000” is incremented in units of 1 to “3000”, the display effect is performed in such a way that “1001”-->“1002”-->“1003”--> . . . -->“2999”-->“3000”. (In reality, the incrimination is rapidly done). When each payout amount (payout) is displayed on the upper image display panel 131, a flashing image effect is performed on the entire screen as shown in FIG. 52.

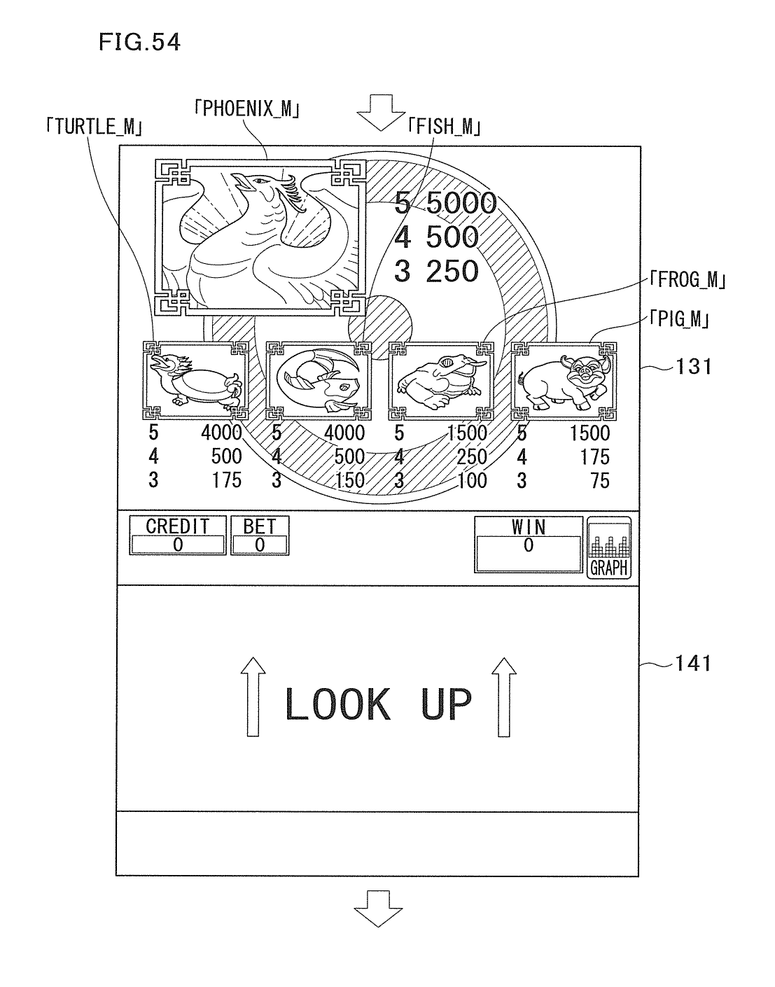

Subsequently, as shown in FIG. 54, a value calculated by multiplying the payout amount indicated in the symbol combination table shown in FIG. 22 by the payout rate ×5 is displayed on the upper image display panel 131, as a payout amount (payout) to be awarded when 3Kind, 4Kind, or 5Kind of each of the “PHOENIX”, “TURTLE”, “FISH”, “FROG”, and “PIG” is established.

Furthermore, a display effect is performed such that the previous payout amount displayed on the upper image display panel 131 is incremented step by step in units of 1. For example, when the previous payout amount “3000” is incremented in units of 1 to “5000”, the display effect is performed in such a way that “3001”-->“3002”-->“3003”--> . . . -->“4999”-->“5000”. (In reality, the incrimination is rapidly done). When each payout amount (payout) is displayed on the upper image display panel 131, a flashing image effect is performed on the entire screen as shown in FIG. 52.

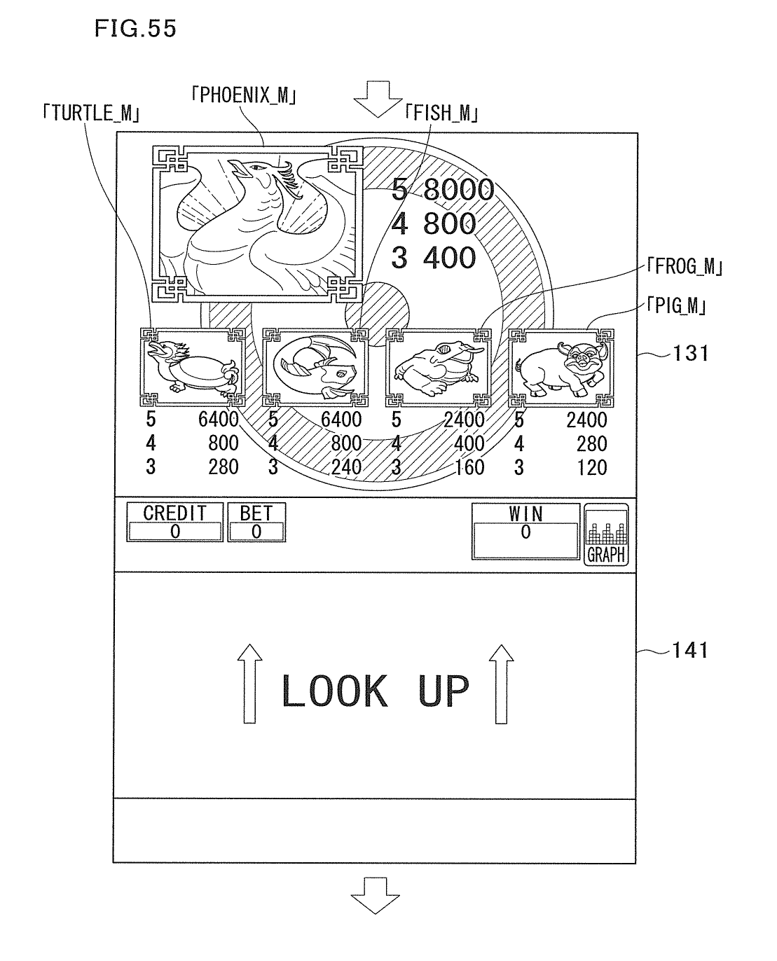

Subsequently, as shown in FIG. 55, a value calculated by multiplying the payout amount indicated in the symbol combination table shown in FIG. 22 by the payout rate ×8 is displayed on the upper image display panel 131, as a payout amount (payout) to be awarded when 3Kind, 4Kind, or 5Kind of each of the “PHOENIX”, “TURTLE”, “FISH”, “FROG”, and “PIG” is established. Furthermore, a display effect is performed such that the previous payout amount displayed on the upper image display panel 131 is incremented step by step in units of 1. For example, when the previous payout amount “5000” is incremented in units of 1 to “8000”, the display effect is performed in such a way that “5001”-->“5002”-->“5003”--> . . . -->“7999”-->“8000”. (In reality, the incrimination is rapidly done). When each payout amount (payout) is displayed on the upper image display panel 131, a flashing image effect is performed on the entire screen as shown in FIG. 52.

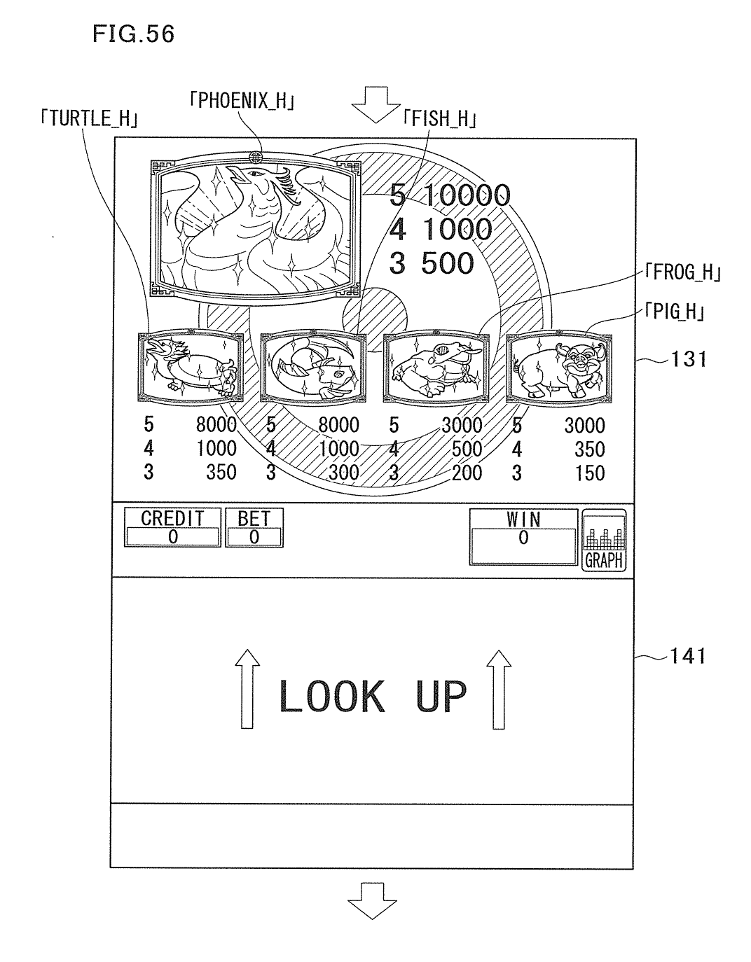

Subsequently, as shown in FIG. 56, a value calculated by multiplying the payout amount indicated in the symbol combination table shown in FIG. 22 by the payout rate ×10 is displayed on the upper image display panel 131, as a payout amount (payout) to be awarded when 3Kind, 4Kind, or 5Kind of each of the “PHOENIX”, “TURTLE”, “FISH”, “FROG”, and “PIG” is established. At this stage, as shown in FIG. 56, an image effect of changing the symbol graphical image of the middle-class “PHOENIX_M” to the symbol graphical image of the high-class “PHOENIX_H” is performed on the upper image display panel 131 to indicate that the payout rate is the payout rate ×10 or higher. Similarly, an image effect of changing the symbol graphical images of the middle-class “TURTLE_M”, “FISH_M”, “FROG_M”, and “PIG_M” to the symbol graphical images of the high-class “TURTLE_H”, “FISH_H”, “FROG_H”, and “PIG_H” is performed.

Furthermore, a display effect is performed such that the previous payout amount displayed on the upper image display panel 131 is incremented step by step in units of 1. For example, when the previous payout amount “8000” is incremented in units of 1 to “10000”, the display effect is performed in such a way that “8001”-->“8002”-->“8003”--> . . . -->“9999”-->“10000”. (In reality, the incrimination is rapidly done). When each payout amount (payout) is displayed on the upper image display panel 131, a flashing image effect is performed on the entire screen as shown in FIG. 52.

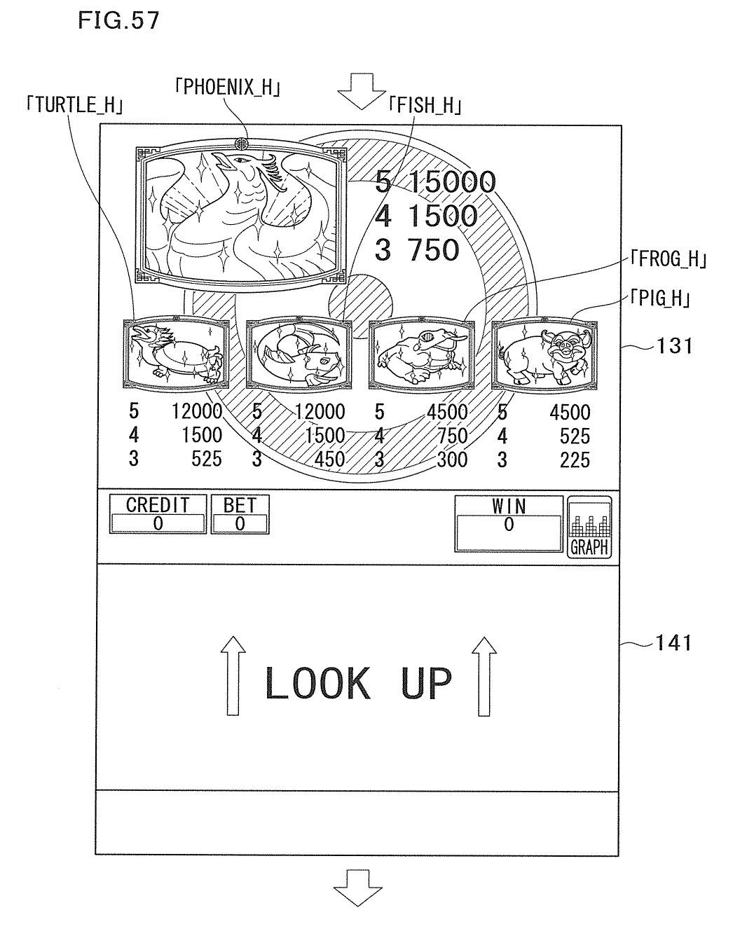

Subsequently, as shown in FIG. 57, a value calculated by multiplying the payout amount indicated in the symbol combination table shown in FIG. 22 by the payout rate ×15 is displayed on the upper image display panel 131, as a payout amount (payout) to be awarded when 3Kind, 4Kind, or 5Kind of each of the “PHOENIX”, “TURTLE”, “FISH”, “FROG”, and “PIG” is established.

Furthermore, a display effect is performed such that the previous payout amount displayed on the upper image display panel 131 is incremented step by step in units of 1. For example, when the previous payout amount “10000” is incremented in units of 1 to “15000”, the display effect is performed in such a way that “10001”-->“10002”-->“10003”--> . . . -->“14999”-->“15000”. (In reality, the incrimination is rapidly done). When each payout amount (payout) is displayed on the upper image display panel 131, a flashing image effect is performed on the entire screen as shown in FIG. 52.

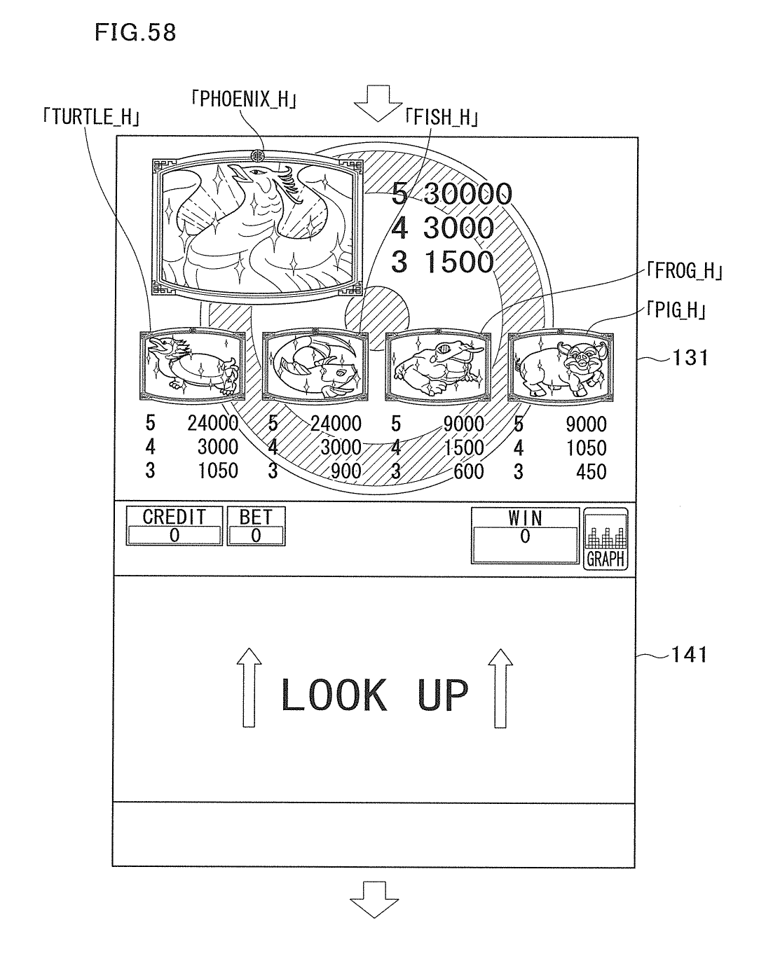

Subsequently, as shown in FIG. 58, a value calculated by multiplying the payout amount indicated in the symbol combination table shown in FIG. 22 by the payout rate ×30 is displayed on the upper image display panel 131, as a payout amount (payout) to be awarded when 3Kind, 4Kind, or 5Kind of each of the “PHOENIX”, “TURTLE”, “FISH”, “FROG”, and “PIG” is established. Furthermore, a display effect is performed such that the previous payout amount displayed on the upper image display panel 131 is incremented step by step in units of 1. For example, when the previous payout amount “15000” is incremented in units of 1 to “30000”, the display effect is performed in such a way that “15001”-->“15002”-->“15003”--> . . . -->“29999”-->“30000”. (In reality, the incrimination is rapidly done). When each payout amount (payout) is displayed on the upper image display panel 131, a flashing image effect is performed on the entire screen as shown in FIG. 52.

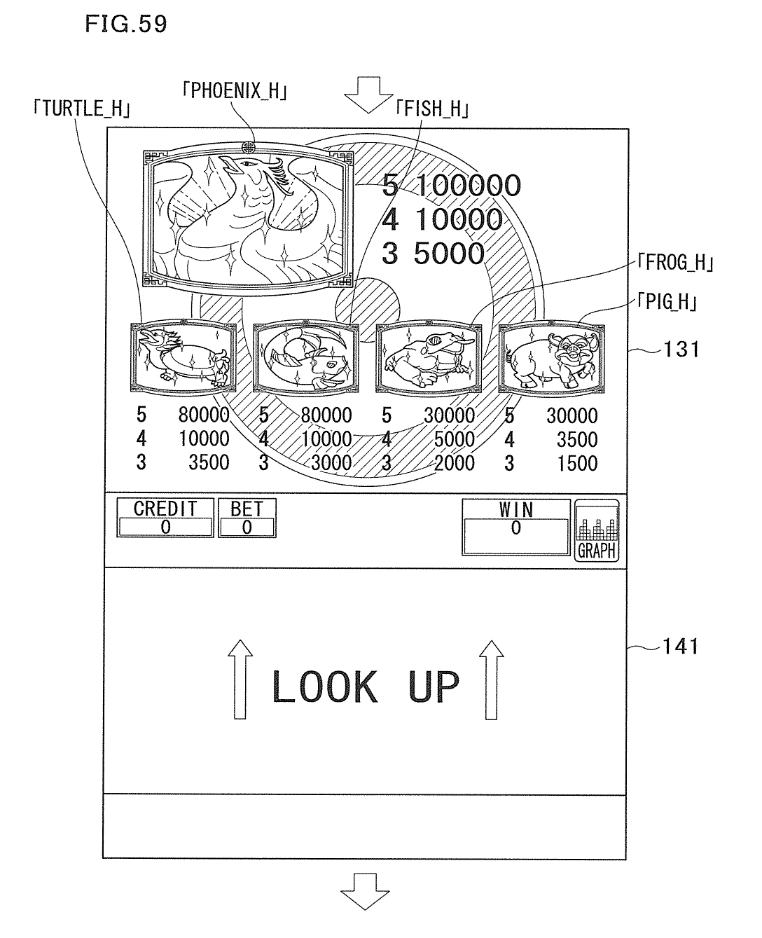

Subsequently, as shown in FIG. 59, a value calculated by multiplying the payout amount indicated in the symbol combination table shown in FIG. 22 by the payout rate ×100 is displayed on the upper image display panel 131, as a payout amount (payout) to be awarded when 3Kind, 4Kind, or 5Kind of each of the “PHOENIX”, “TURTLE”, “FISH”, “FROG”, and “PIG” is established.

Furthermore, a display effect is performed such that the previous payout amount displayed on the upper image display panel 131 is incremented step by step in units of 1. For example, when the previous payout amount “30000” is incremented in units of 1 to “100000”, the display effect is performed in such a way that “30001”-->“30002”-->“30003”--> . . . -->“99999”-->“100000”. (In reality, the incrimination is rapidly done). When each payout amount (payout) is displayed on the upper image display panel 131, a flashing image effect is performed on the entire screen as shown in FIG. 52.

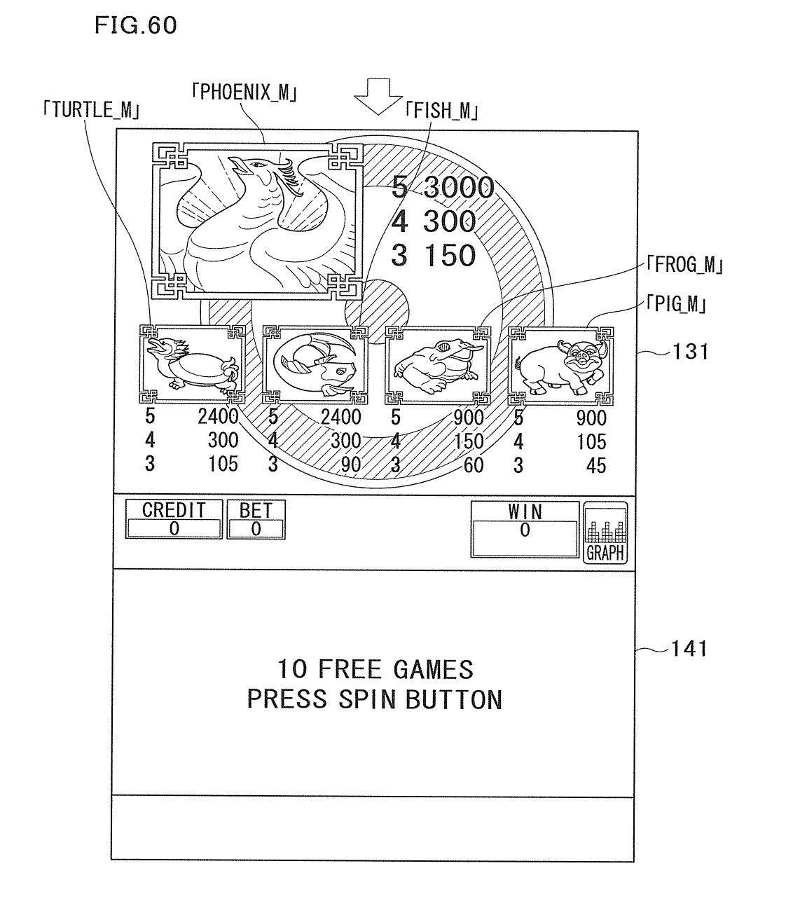

Furthermore, as shown in FIG. 60, a value calculated by multiplying the payout amount indicated by the symbol combination table shown in FIG. 22 by the payout rate determined in S103 (the payout rate ×3 in FIG. 60) is displayed on the upper image display panel 131, as a payout amount (free game payout) to be awarded when 3Kind, 4Kind, or 5Kind of each of the symbols “PHOENIX”, “TURTLE”, “FISH”, “FROG”, and “PIG” is established.

When each payout amount (free game payout) is displayed on the upper image display panel 131, a flashing image effect is performed on the entire screen as shown in FIG. 52. Furthermore, as shown in FIG. 60, messages “10 FREE GAME” and “PRESS SPIN BUTTON” are displayed on the lower image display panel 141.

With the display state above, on the upper image display panel 131, a process that a free game payout multiplied by a low payout rate is changed to a free game payout multiplied by the payout rate determined in S103 via a free game payout multiplied by a high payout rate is displayed step by step. In this way, an effect that the free game payout (including the payout rate) progresses is performed. This increases the expectation on the free game payout awarded in the free game.

With the display state above, furthermore, a symbol graphical image is changed step by step from a normal-class symbol graphical image corresponding to a low payout rate to a middle-class symbol graphical image and a high-class symbol graphical image. As such, an effect that the symbol graphical image corresponding to the payout rate progresses is performed. This increases the expectation on the free game payout awarded in the free game.

After the step S104, the main CPU 71 determines whether or not an operation of the spin button 49 is detected (step S105). When the main CPU 71 determines that an operation of the spin button 49 is not detected (S105:NO), the operation of the spin button 49 is waited for.

In the meanwhile, when the operation of the spin button 49 is detected (S105: YES), the main CPU 71 executes a at-one-game-end initialization process in the same manner as in the step S12 (S106). Next, the main CPU 71 executes a symbol random determination process (S107) in the same manner as the step S14.

The main CPU 71 then executes the effect contents determination process (S108) in the same manner as the step S15. Next, the main CPU 71 executes the symbol display control process (S109) in the same manner as the step S16. The main CPU 71 then executes the payout amount determination process (S110) in the same manner as in the step S17.

Subsequently, the main CPU 71 executes a payout process (step S111). In this payout process, the main CPU 71 adds the value awarded in the payout amount determination process of the step S110 to the value stored in a free game payout counter. The free game payout counter is an area where the total payout amount determined during the free game is stored. When the free game process ends, the main CPU 71 adds the value stored in the free game payout counter to a credit counter provided in the RAM 73. In other words, the total payout amount determined in the free game is awarded at once. The payout may be awarded by ejecting coins from the coin payout exit 15A or by issuing a ticket with a barcode.

In regard to the type of the WAYS BET and the credit type in the free game, when the free game trigger is established or the mystery feature is won, the WAYS BET and the credit type in the normal game in which the right to execute the free game is awarded are maintained (i.e., the type of the WAYS BET and the credit type received in S45 are maintained). In the meanwhile, if the value of the game play counter has reached the threshold game play count in S22, the type of the WAYS BET and the credit type corresponding to the game play counter having reached the threshold game play count are employed as the type of the WAYS BET and the credit type in the free game. Therefore, in S107 (symbol random determination process) above in the free game of the present embodiment, a symbol array corresponding to the WAYS BET selected above is used (see FIG. 13 to FIG. 17).

For example, when, in S22, the value of the game play counter corresponding to the WAYS BET1 (3WAYS) and the 3BET reaches “450” which is the threshold game play count, a payout of 300×3=900 is added to the value stored in the free game payout counter, provided that the payout rate determined in S103 is ×3 (see FIG. 60) and 4Kind of the ““PHOENIX”_M” is established in the free game.

Furthermore, for example, when the WAYS BET3 (27WAYS) and the 5BET are selected in S45 and the normal game is executed and the free game trigger is established in S19 or the mystery feature is won in S21, a payout of 300×5=1500 is added to the value stored in the free game payout counter, provided that the payout rate determined in S103 is ×3 (see FIG. 60) and 4Kind of the ““PHOENIX”_M” is established in the free game.

Next, the main CPU 71 determines whether or not a re-trigger occurred (S112). In the present embodiment, the re-trigger occurs when the symbol of “FEATURE” occurs in three or more consecutive positions through the first array area to the fifth array area, irrespective of the result determination area activated by the WAYS BET. When it is determined that the re-trigger occurred (S112: Yes), the main CPU 71 adds 1 to the free game play counter in the RAM 73 and updates the value of the same (S113).

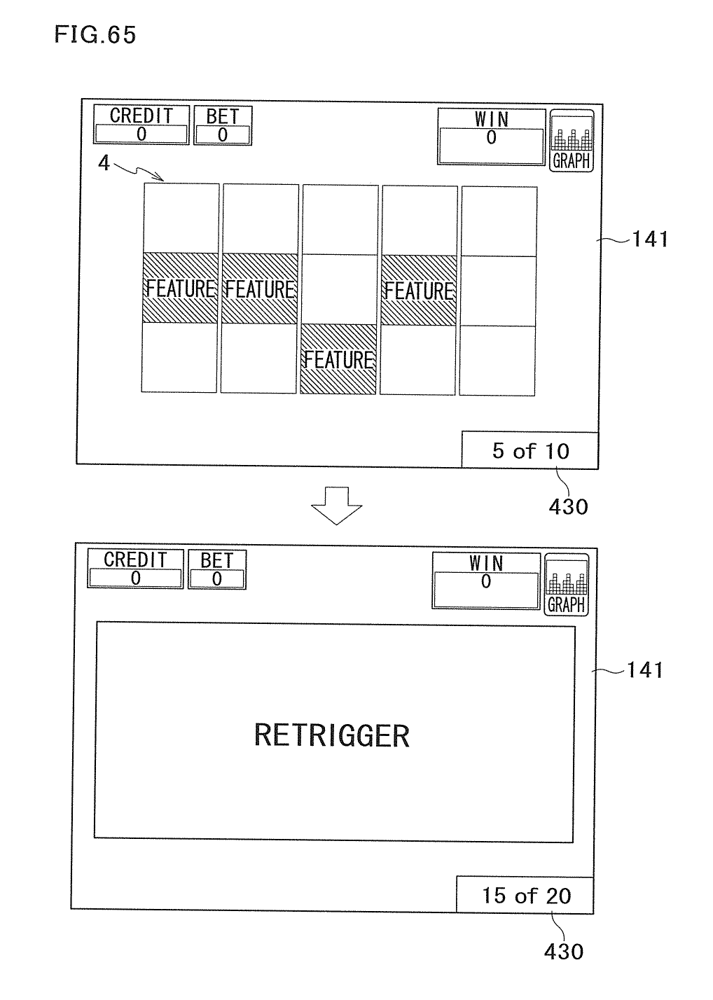

In the present embodiment, as shown in FIG. 65, when the “FEATURE” symbol occurs in three or more consecutive positions through the first array area to the fifth array area in the free game, irrespective of the area activated by a WAYS BET button, a message reading “RETRIGGER” is displayed on the lower image display panel 141. Then, a value of 10 as the additional number of play of the free game at the time of the re-trigger is added to the value on the free game play counter 430 displayed at a lower right position of the lower image display panel 141. For example, as shown in FIG. 65, when the re-trigger occurs during the free game and when the value on the free game play counter 430 is 5, a value of 10 is added and 15 is displayed.

When the main CPU 71 determines that the re-trigger is not established (S112: NO) or after S113, the main CPU 71 subtracts 1 from the value of the free game play counter (S114).

The main CPU 71 then determines whether the value on the free game play counter is 0 (S115). When determining that the value on the free game play counter is not 0 (S115: NO), the main CPU 71 proceeds to the step S105.

In the meanwhile, when the value on the free game play counter is 0 (S115: YES), the free game process is terminated.

According to the arrangement above, in accordance with the start of the normal game, the value of the game play counter corresponding to the selected type of the WAYS BET and the selected credit type is incremented, and the right to execute the free game for a predetermined number of times is awarded when the value of the game play counter reaches the threshold game play count. As such, because a game play counter for counting the number of game play is independently set for each of the credit types corresponding to the types of the WAYS BET, the credit types based on which the player places a bet and the types of the WAYS BET selectable by the player are diversified.

In addition to the above, in the free game a payout is awarded based on a result of the free game and the type of the WAYS BET and the credit type corresponding to the game play counter having reached the threshold game play count. On this account, because the credit type with which a bet is placed in the normal game and the selected WAYS BET are taken into consideration in the free game payout, the player is encouraged to select a credit type with which a bet is placed in the normal game and a type of the WAYS BET, in consideration of the payout in the free game.

Furthermore, in the arrangement above, when the free game trigger is established or when the mystery feature is won as a result of the normal game, the right to execute the free game 10 times is awarded. On this account, the free game awarded when the free game trigger is established or the mystery feature is won as a result of the normal game is arranged to be identical with the free game awarded when the value of the game play counter reaches the threshold game play count. This simplifies the game design and the operation of the slot machine 1. Furthermore, because the free game is shared, it is possible for the player to understand the rules of the free game soon.

In the structure, when the game play count in the game play counter reaches the threshold game play count, the right to execute the free game is awarded and only the value of the game play counter having reached the threshold game play count is reset. Values of the game play counters having not yet reached their threshold game play counts are maintained. This induces the player to select the WAYS BET and the bet type corresponding to the game play counter which has not yet reached the threshold game play count.

[Screen Display Specification]

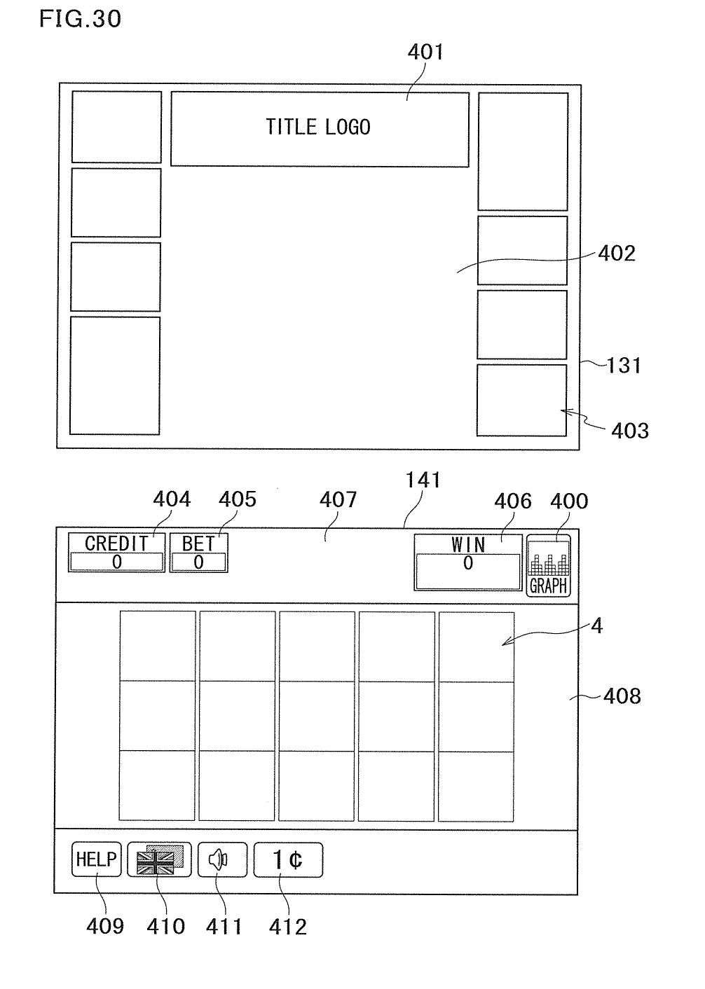

Now, the screen display specification of the slot machine 1 will be described with reference to FIGS. 30 to 36.

<Screen Display Specification in Normal Game>

To begin with, screen display specification in the normal game will be described with reference to FIG. 30. FIG. 30 shows the screen display specification in the normal game in the slot machine of the embodiment of the present invention.

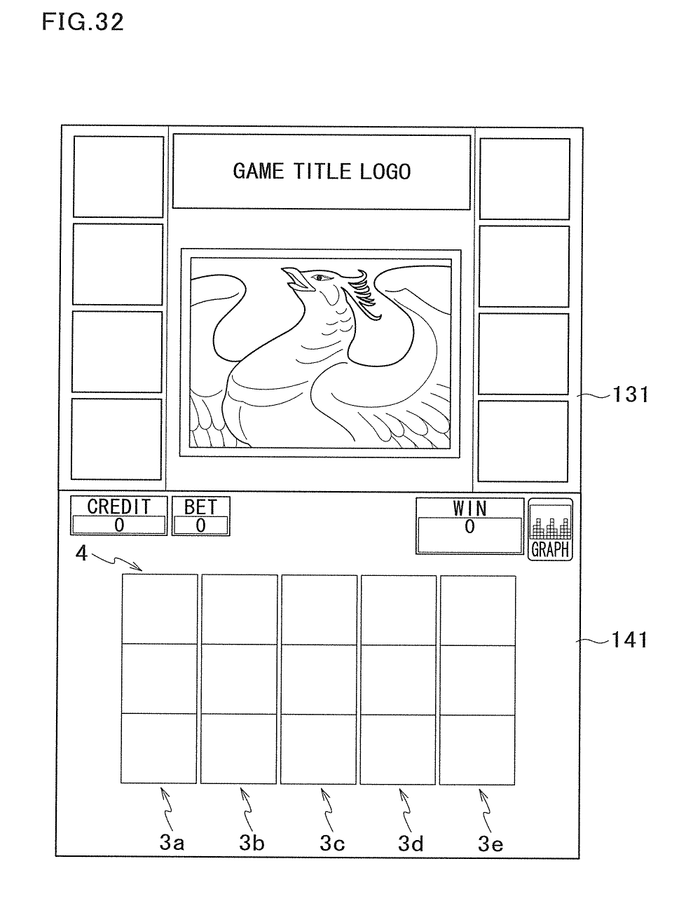

As shown in FIG. 30, the upper image display panel 131 in the normal game is provided with a title logo area 401, an image area 402, and an information area 403. In the title logo area 401 is displayed a game title logo. During the free game, the display is switched to displaying of the free game name. When the display language is switched to English or Chinese, the title is displayed in that language. In the image area 402 is displayed a main image of the game. In the information area 403 are displayed a simple explanation of game rules and payout amount and the like in relation to the symbols. In the present embodiment, as shown in FIG. 32, a character “PHOENIX” is displayed in the image area 402 as a main image.

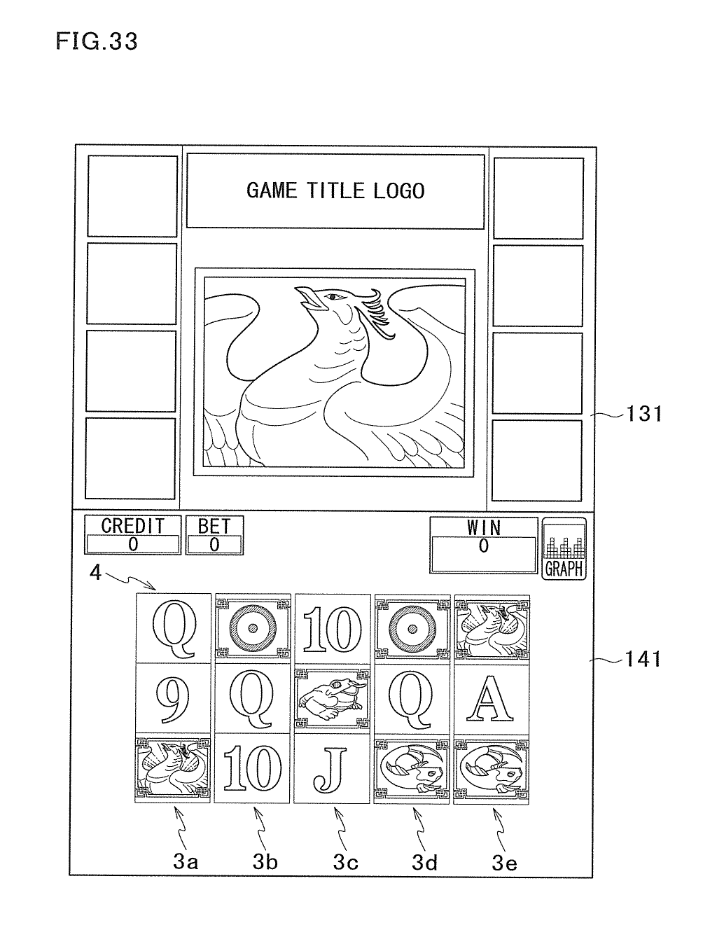

On the lower image display panel 141 in the normal game, in addition to the above-described symbol display area 4, a credit meter 404, a bet meter 405, a win meter 406, a display area 407 for WAYS BET information, bet information and the game state, a graph-switch button 400, a help touch button 409, a language switching touch button 410, a sound volume switching touch button 411, and a denomination indicator 412. In the credit meter 404 is displayed a remaining credit amount. The default value is 0. In other words, a credit amount stored in the RAM 73 is displayed. The bet meter 405 displays the total bet amount of the current game (or the final game). The win meter 406 displays the total credit amount of win and the detail of the win. In the normal game of the present embodiment, as shown in FIGS. 32 and 33, in the symbol display area 4, the symbol array allocated to each video reel 3 (3a, 3b, 3c, 3d, and 3e) scrolls and stops after elapse of a predetermined time. As a result, parts of the respective symbol arrays (three successive symbols in the embodiment of the present invention) are displayed for the player.

The display area 407 for the WAYS BET information, bet information and the game state displays the WAYS BET information and the bet information of the currently played game (or the final play of the game). Specifically, the area displays which type of the 5 staged WAYS BET (i.e., WAYS BET1, WAYS BET2, WAYS BET3, WAYS BET4, and WAYS BET5) is currently selected. Further, the display area 407 displays the state of the currently played game. The area is hidden while the current play of the game is played. When the current game state is game over, “GAME OVER” is displayed. When the current game state is waiting for gamble, “PLAY ON, GAMBLE or TAKE WIN” is displayed.

The graph-switch button 400 sequentially changes the display every time it is touched by the player, in the order of a normal screen (title logo screen)-->a line-graph G1,-->a bar-graph G2,-->a block-graph G3,-->and back to the normal screen (title logo screen).

When the player touches the help touch button 409, the first page of the help screen is displayed on the lower image display panel 141. The help touch button 409 is darkened when it is inactive, e.g., during the rotation of the video reels 3.

As the language switching touch button 410 is touched by the player, the language is switched to English or Chinese. The language switching touch button 410 is activated only during the advertisement, and is darkened when it is inactive, e.g., during the rotation of the video reels 3. Furthermore, on the language switching touch button 410, the displayed national flags are changed to “U.K./Chine” or “U.S.A./China” in accordance with the setting of the AUDIT. When the language switching is set at “DISABLE”, the language switching touch button 410 is changed to a paytable button with which a payout table is displayed on the help screen.

The sound volume switching touch button 411 is used for switching the game sound volume in three stages. Each time the sound volume switching touch button 411 is touched by the player, the game sound volume is switched such that, for example, from low to middle to high to small to middle. The denomination indicator 412 displays current denomination.

<HELP Screen Display Specification>

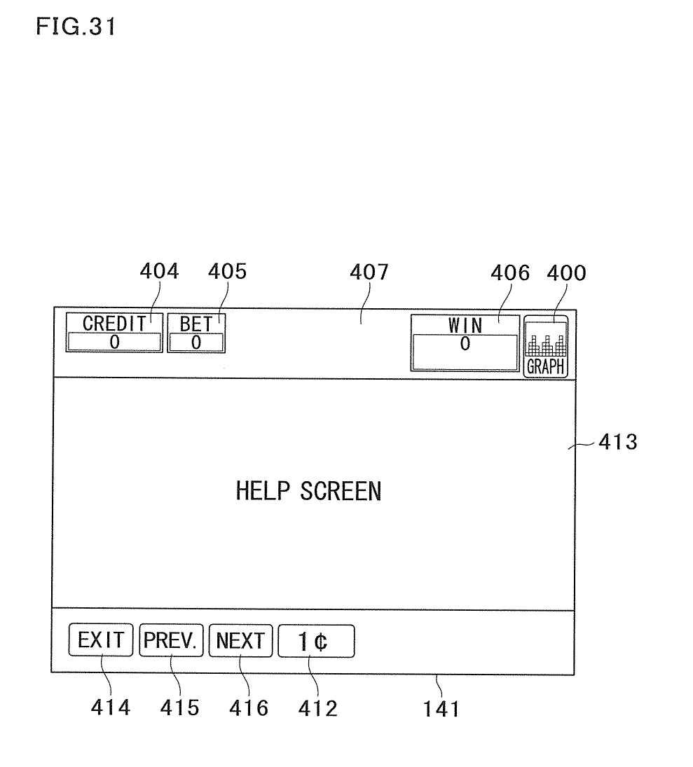

Next, the following describes HELP screen display specification, with reference to FIG. 31.

As the lower image display panel 141 shown in FIG. 31, the HELP screen display specification is such that: the credit meter 404, the bet meter 405, the win meter 406, the display area 407 for the WAYS BET information, bet information, and the game state, and the graph-switch button 400 are displayed. Further, the lower image display panel 141, while ensuring the HELP screen 413, displays an exit touch button 414, a PREV. touch button 415, a NEXT touch button 416, and a denomination indicator 412.

When the player touches the exit touch button 414, the HELP screen 413 disappears from the lower image display panel 141 and a normal game screen (see FIG. 30) comes back. When the player touches the PREV. touch button 415, the directly preceding page is displayed on the HELP screen 413. When the player touches the NEXT touch button 416, the next page is displayed on the HELP screen 413.

<Screen Display Specification in Free Game>

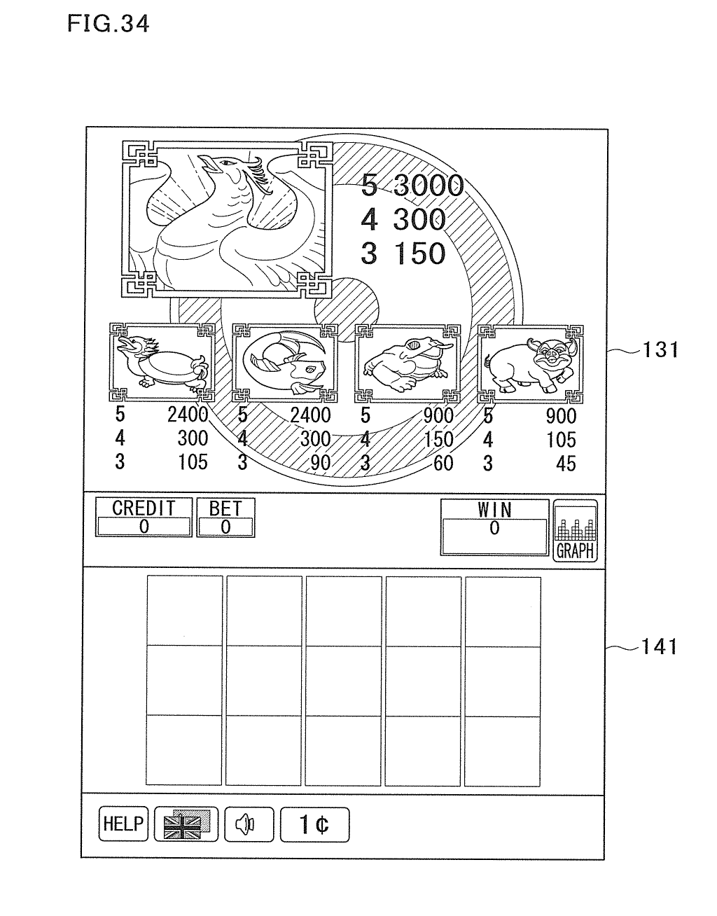

Now, the screen display specification in the free game will be described with reference to FIG. 34. FIG. 34 shows the screen display specification in the free game in the slot machine of the embodiment of the present invention.

As shown in FIG. 34, the upper image display panel 131 in the free game displays a value calculated by multiplying the payout amount indicated in the symbol combination table shown in FIG. 22 by the payout rate determined in S103, as a payout amount (free game payout) to be paid out when 3Kind, 4Kind, or 5Kind of each of the symbols “PHOENIX”, “TURTLE”, “FISH”, “FROG”, and “PIG” is established. Image display on the lower image display panel 141 in the free game is identically with the image display in the normal game.

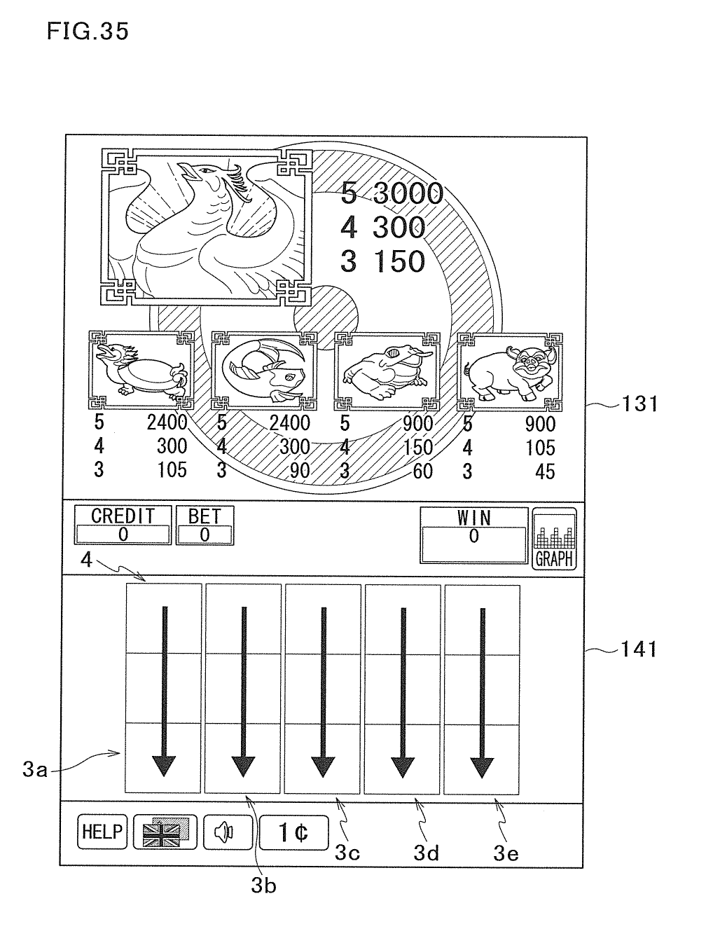

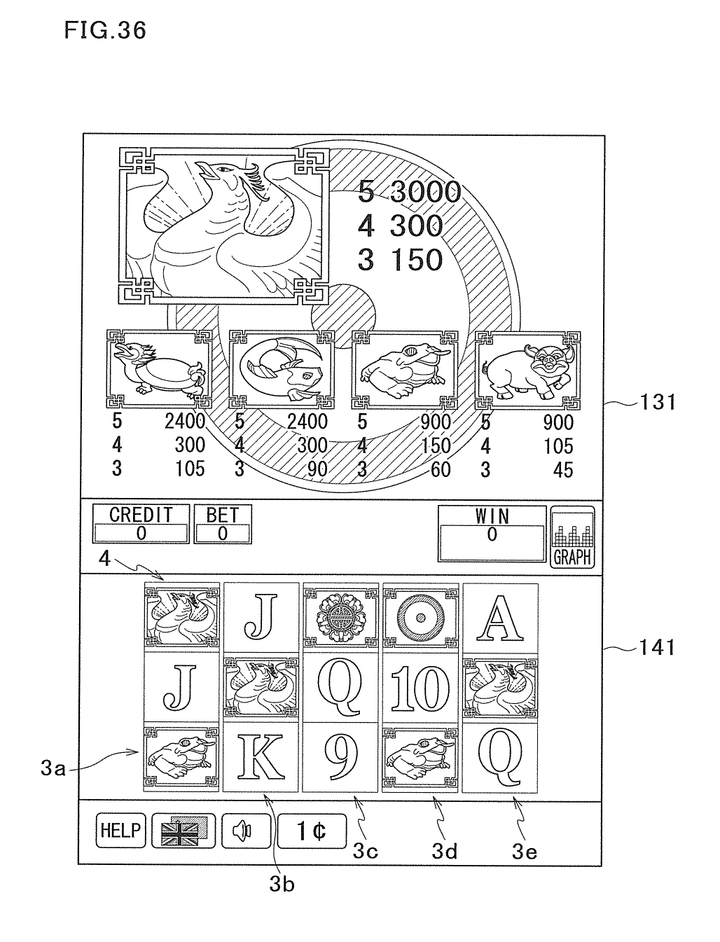

As shown in FIG. 35 and FIG. 36, in the free game of the present embodiment, a symbol array allocated to each of the video reels 3 (3a, 3b, 3c, 3d, and 3e) scrolls in the symbol display area 4, and stops when a predetermined time elapses. As a result, parts of the respective symbol arrays (three successive symbols in the embodiment of the present invention) are displayed for the player.

[Win Effect]

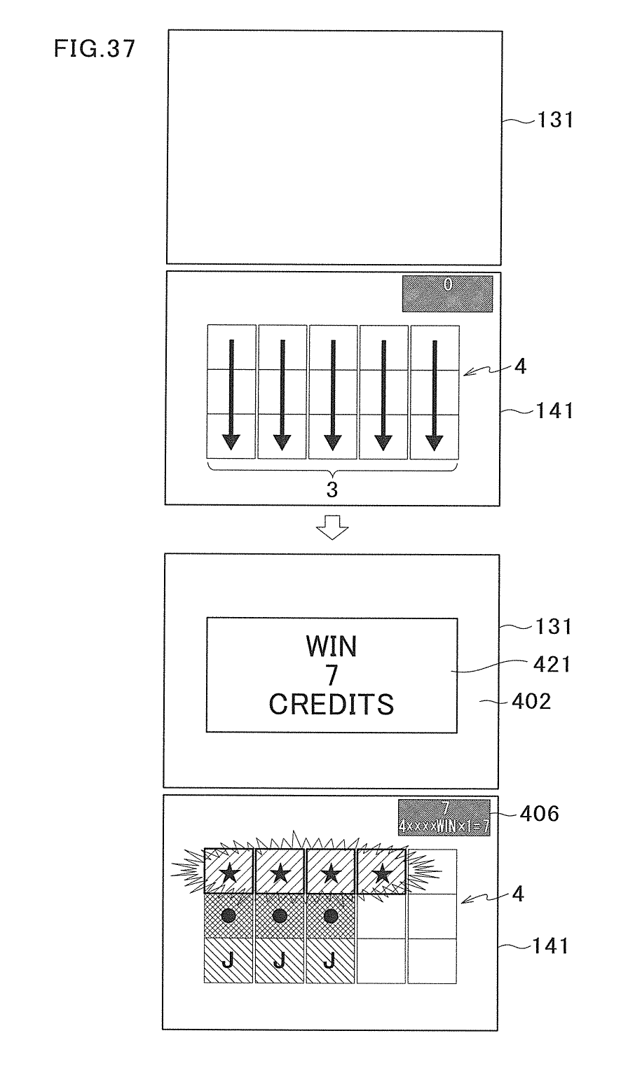

Now, a win effect in the slot machine 1 will be described with reference to FIG. 37 to FIG. 41.

The win effect is an effect executed when a winning is achieved in the normal game or the free game. In other words, the effect is executed when symbols stopped in the result determination area subjected to result determination by operating the WAYS BET button forms a combination of a predetermined number of symbols which are linked within the first array area to the fifth array area in the symbol display area 4, the combination matching with a symbol combination on the symbol combination table (see FIG. 22).

<Flow of Win Effect>

To begin with, as shown in FIG. 37, all video reels 3 in the symbol display area 4 on the lower image display panel 141 stop. When all video reels 3 stop, as shown in FIG. 37, a win signboard 421 is displayed in the image area 402 of the upper image display panel 131. In the win signboard 421, an obtained credit is displayed in an increment manner. The increment display of the obtained credit on the win signboard 421 is linked to the image display on the win meter 406 of the lower image display panel 141.

On the lower image display panel 141, the win effect is performed for the achieved win. The win effect is provided when the feature symbol occurs to three or more consecutive positions through the first array area to the fifth array area, followed by a win effect associated with a winning related to the other symbols are executed. In this regard, for symbols for each of which a win animation is prepared, an animation effect is carried out. The symbols which do not relate to any win are darkened to be less noticeable.

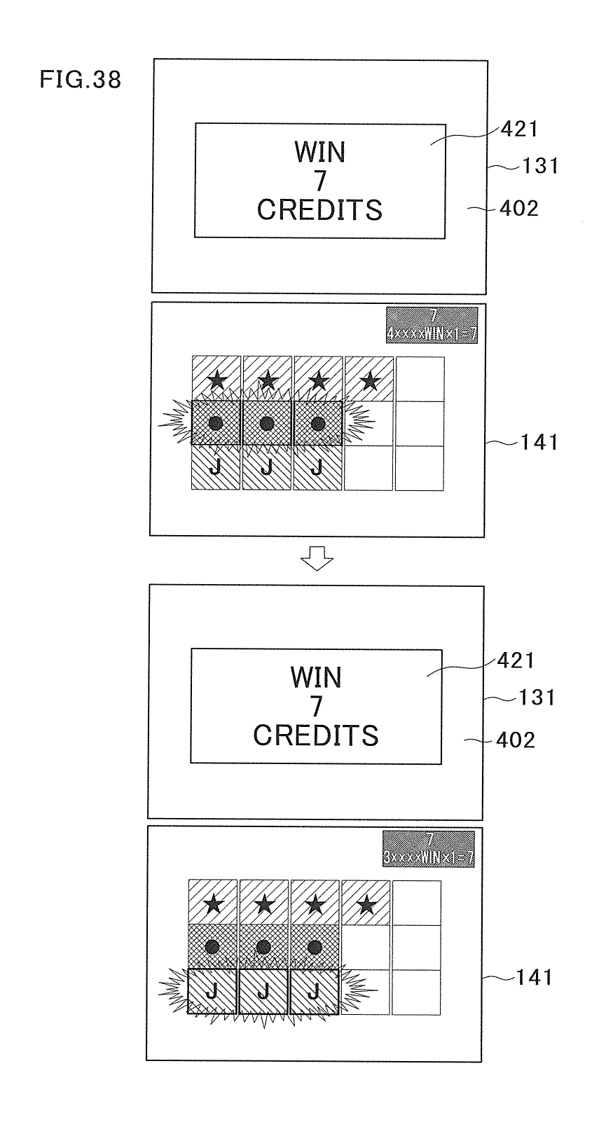

For example, as shown in FIG. 37, a win effect is provided (light is turned on) for star symbols. Subsequently, as shown in FIG. 38, on the win signboard 421 displayed on the image area 402 of the upper image display panel 131, the increment display of the obtained credit is continued. On the lower image display panel 141, the display of the win effect proceeds to next. In this case, the display of the win effect proceeds from the star symbols to the black circle symbols. When win animations are prepared for both the star symbols and black circle symbols, animation effects are performed. In the meanwhile, the “J” symbols are kept in the stop state because the time to display the win effect has not come and no win animation is prepared therefor. In this case, the display of the win effect (turning on of the lights) proceeds from the black circle symbols to the J symbols, as shown in FIG. 38.

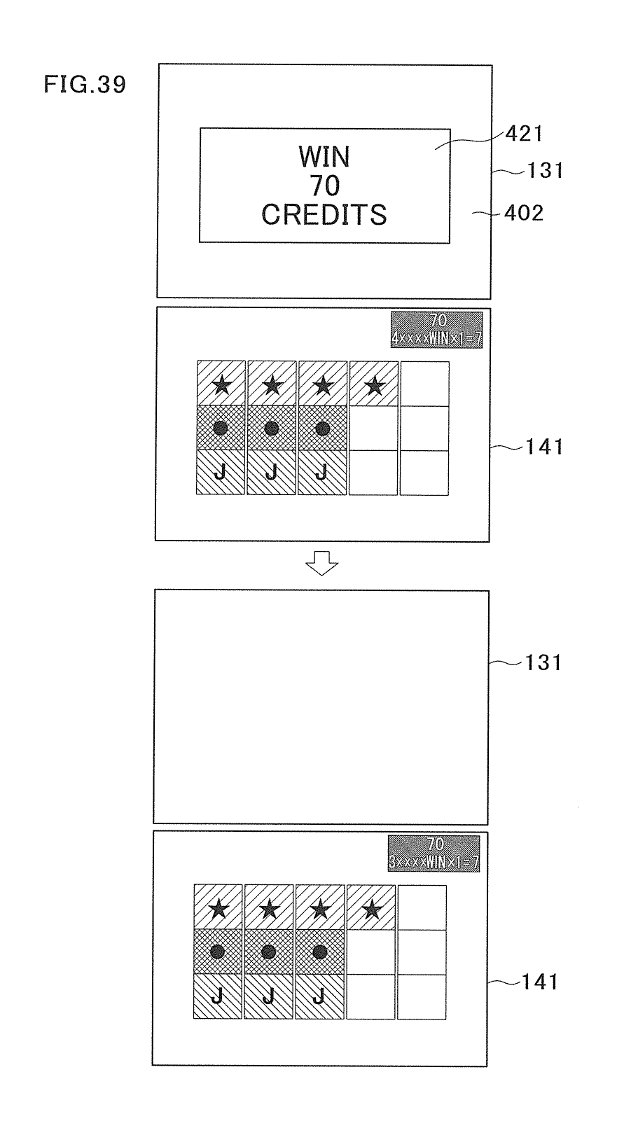

Subsequently, as shown in FIG. 39, the total win is displayed on the win signboard 421 displayed in the image area 402 of the upper image display panel 131. The increment display of the obtained credit is terminated. On the lower image display panel 141, as all of the winning symbols are displayed for once, the win signboard 421 is hidden, and the symbols are displayed in a looped manner in a descending order of the payout, as shown in FIG. 39.

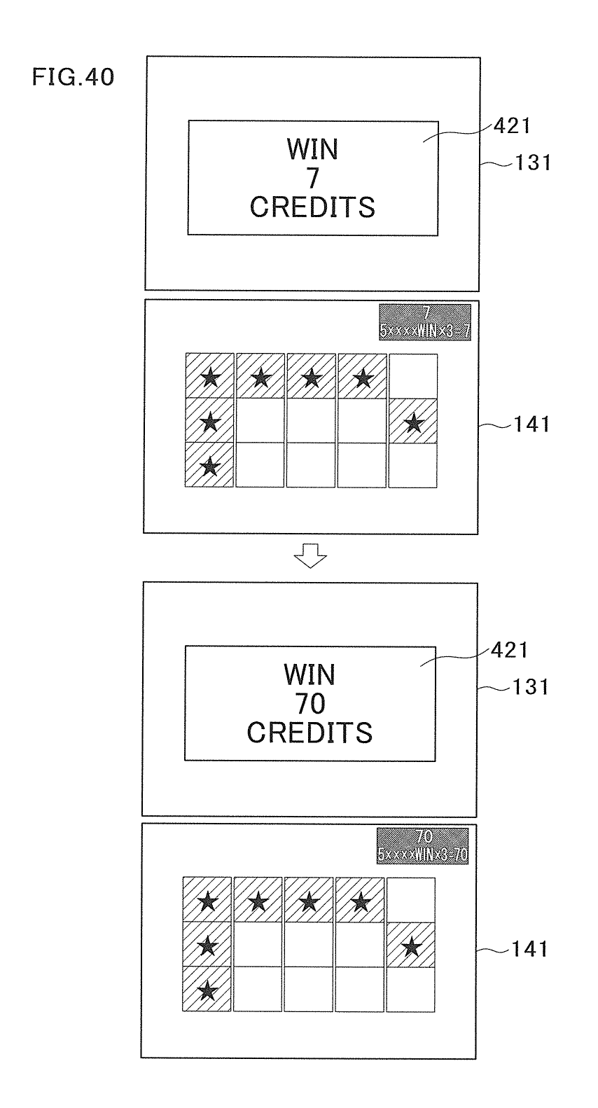

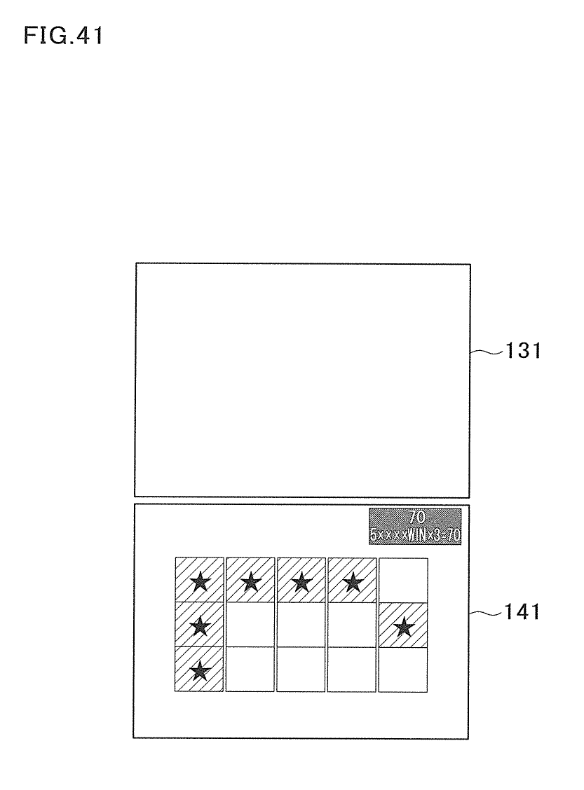

When one kind of symbols successively appear, as shown in FIG. 40 and FIG. 41, animation effect is performed for all of the symbols. The symbols which do not relate to any win are darkened to be less noticeable.

<Win Signboard>

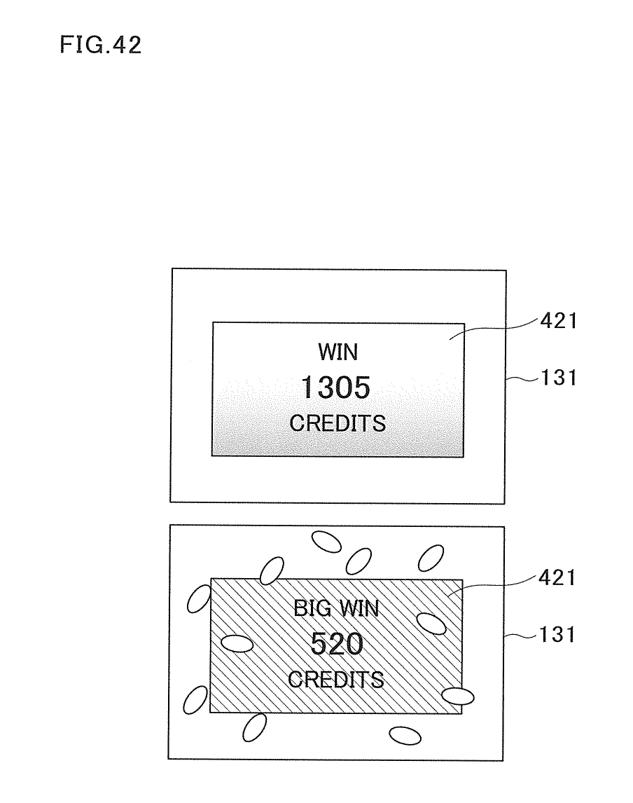

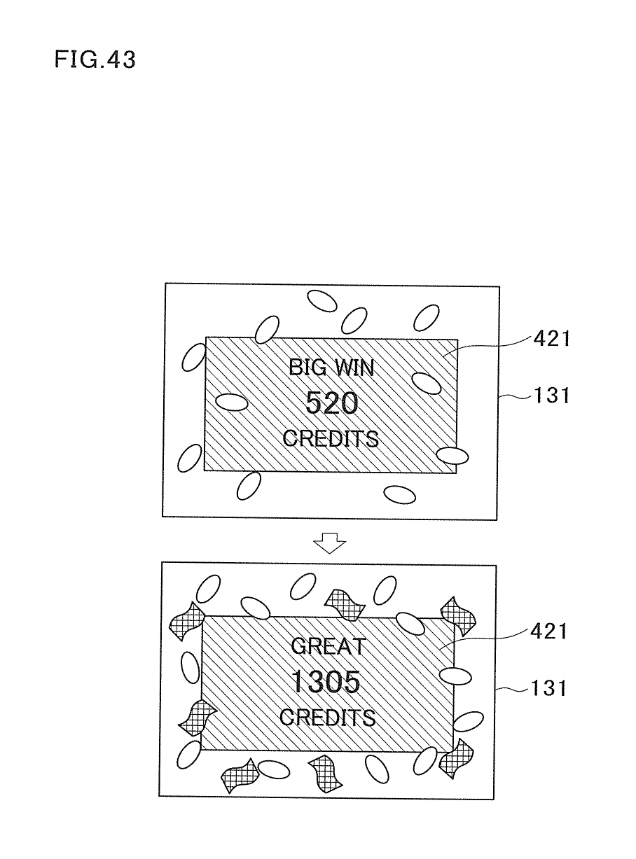

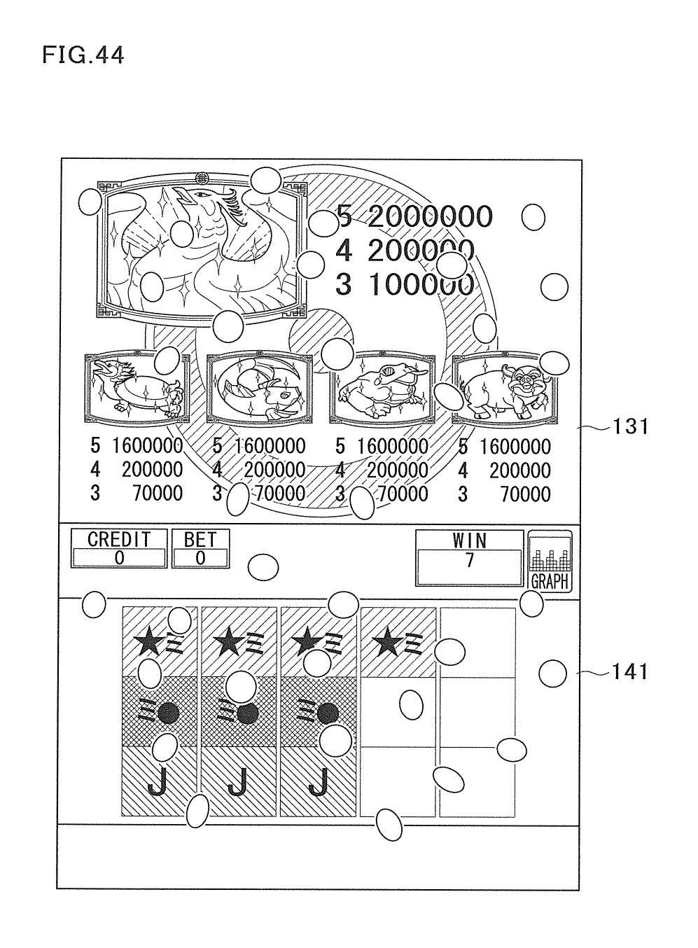

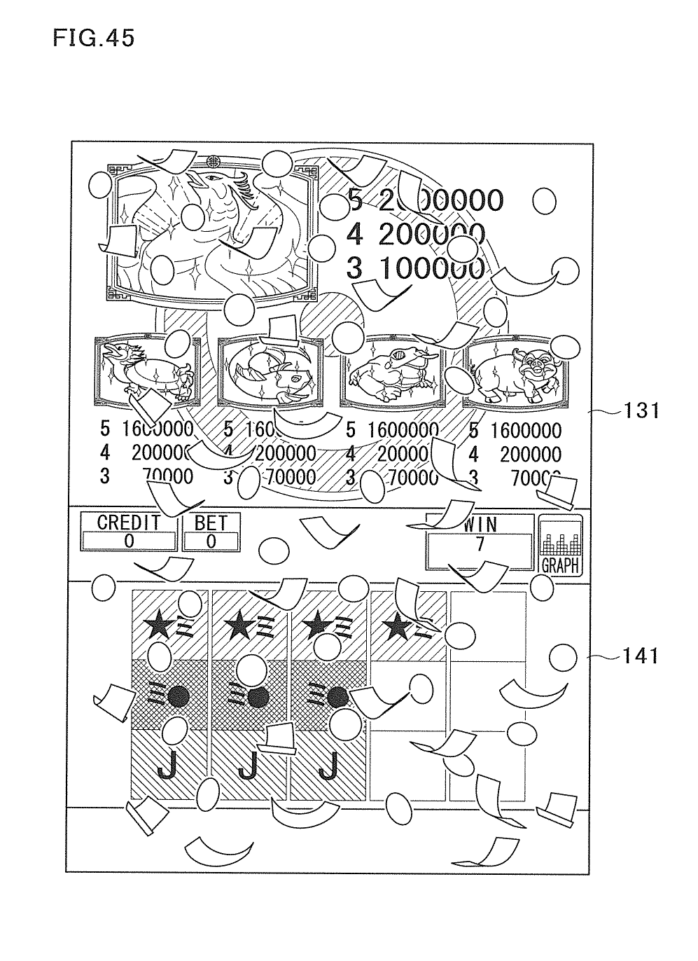

Now, the win signboard will be described with reference to FIGS. 42 to 45. FIG. 42 and FIG. 43 show a win signboard of the slot machine of the embodiment of the present invention (in the normal game). FIG. 44 and FIG. 45 show a win signboard of the slot machine of the embodiment of the present invention (in the free game).

The total win amount as a result of the current play of the game is displayed on a silver signboard 421 shown in FIG. 42 on the upper image display panel 131, when the total win is less than 15 times as much as the bet amount. On the gold signboard 421, an effect of falling coins is performed.

On the other hand, when the increment amount becomes more than 50 times as much as the bet amount, the gold signboard 421 shown in the upper part of FIG. 43 is changed to a gold signboard 421 shown in the lower part of FIG. 43, on the upper image display panel 131. On the gold signboard 421 on the lower part of the figure, effect of falling coins and paper money is performed. In other words, on the upper image display panel 131, the effect of falling coins 431 is performed first by the gold signboard 421. Subsequently, in sync with the increment display on the win meter 406, the obtained credit is incremented with the gold signboard 421. When the increment amount becomes more than 50 times as much as the bet amount, the gold signboard 421 shown in the upper part of FIG. 43 is replaced with the gold signboard 421 shown in the lower part of FIG. 43.

In addition to the above, in the free game, when the TOTAL WIN in the free game is less than 15 times as much as the bet amount, as shown in FIG. 44, an effect of displaying falling coins is performed on the upper image display panel 131 and the lower image display panel 141.

In the meanwhile, when in the free game the increment amount exceeds 50 times as much as the bet amount, an effect of displaying falling coins and bills is performed on the upper image display panel 131 and the lower image display panel 141 as shown in FIG. 45.

<Effect Sound when Three or More “FEATURE” Symbols Appear>

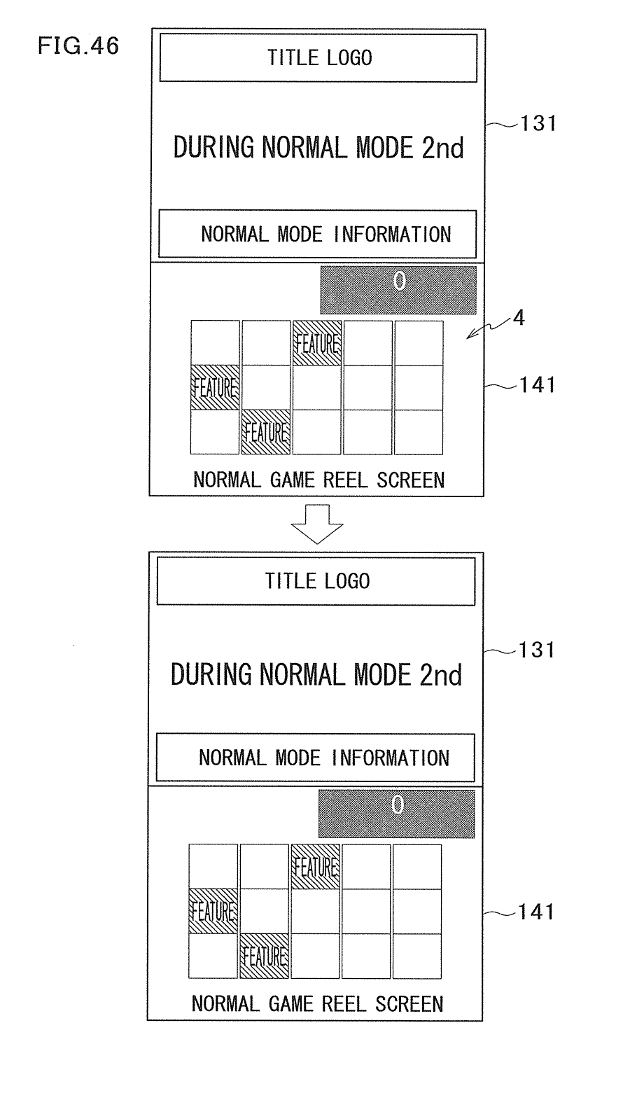

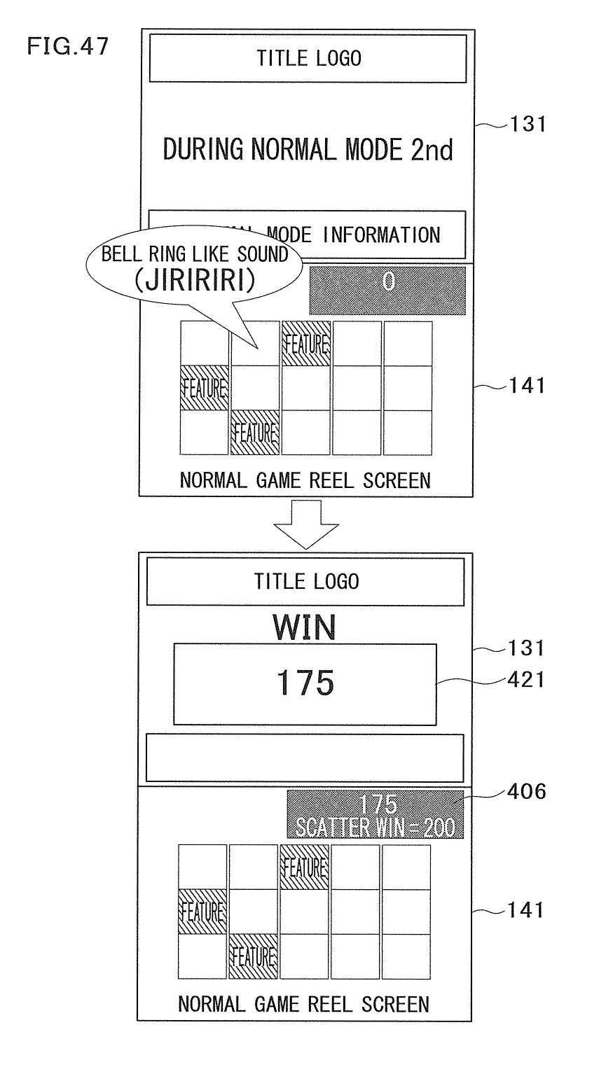

Now, effect sound when three or more “FEATURE” symbols appear will be described with reference to FIG. 46 and FIG. 47. FIG. 46 and FIG. 47 show the effect sound of the slot machine of the embodiment of the present invention when three or more “FEATURE” symbols appear.

When three or more “FEATURE” symbols appear in the symbol display area 4, dedicated “Jilililili” sound (bell-ring like sound) is reproduced as a sound effect. The sound reproduction starts when all reels stop, and lasts three seconds until the increment starts after 30 frames elapse. During the reproduction of the bleep sound, the symbol animation, the display of the LINE WIN, and the increment display are not performed.

According to the embodiment of the present invention, as shown in FIG. 46, in the symbol display area 4 on the lower image display panel 141, a waiting time as long as 30 frames starts when three or more “FEATURE” symbols appear in the symbol display area 4 at the time of the stop of all reels. After the waiting time as long as 30 frames, as shown in FIG. 47, the “jilililili” sound indicated by a balloon 441 is reproduced for three seconds as the effect sound when three or more “FEATURE” symbols appear.

After the three seconds, as shown in FIG. 47, the effect of LINE WIN starts in the symbol display area 4 on the lower image display panel 141, and the symbol animation starts. Furthermore, the win signboard 421 is displayed in the image area 402 of the upper image display panel 131. On the win signboard 421, the increment display starts. Simultaneously, the increment display starts on the win meter 406 of the lower image display panel 141. Furthermore, the reproduction of increment sound starts. Then the processing shifts to the above-described flow of the win effect.

(Display Screen: Graph Display Screen)

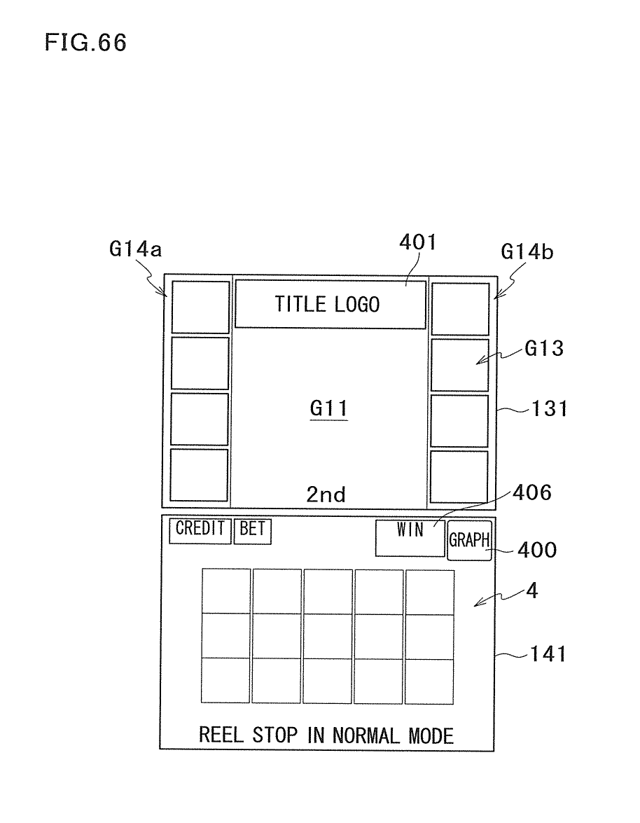

FIG. 66 is an explanatory diagram of display on the upper image display panel 131 and that on the lower image display panel 141 in the normal screen. Specifically, there is provided a graph screen display portion G11 arranged in the central portion, a title logo area 401 arranged in the upper middle of the graph screen display portion G11, door display portions G14a and G14b arranged on the left and right sides of the graph screen display portion G11, and a plurality of guidance display portions G13 arranged in the door display portions G14a and G14b. The guidance display portions G13 display wild symbols and payout tables.

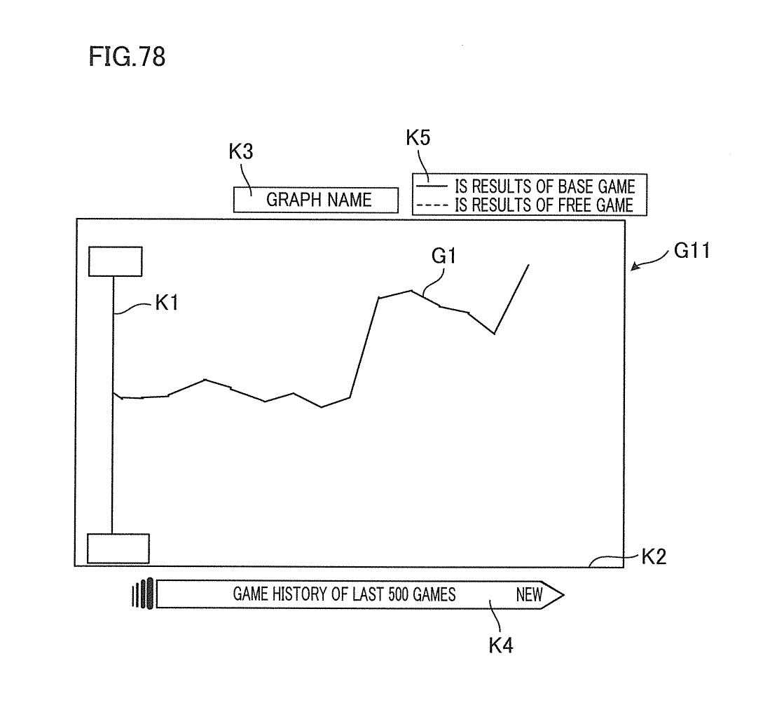

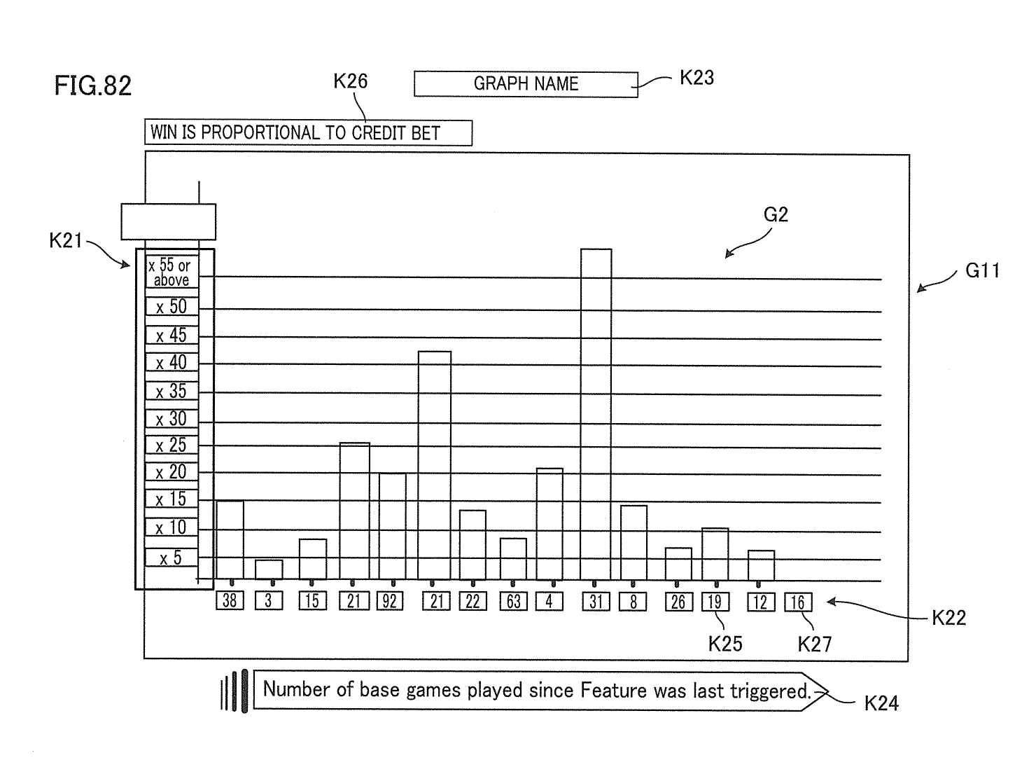

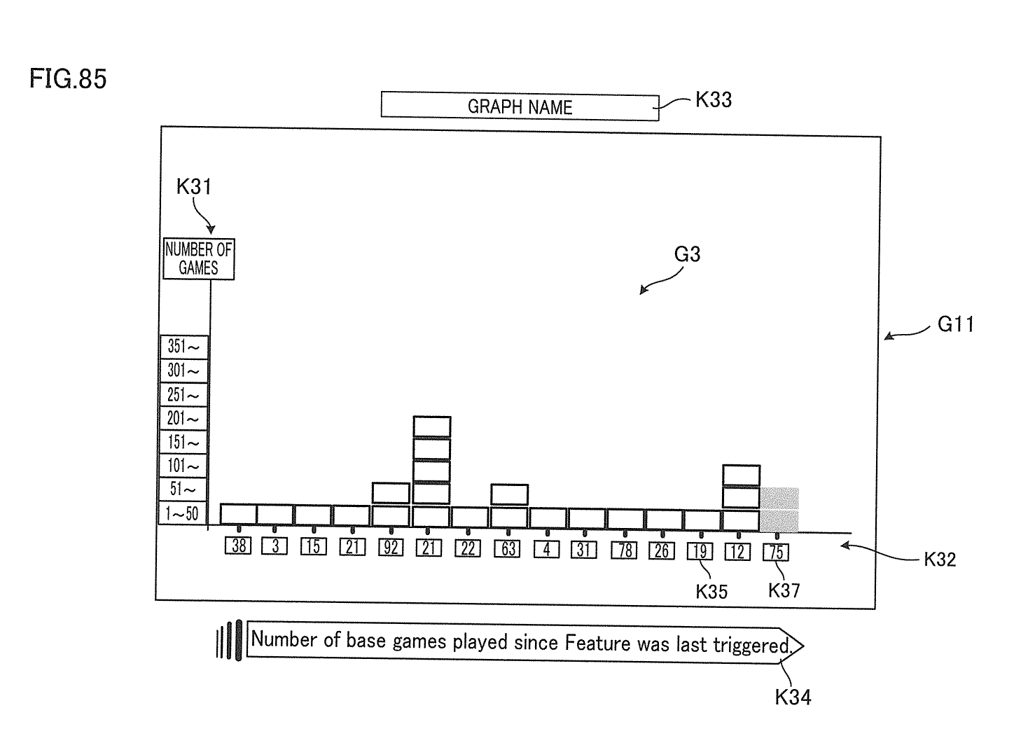

Specifically, the graph screen display portion G11 indicates a transition of returns, the number of plays at the time of winning a feature, and amount of credits won at the time. The graph screen display portion G11 is switch over displaying of three types of graph images, by touching operation of the graph-switch button 400 while the reels on the normal screen are stopped. The three types of graph images are images of: a line-graph, a bar-graph, and a block-graph. In other words, the display is switched sequentially in an order of: the 0th page shown in FIG. 66 (normal screen (title logo screen)), the first page shown in FIG. 78 (line-graph G1), the second page shown in FIG. 82 (bar-graph G2), the third page shown in FIG. 85 (block-graph G3), and then back to the 0th page shown in FIG. 66 (normal screen (title logo screen)). It should be noted that the data used in the graph image is reset at a time of power outage and at a time of RAM clear accompanying resetting of the software.

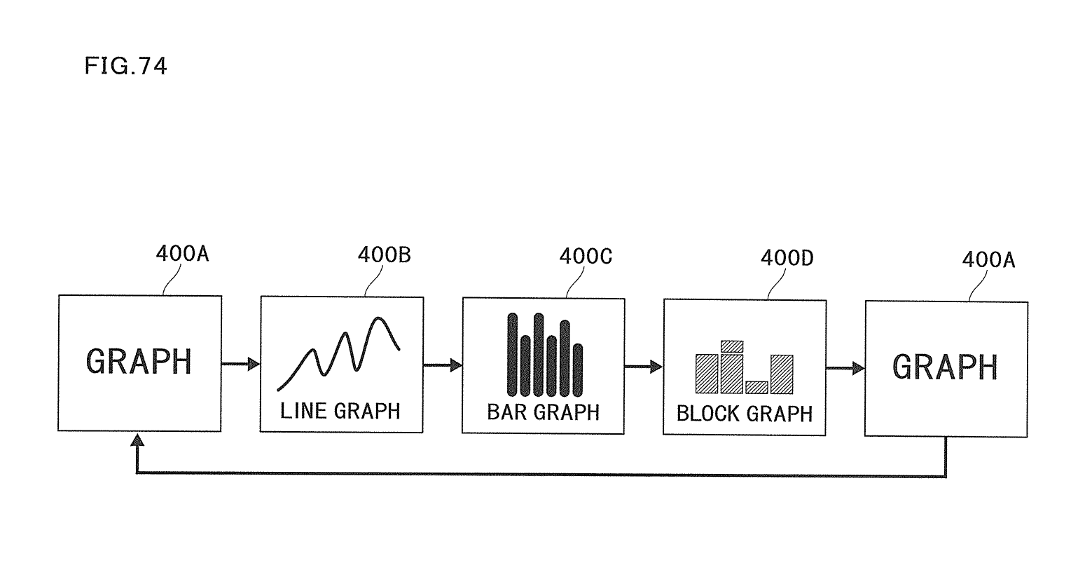

The graph-switch button 400 is arranged on the right side of the win meter 406 and allows switching over of the graph images by player's touch operations. Further, the graph-switch button 400 switches over its indication along with the switching of the graph images in the graph screen display portion G11. Specifically, as shown in FIG. 74, every time the graph-switch button 400 is touched by the player, its indication switches sequentially in an order of the 0th page (normal screen (title logo screen))-->the first page (line-graph G1),-->the second page (bar-graph G2),-->the third page (block-graph G3),-->and back to the 0th page (normal screen (title logo screen)). It should be noted that the graph-switch button 400 is active and enables touch operations thereon only when the reels are stopped at a time of the normal game, and is inactive and touch operations thereon are disabled during reel rotation or in the middle of the free game. It should be noted further that the brightness of the graph-switch button 400 in the inactive state is made darker than the graph-switch button 400 in the active state.

(Display Screen: Operations of Graph Display Screen)

The following describes the state of the display screen on the upper image display panel 131, when the graph-switch button 400 is touch-operated, with reference to FIG. 66 to FIG. 77.

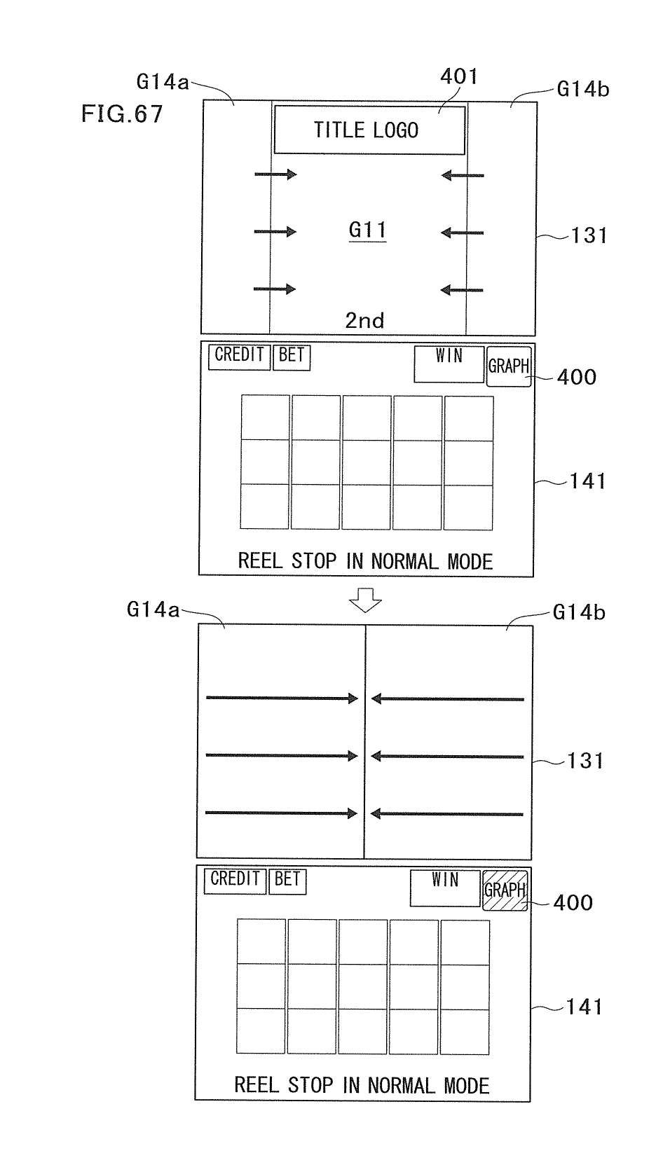

As shown in FIG. 66, the normal screen (title logo screen) is displayed on the upper image display panel 131. When the player touches to operate the graph-switch button 400 while the button is bright, the door display portions G14a and G14b expands inwardly their display areas, and simulate the situation that the graph screen display portion G11 and the title logo area 401 are hidden over the closed doors, as shown in FIG. 67. When the door display portions G14a and G14b simulate the closing doors, an effect sound of doors closing is output.

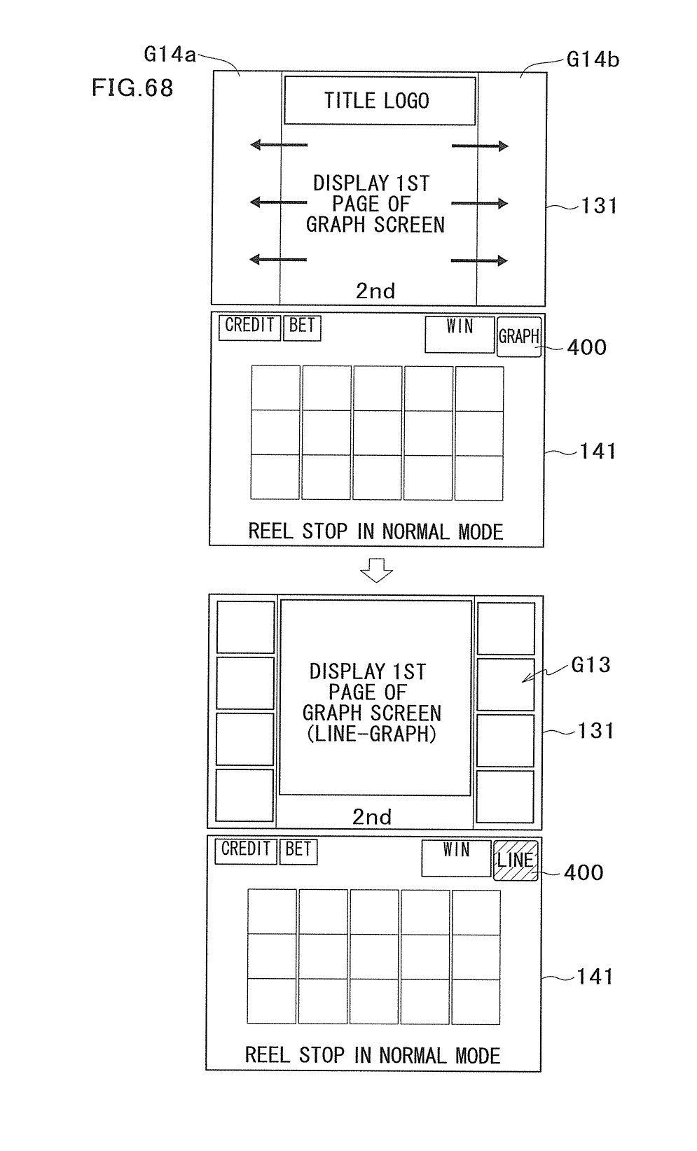

Immediately after that, there will be a video effect simulating the door display portions G14a and G14b open to the left and right, as shown in FIG. 68. The graph-switch button 400 at this time is in the inactive state and dimmed as compared to the graph-switch button 400 in the active state. Then, when the door display portions G14a and G14b are opened, a line-graph of the first page is displayed in the graph screen display portion G11. The graph-switch button 400 at this time is in the active state and made brighter as compared to the graph-switch button 400 in the inactive state. The guidance display portions G13 display wild symbols and payout tables.

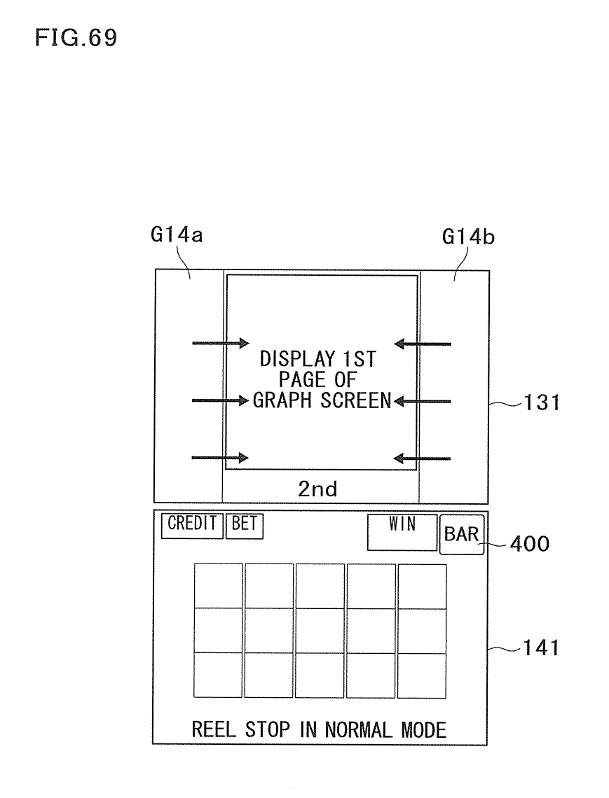

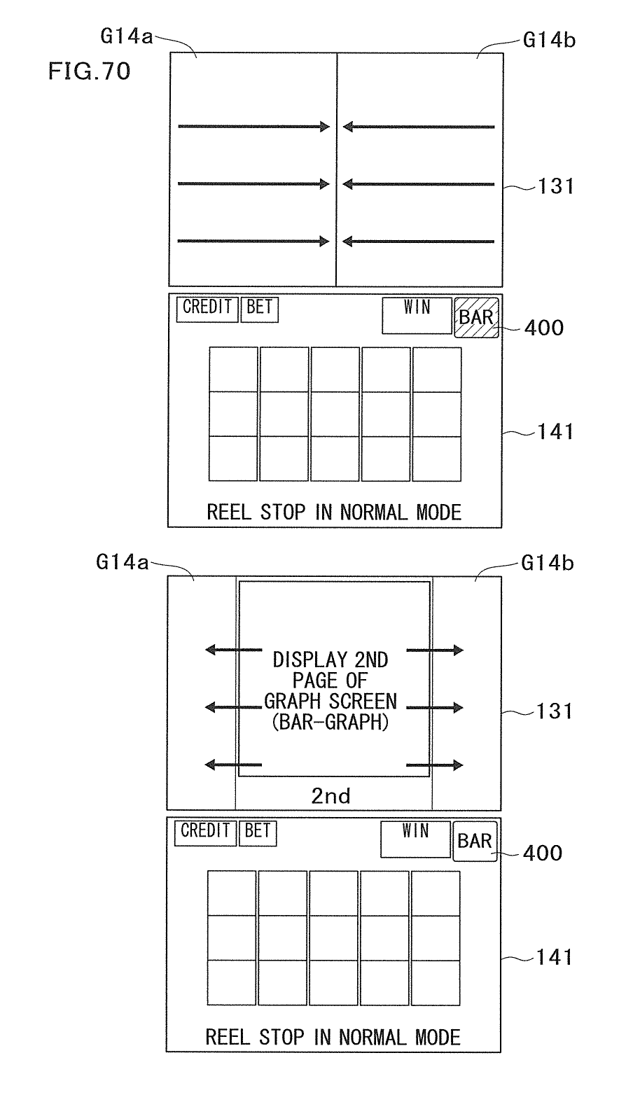

Further, as shown in FIG. 69, when the player touches to operate the graph-switch button 400 while the button is bright, the door display portions G14a and G14b expands inwardly their display areas, and simulate the situation that the line-graph displayed in the graph screen display portion G11 is hidden over the closed doors. Then, as shown in FIG. 70, when the door display portions G14a and G14b simulate the closing doors, an effect sound of doors closing is output.

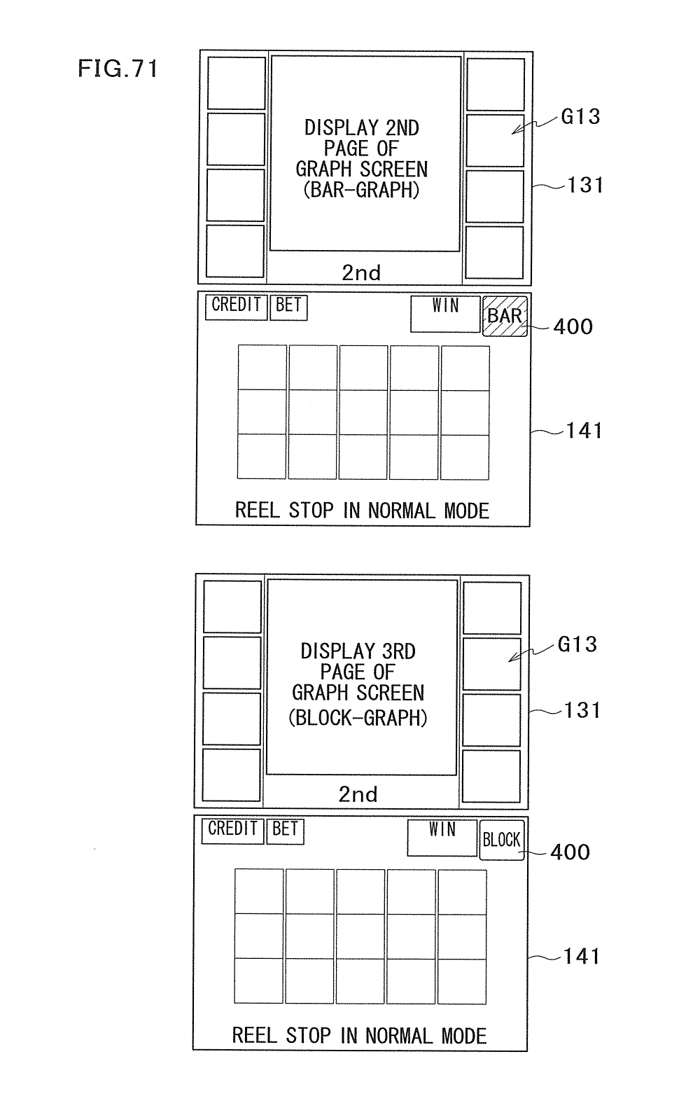

Immediately after that, there will be an image effect simulating the door display portions G14a and G14b open to the left and right, as shown in FIG. 70. The graph-switch button 400 at this time is in the inactive state and dimmed as compared to the graph-switch button 400 in the active state. Then, when the door display portions G14a and G14b are opened, a bar-graph of the second page is displayed in the graph screen display portion G11, as shown in FIG. 71. The graph-switch button 400 at this time is in the active state and made brighter as compared to the graph-switch button 400 in the inactive state. The guidance display portions G13 display wild symbols and payout tables.

Further, when the player touches to operate the graph-switch button 400 while the button is bright, the door display portions G14a and G14b expands inwardly their display areas, and simulate the situation that the bar-graph displayed in the graph screen display portion G11 is hidden over the closed doors. When the door display portions G14a and G14b simulate the closing doors, an effect sound of doors closing is output.

Immediately after that, there will be an image effect simulating the door display portions G14a and G14b open to the left and right. The graph-switch button 400 at this time is in the inactive state and dimmed as compared to the graph-switch button 400 in the active state. Then, when the door display portions G14a and G14b are opened, a block-graph of the third page is displayed in the graph screen display portion G11, as shown in FIG. 71. The graph-switch button 400 at this time is in the active state and made brighter as compared to the graph-switch button 400 in the inactive state. The guidance display portions G13 display wild symbols and payout tables.

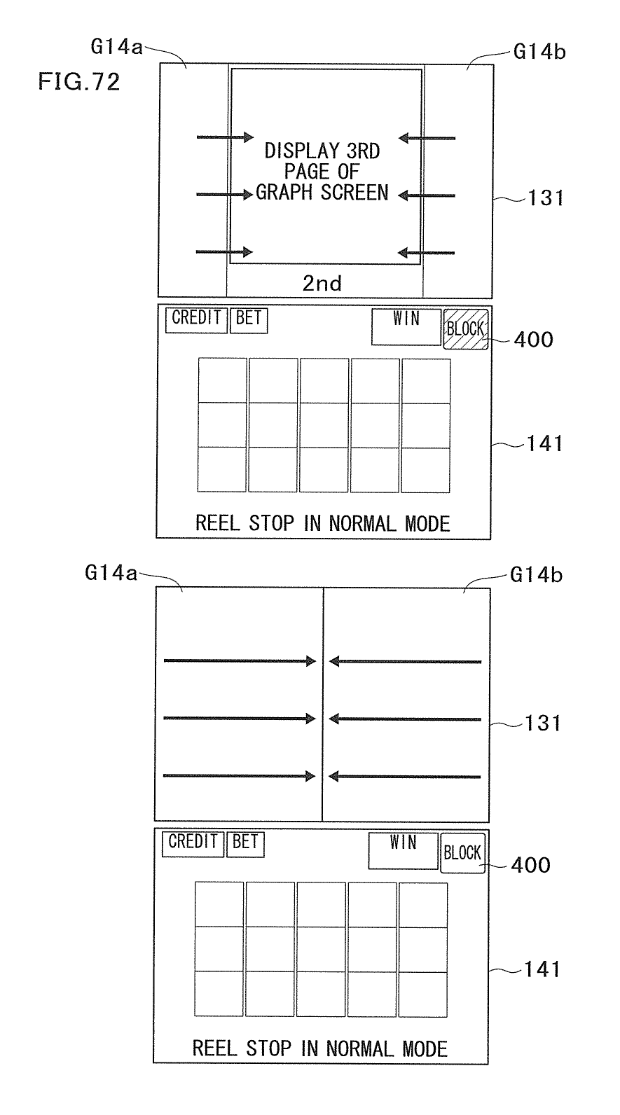

Further, as shown in FIG. 72, when the player touches to operate the graph-switch button 400 while the button is bright, the door display portions G14a and G14b expands inwardly their display areas, and simulate the situation that the block-graph displayed in the graph screen display portion G11 is hidden over the closed doors. Then, as shown in FIG. 72, when the door display portions G14a and G14b simulate the closing doors, an effect sound of doors closing is output.

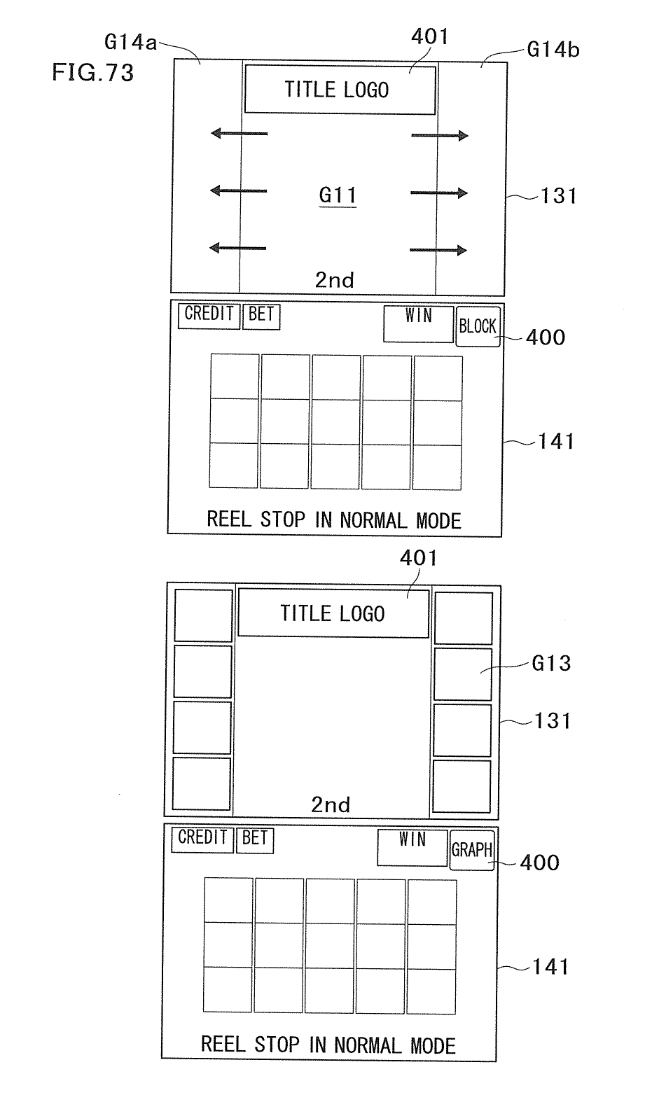

Immediately after that, there will be an image effect simulating the door display portions G14a and G14b open to the left and right, as shown in FIG. 73. The graph-switch button 400 at this time is in the inactive state and dimmed as compared to the graph-switch button 400 in the active state. Then, when the door display portions G14a and G14b are opened, the title logo area 401 of the normal screen is displayed in the graph screen display portion G11, as shown in FIG. 73. The graph-switch button 400 at this time is in the active state and made brighter as compared to the graph-switch button 400 in the inactive state. The guidance display portions G13 display wild symbols and payout tables.

By touching the graph-switch button 400, the display on the upper image display panel 131 is switched in the following sequence: the 0th page (normal screen (title logo screen)),-->the first page (line-graph)-->the second page (bar-graph),-->the third page (block-graph),-->back to the 0th page (normal screen (title logo screen)). At the same time, the graph-switch button 400 changes its graphics in a sequence of: a graph-switch button 400A corresponding to the 0th page (normal screen (title logo screen)),-->a graph-switch button 400B corresponding to the line-graph on the first page,-->a graph-switch button 400C corresponding to the bar-graph on the second page,-->a graph-switch button 400D corresponding to the block-graph on the third page,-->back to the graph-switch button 400A corresponding to the 0th page (normal screen (title logo screen)), as shown in FIG. 74. This way, the player is able to know what graph will be displayed next by touching the graph-switch button 400.

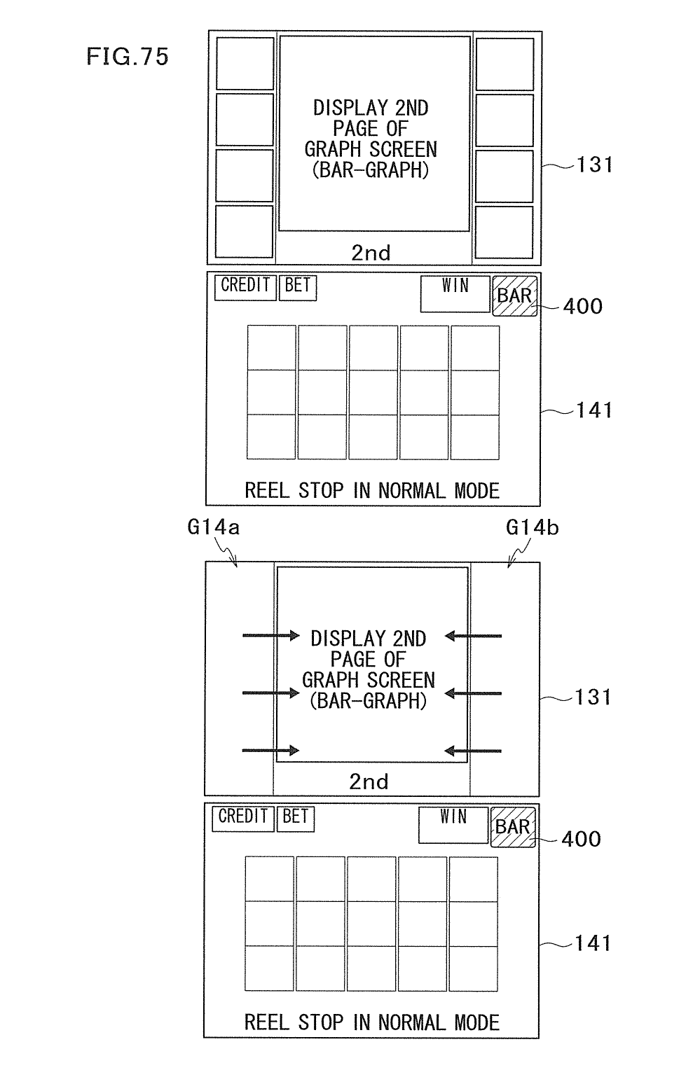

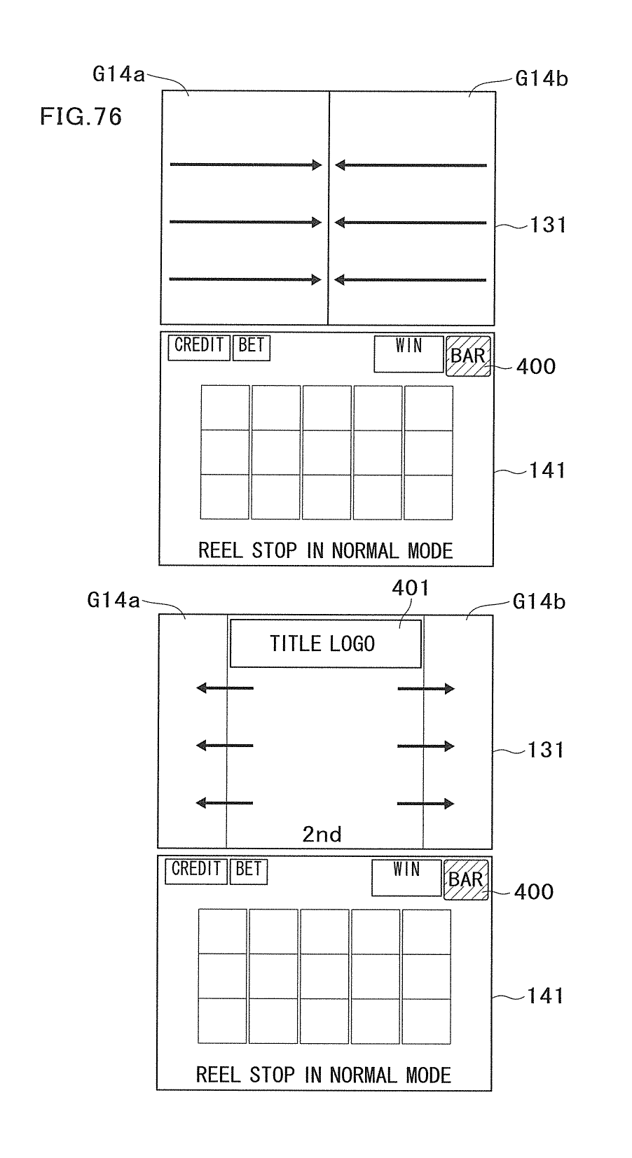

Further, for example, when the spin button 49 is pressed while the bar-graph on the second page is displayed in the graph screen display portion G11 as shown in FIG. 75, the doors close and the bar-graph displayed in the graph screen display portion G11 is hidden over the closed doors, as shown in FIG. 76. When the door display portions G14a and G14b simulate the closing doors, an effect sound of doors closing is output.

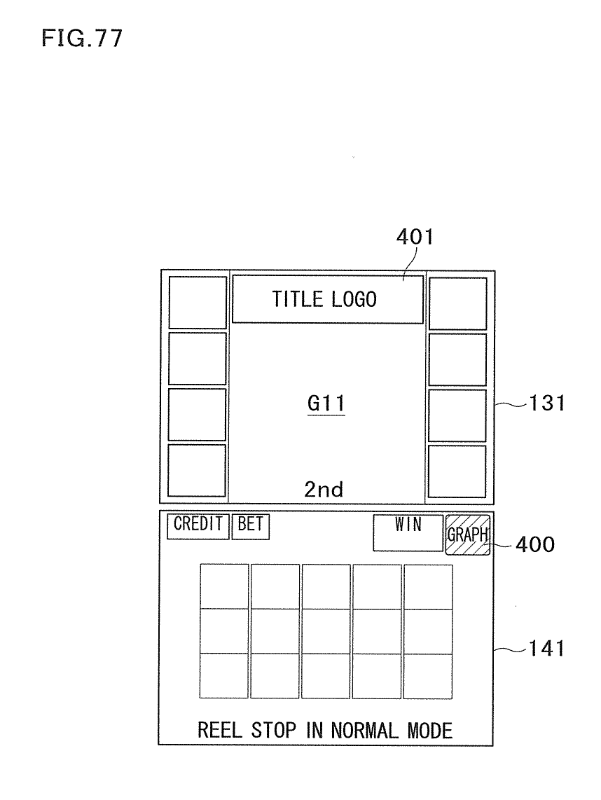

Immediately after that, there will be an image effect simulating the door display portions G14a and G14b open to the left and right, as shown in FIG. 76. The graph-switch button 400 at this time is in the inactive state and dimmed as compared to the graph-switch button 400 in the active state. Then, when the door display portions G14a and G14b are opened, the title logo area 401 of the normal screen is displayed in the graph screen display portion G11, as shown in FIG. 77. The graph-switch button 400 at this time is in the active state and made brighter as compared to the graph-switch button 400 in the inactive state. The guidance display portions G13 display wild symbols and payout tables.

(Display Screen: Line-Graph in Details)

Next, with reference to FIG. 78 to FIG. 81 the following describes the line-graph on the first page of the graph screen, which is switched by a touch-operation of the graph-switch button 400.

As shown in FIG. 78, in the upper part of the graph screen display portion G11, a graph name K3 is displayed. In the present embodiment, the indication will be “Graph showing Transition of Payout: Line-Graph” In the lower part of the graph screen display portion G11 is a label of the horizontal axis K4 reading “GAME HISTORY OF LAST 500 GAMES”.

As shown in FIG. 78, the line-graph G1 is displayed in the graph screen display portion G11 of the upper image display panel 131. The vertical axis K1 of this line-graph indicates the payout rate calculated by dividing the total payout in a unit game by the total bet amount. The points indicating the payout rate initially include: a point of 150 corresponding to ×150 at the top, and a point of −150 corresponding to ×−150 at the bottom. When an interval of a scale to the another is set to ×0.2 of the payout rate, the vertical axis is able to indicate a range from ×−30 to ×30. When the interval is set to ×1 of the payout rate, the vertical axis is able to indicate a range of ×−150 to 150. Further, a digit in a decimal place of the payout rate is rounded off to indicate the payout rate as an integer. The values plotted on the line-graph are each a value resulting from subtracting an amount corresponding to ×1 from the integer obtained by rounding off the payout rate. When the free game takes place, a slightly larger mark is plotted.

Further, the horizontal axis K2 indicates a cumulative number of plays of the normal game players have played. The right end of the horizontal axis is given a space to indicate the play of the normal game currently taking place, and 500 plays of the game are initially indicated on the horizontal axis. In other words, the last 500 plays of the game are indicated (the left end of the horizontal axis indicates the payout rate of a play which is 500 plays before the current play of the game).

For example, when the normal game starts with the betting of 15 credits (total bet amount) and a payout of 100 credits is awarded as a result of the normal game, the payout rate is 100÷15≈6.7, and this number is rounded to the nearest whole number and then 1 is subtracted therefrom. As a result, the payout rate is determined as “6”. When a dot is plotted at ×10 as the payout rate of the previous normal game, the present payout rate is added thereto as 10+“6”, and a dot is plotted at “16”. The dot at the previous ×10 is connected with the dot at ×16 as a result of the addition of the present payout rate by a linear line, and the line-graph G1 is updated. The payout rate of the total win including the free game is indicated by a dotted line.

To the upper right of the graph screen display portion G11, a graph information notification space K5 is provided. The space displays a message notifying that a full linear line in the graph indicates the payout rate as a result of the normal game, whereas a dotted linear line in the graph indicates the payout rate in the total win including the free game.

(Display Screen: Display of Scales in Line-Graph)

The upper and lower limit values of the vertical axis K1 shift according to the payout rate. Specifically, the points of the upper limit value and the lower limit value are shifted, as follows. Namely, with the points before the shift as the references, the points are shifted to values resulting from adding the value of the current payout rate to the points before the shift.

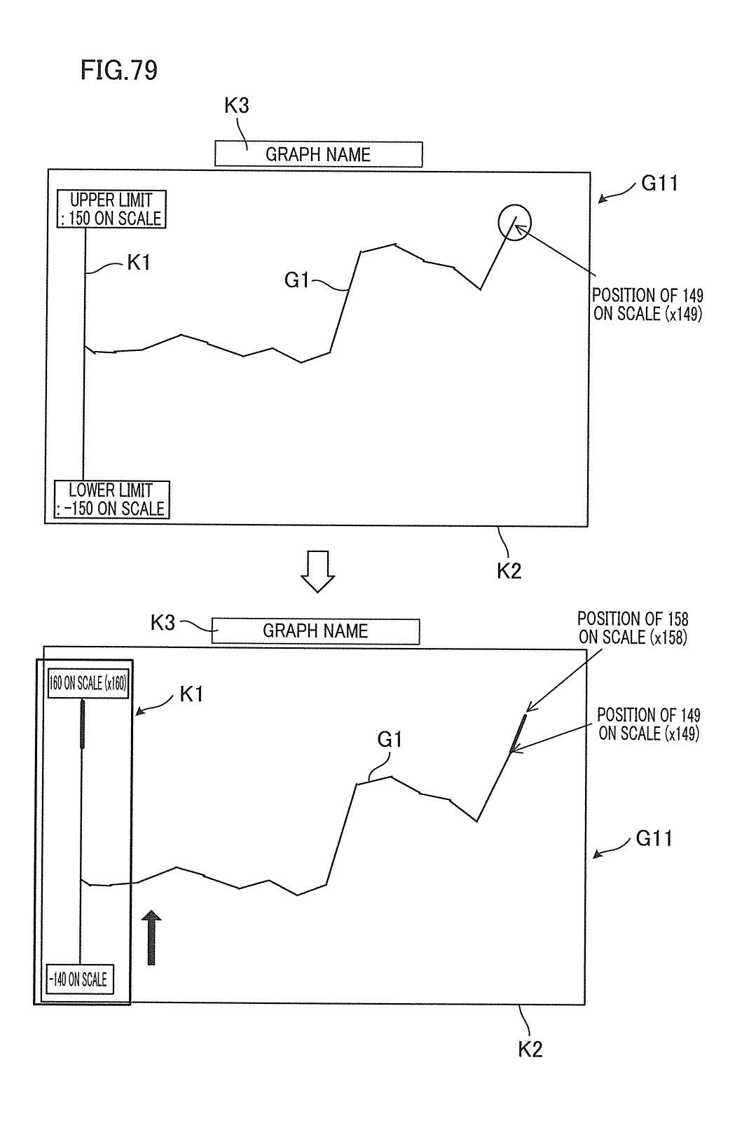

For example, as shown in FIG. 79, suppose the points indicating the payout rates has a point of 150 corresponding to the ×150 at the top and a point of −150 corresponding to ×−150 at the bottom. Then, a play of the normal game results in a payout rate of 9.86. In this case, a value of 10 resulting from rounding off the decimal digits of the payout rate is added to the upper limit value and the lower limit value. As the results, as shown in FIG. 79, the points indicating the payout rate include: a point of 160 corresponding to ×160 at the top and a point of −140 corresponding to −140 at the bottom. Then, as shown in FIG. 79, suppose the payout rate resulting in a play of the normal game is 9.86, and the value of the payout rate of the previous play is plotted at the point of 149. In this case, the payout rate of the current play is added so that 149+9, and the current payout rate is plotted at the point of ×158. Then, the point of ×149 which is the payout rate of the previous play and the point of ×158 which is the previous payout rate+the current payout rate are connected by a straight line and updated on the line-graph G1.

Further, when the payout rate of the current play is 0 or lower, the upper limit value and the lower limit value of the vertical axis K1 are shifted to the values resulting from subtracting 1 from each of the upper limit values and the lower limit values before the shift, respectively.

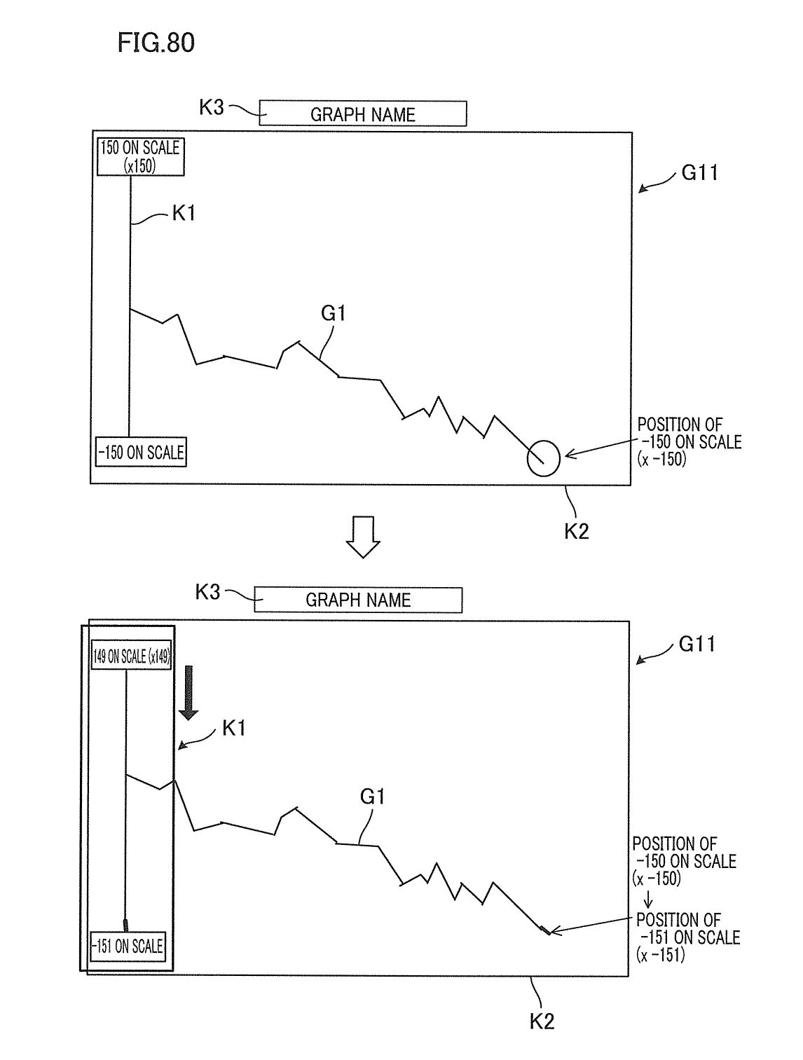

For example, as shown in FIG. 80, suppose the points indicating the payout rates has a point of 150 corresponding to the ×150 at the top and a point of −150 corresponding to ×−150 at the bottom. Then, a play of the normal game results in a payout rate of 0. In this case, a value of 1 is subtracted from the upper limit value and the lower limit value. As the results, as shown in FIG. 80, the points indicating the payout rate include: a point of 149 corresponding to ×149 at the top and a point of −151 corresponding to −151 at the bottom. Then, as shown in FIG. 80, suppose the payout rate resulting in a play of the normal game is 0, and the value of the payout rate of the previous play is plotted at the point of −150. In this case, the payout rate of the current play is added (i.e., 1 is subtracted as described above) so that (−150)+(−1), and the current payout rate is plotted at the point of ×−151. Then, the point of ×−150 which is the payout rate of the previous play and the point of ×−151 which is the previous payout rate+the current payout rate are connected by a straight line and updated on the line-graph G1.

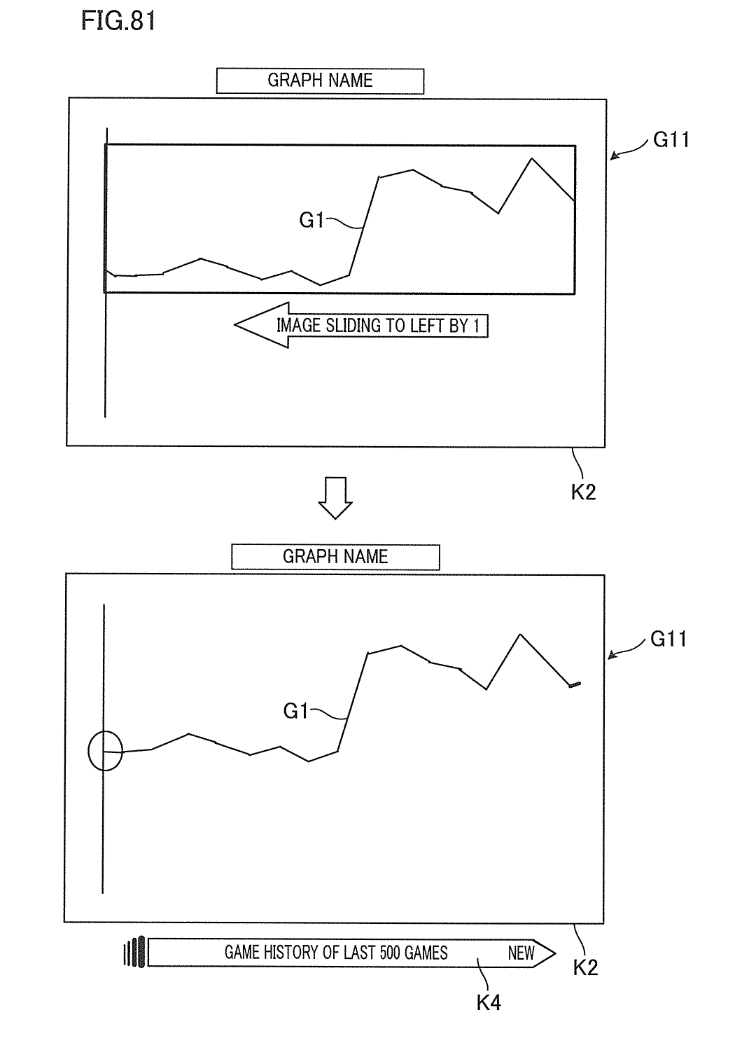

Further, as shown in FIG. 81, the line-graph G1 is updated every time a play of the normal game is run, and shifts to the left by 1 point.

(Display Screen: Bar-Graph in Details)

Next, with reference to FIG. 82 to FIG. 84 the following describes the bar-graph on the 2 page of the graph screen, which is switched by a touch-operation of the graph-switch button 400.

As shown in FIG. 82, in the upper part of the graph screen display portion G11, a graph name K23 is displayed. In the present embodiment, the indication will be “Total win graph of Free game: bar-graph”. In the lower part of the graph screen display portion G11 is a label of the horizontal axis K24 reading “Number of base games played since Feature was last triggered”. Further, in the upper left of the graph screen display portion G11, there is a display field K26. In the present embodiment, the indication will be “win is proportional to the credits bet”.

As shown in FIG. 82, the bar-graph G2 is displayed in the graph screen display portion G11 of the upper image display panel 131. The vertical axis K21 of this bar-graph G2 indicates the payout rate resulting from a calculation of the total payout obtained in all the plays of the free game, when the free game is run, divided by the total bet amount. There are points indicating payout rates, up to ×55. Further, to facilitate confirmation of the payout rate, horizontal lines are given to the payout rate.

Further, the “total win in the free game” of a player indicated by the horizontal axis K22 covers 15 plays including the current play. A box K25 under each bar-graph indicating the “total win in the free game” indicates the number of plays of the normal game run from the last triggered free game or from the end of the last 15-choice pick game till the 15-choice pick game is newly triggered. It should be noted that the rightmost box K27 indicates the cumulative total of the plays of the normal game run from the last triggered free game or from the end of the last 15-choice pick game till the current time.

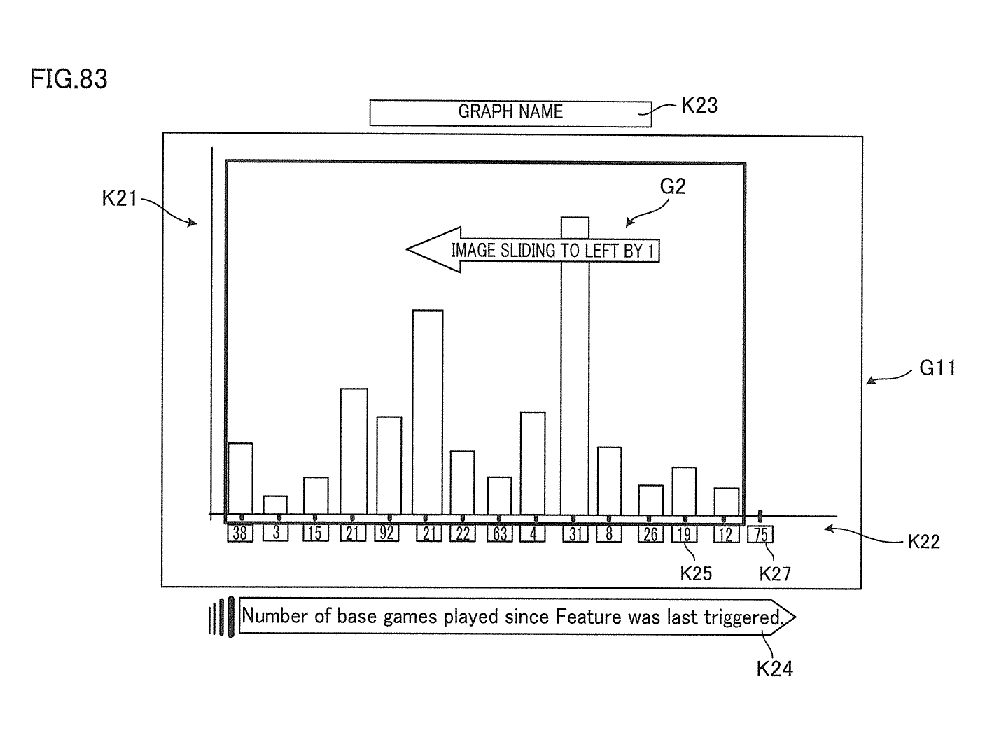

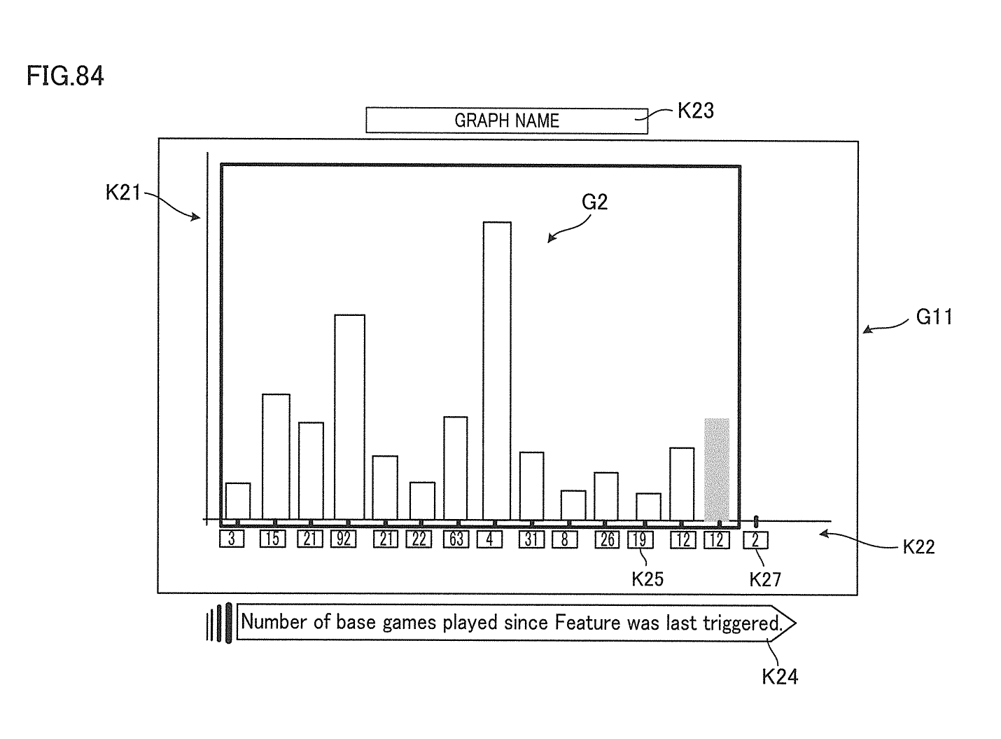

Further, as shown in FIG. 83 and FIG. 84, the bar-graph G2 is updated every time the right to play the free game is awarded, and shifts to the left by 1 point.

(Display Screen: Block-Graph in Details)

Next, with reference to FIG. 85 to FIG. 87 the following describes the block-graph on the third page of the graph screen, which is switched by a touch-operation of the graph-switch button 400.

As shown in FIG. 85, in the upper part of the graph screen display portion G11, a graph name K33 is displayed. In the present embodiment, the indication will be “Game Play Graph when Winning Free Game: Block-Graph”. In the lower part of the graph screen display portion G11 is a label of the horizontal axis K24 reading “Number of base games played since Feature was last triggered”.

As shown in FIG. 85, the block-graph G3 is displayed in the graph screen display portion G11 of the upper image display panel 131. The vertical axis K31 in the block-graph G3 indicates the number of plays of the normal game run from the last triggered free game until the free game is newly triggered. The points on the vertical axis indicates 9 steps, each of which step represents 50 plays of the game.

Further, the number of plays of the free game played by a player indicated by the horizontal axis K32 covers 15 plays including the current play. A box K35 under each column of the block-graph G3 indicates the number of plays of the normal game run from the end of the last free game till the free game is newly triggered. It should be noted that the rightmost box K27 indicates the cumulative total of the plays of the normal game run from the end of the last free game till the current time. The rightmost box K37, since it indicates the current value, is displayed in a different color from that of the other boxes K35 so as to make it noticeable to the player.

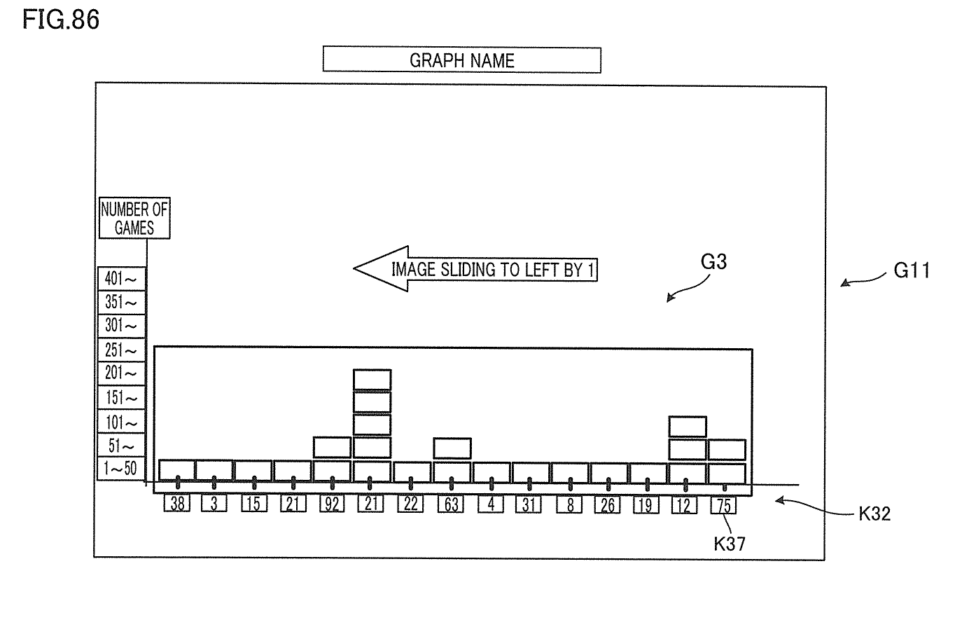

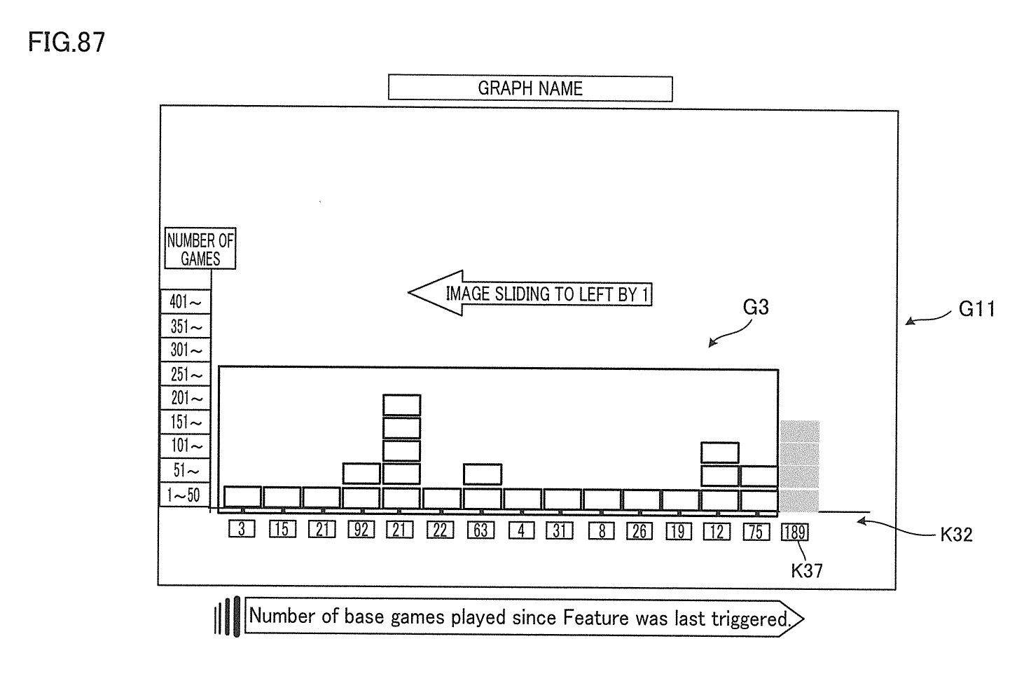

Further, as shown in FIG. 86 and FIG. 87, the value in the box K37 is incremented by 1 every time a play of the normal game is run. Further, the block-graph G3 is updated every time a right to play the free game is awarded, and shifts to the left by 1 point. Then, the value in the new rightmost box K37 by the horizontal axis K32 is incremented by 1 every time a play of the normal game is run.

(Setting of Audit for Switching Graph Screen: Audit)

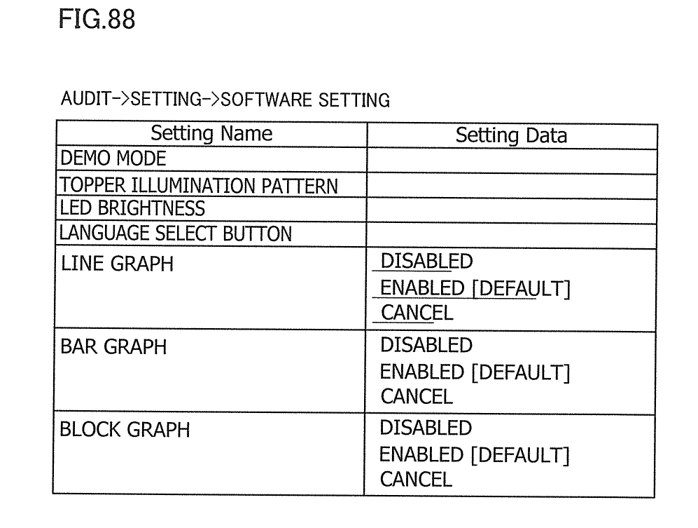

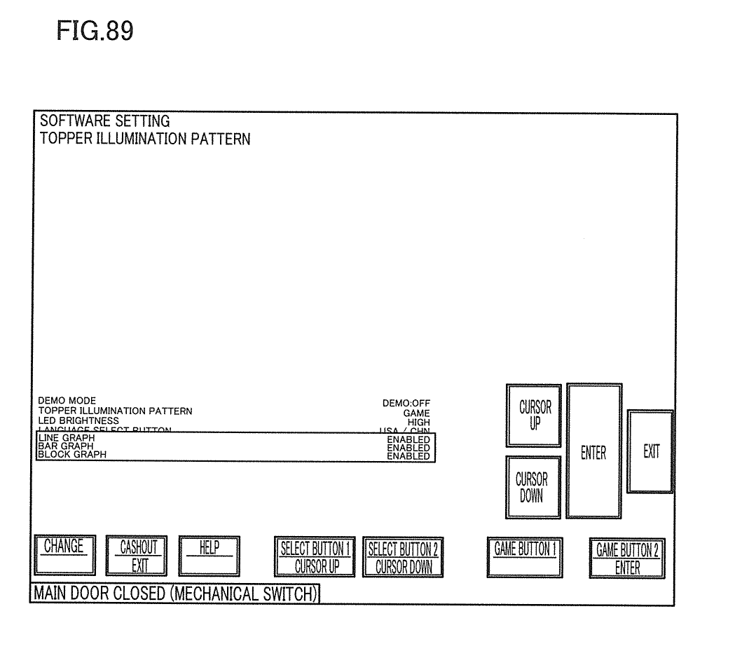

In the present embodiment, the line-graph G1, the bar-graph G2, and the block-graph G3 displayed on the graph screen display portion G11 are switchable to active or inactive state in Audit setting (see FIG. 89). Specifically, as shown in FIG. 88, whether to display or not display the line-graph G1, the bar-graph G2, and the block-graph G3 is set by selecting “Disabled” or “Enabled” in the setting for “LINE GRAPH” for the line-graph, “BAR-GRAPH” for the bar-graph, and “BLOCK GRAPH” for the block-graph displayed in the “SOFTWARE SETTING” of the AUDIT.

[Win Meter Information Display]

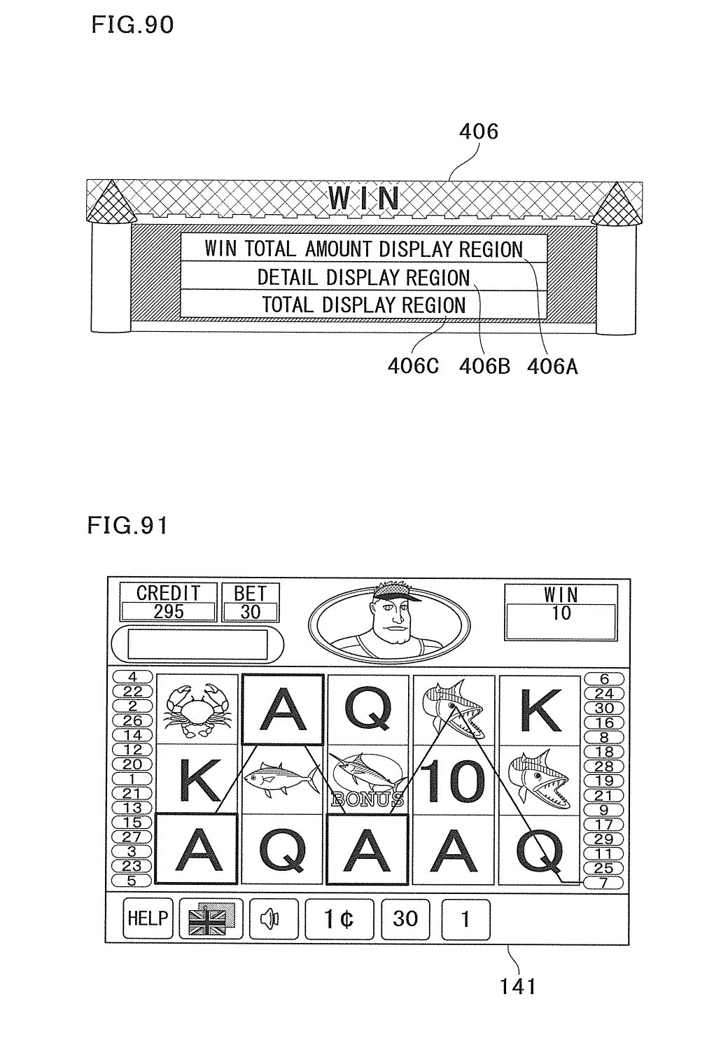

Now, win meter information display of the slot machine 1 will be described with reference to FIG. 90. FIG. 90 illustrates the win meter information display of the slot machine of the embodiment of the present invention.

As shown in FIG. 90, a win meter 406 is provided with a win total amount display region 406A, a detail display region 406B, and a total display region 406C.

The win total amount display region 406 displays a win credit and a money amount. Increment display is performed based on a win increment speed sheet, when performed. More specifically, the win total amount display region 406A displays a credit amount obtained in the current game cycle (or in the previous game cycle). When a credit is obtained more than once in one game cycle, the credit is added each time it is obtained. For example, when the free game is triggered in the normal game and the player obtains a normal win 20 and a bonus win 100, the image display is incremented from “0” to “120”. Thereafter, when the player obtains a payout amount of 200 in the free game, the increment display is conducted from 120 to 320. 0 is displayed either when the next game cycle starts or when lost in GAMBLE. In the meanwhile, when a win is achieved in GAMBLE, no increment is carried out and the displayed amount is immediately doubled.

The detail display region 406 relates to a win in the normal game and the free game. After the fifth reel stops, the win credit is displayed. When more than one payout simultaneously occurs, the line payouts are displayed one by one at intervals of 0.5 second. The payouts are serially displayed in an ascending order of the payout amount, and the smallest payout is again displayed after the largest payout is displayed. In other words, the detail display region 406 displays the details of the credit obtained by the spinning in this time. When there are plural elements (e.g., another line or scatter), the elements are switched at intervals of 0.5 second.

The total display region 406C displays the total credits of the detail display region 406 when the increment in the win total amount display region 406A is completed. The region is not displayed until the increment in the win total amount display region 406A is completed. In other words, the total display region 406C displays the details of the credit obtained by the spinning in this time. In this regard, the total credits are displayed after the increment in the win total amount display region 406A is finished.

[Gamble Specification]

Now, the GAMBLE specification in the slot machine 1 will be described with reference to FIG. 91 to FIG. 97. Each of FIG. 91 to FIG. 97 illustrates GAMBLE specification in the slot machine of the embodiment of the present invention.

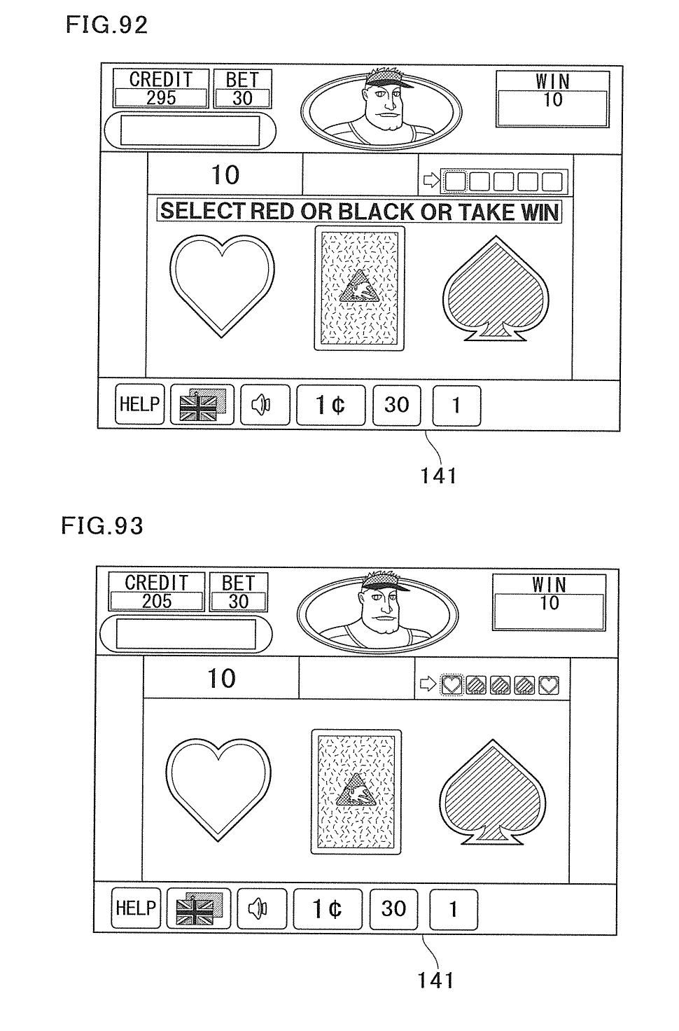

To begin with, when a winning (WIN) is achieved, the lower image display panel 141 shown in FIG. 91 is changed to the lower image display panel 141 shown in FIG. 92. In other words, a gamble screen is displayed whereas the message “PLAY ON, GAMBLE or TAKE WIN” is deleted from the lower image display panel 141. In the meanwhile, a message “SELECT RED OR BLACK OR TAKE WIN” is displayed on the lower image display panel 141.

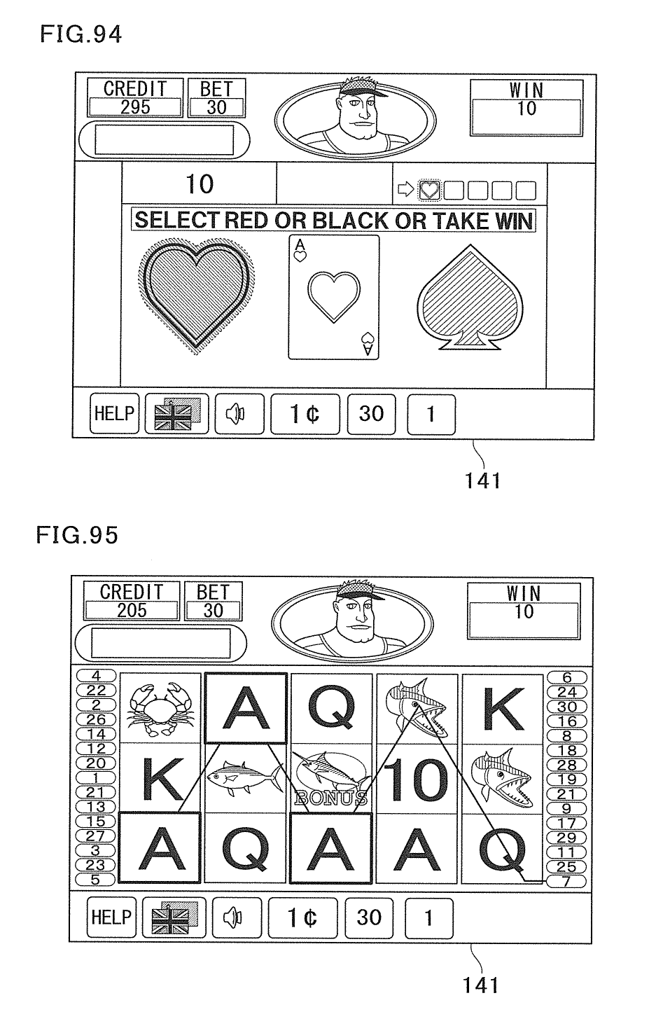

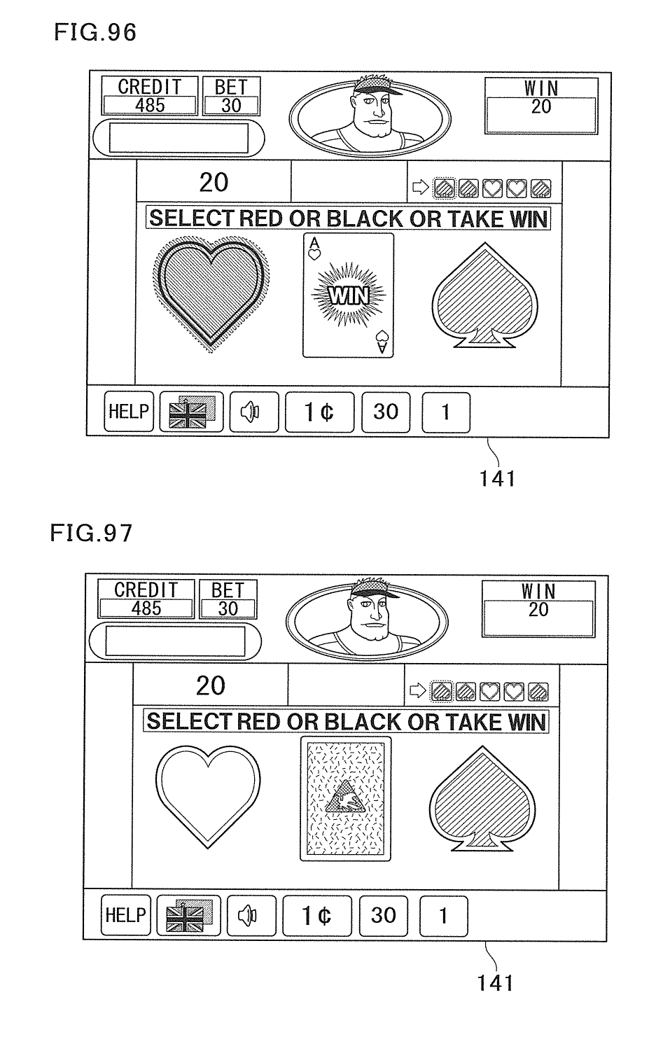

Subsequently, on the lower image display panel 141 shown in FIG. 93, a betted amount is displayed on the lower image display panel 141 as “GAMBLE AMOUNT”. The player selects “RED” or “BLACK”. When the player succeeds in the selection, the lower image display panel 141 is changed to the later-described lower image display panel 141 shown in FIG. 96. In the meanwhile, when the player fails in the selection, the lower image display panel 141 is changed to the lower image display panel 141 shown in FIG. 94. When the player selects “TAKE WIN”, the amount of win is immediately added to the credits on the lower image display panel 141 and the idle state returns.

When the player fails in the selection, the option (“RED” or “BLACK”) which is not selected is darkened on the lower image display panel 141 shown in FIG. 94. On the lower image display panel 141 shown in FIG. 94, the history of card selection is immediately displayed at the leftmost part of the “GAMBLE HISTORY”. When there is previous history of card selection, that previous history is moved to the immediate right. The trace of the movement is not illustrated in animation, and hence the history is rewritten at once. Furthermore, the result of the central card is immediately displayed. At this stage, however, neither the win meter nor the gamble amount meter changes. Then failure sound is reproduced, and after 1.2 seconds elapse after the sound reproduction, the screen is switched to a main game screen as indicated by the lower image display panel 141 shown in FIG. 95. At the same time as the switching to the main game screen, “0” is displayed on the win meter.

When the player succeeds in the selection, the option (“RED” or “BLACK”) which is not selected is darkened on the lower image display panel 141 shown in FIG. 96. On the lower image display panel 141 shown in FIG. 96, the history of card selection is immediately displayed at the leftmost part of the “GAMBLE HISTORY”. When there is previous history of card selection, that previous history is moved to the immediate right. The trace of the movement is not illustrated in animation, and hence the history is rewritten at once. Furthermore, as the central card, a normal card and a card with a win text are alternately displayed for each frame, and success sound is reproduced for 1.2 seconds. To the win meter, the amount increased by the result of GAMBLE is immediately added. At this stage, however, neither the win meter nor the gamble amount meter changes.

When GAMBLE is played until reaching the upper limit number of times, the value of win is added to the credit at once and the idle state returns. In the meanwhile, the number of times of playing the GAMBLE has not reached the upper limit, the lower image display panel 141 is changed to the lower image display panel 141 shown in FIG. 97. On the lower image display panel 141 shown in FIG. 97, the central card is overturned. Thereafter, the lower image display panel 141 is changed to the lower image display panel 141 shown in FIG. 93.

[Residual Gamble]

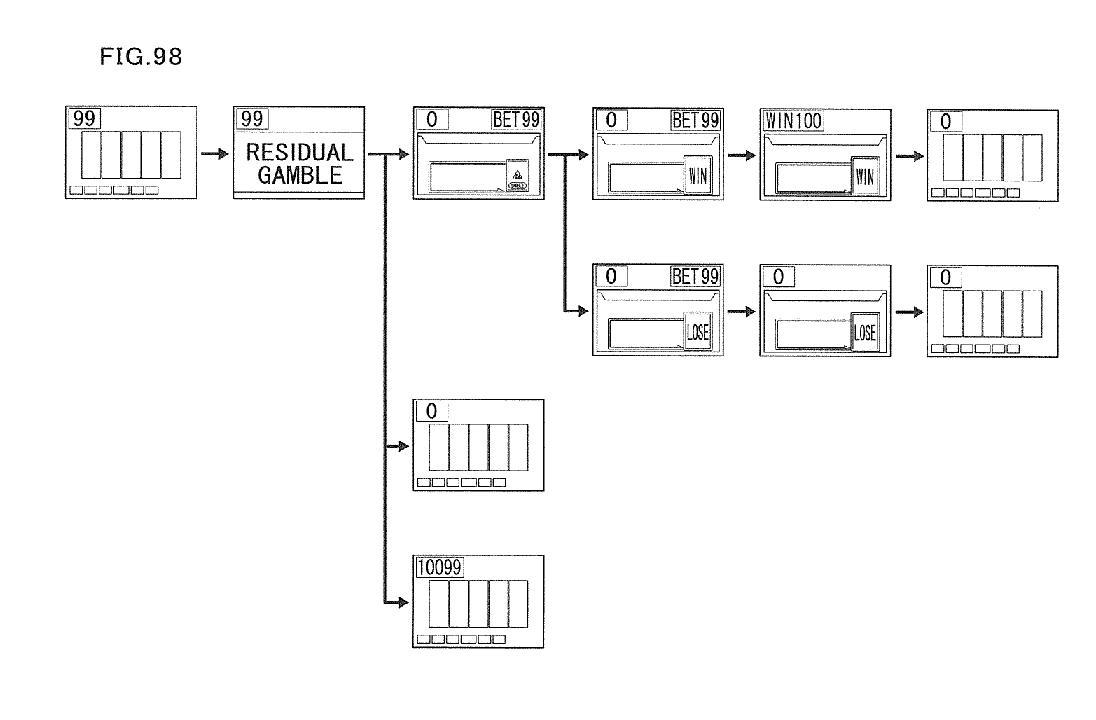

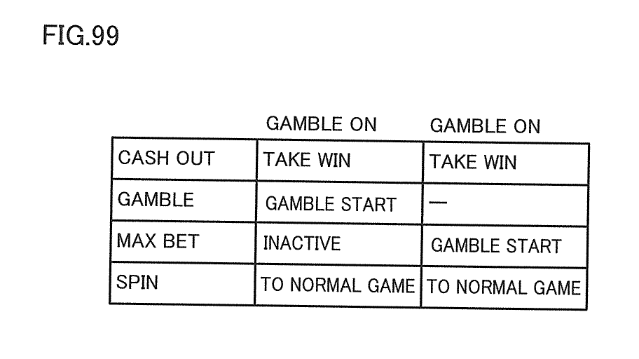

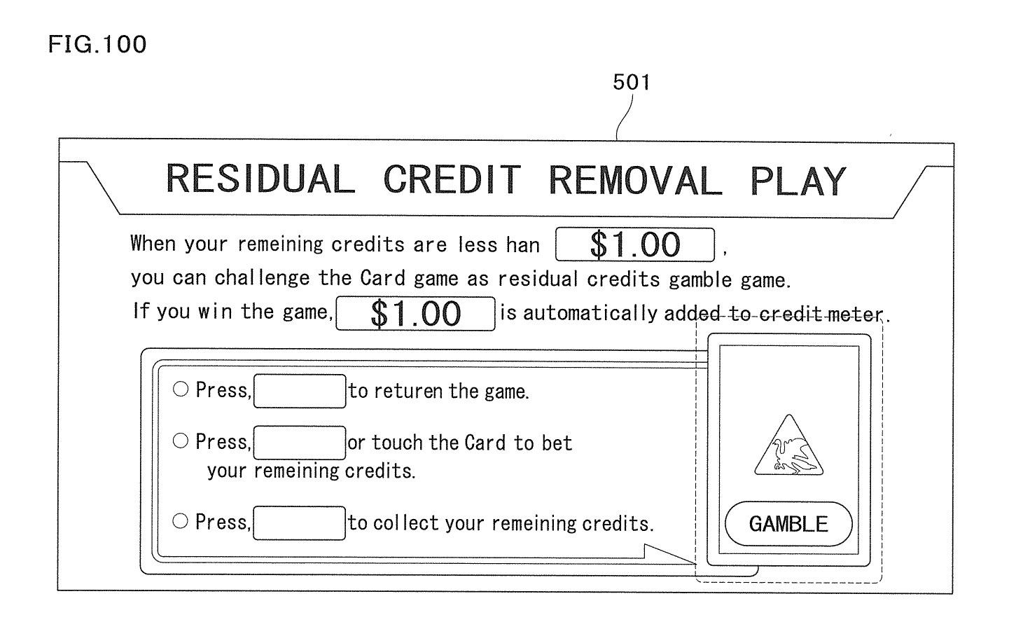

Now, RESIDUAL GAMBLE in the slot machine 1 will be described with reference to FIG. 98 to FIG. 100. FIG. 98 to FIG. 100 illustrate RESIDUAL GAMBLE in the slot machine related to the embodiment of the present invention. RESIDUAL GAMBLE is executed in line with the flow shown in FIG. 98, by using a table shown in FIG. 99. In this connection, in a stage in the RESIDUAL GAMBLE, an image 501 shown in FIG. 100 is displayed on the lower image display panel 141.

[System Font Display Region]

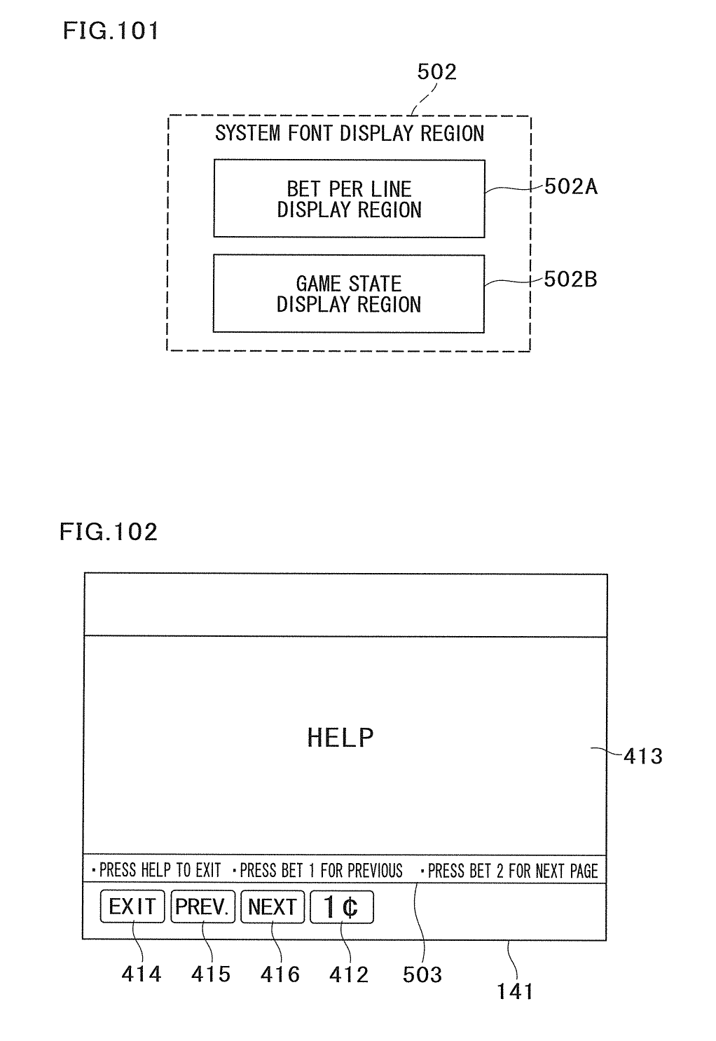

Now, a system font display region of slot machine 1 will be described with reference to FIG. 101. FIG. 101 shows a system font display region of the slot machine of the embodiment of the present invention. The system font display region 502 shown in FIG. 101 is provided with a bet per line display region 502A and a game state display region 502B. The system font display region 502 is provided in the bet information and game state display region 407 on the lower image display panel 141.

[HELP Specification]

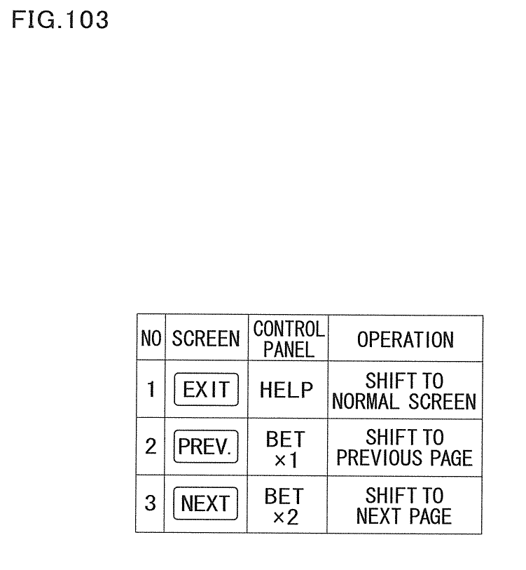

Now, the HELP specification in the slot machine 1 will be described with reference to FIG. 102 to FIG. 103. FIG. 102 and FIG. 103 explain HELP specification in the slot machine of the embodiment of the present invention. As shown in FIG. 102, on the lower image display panel 141 in HELP specification, a help screen 413 and a message region 503 are provided, and an EXIT touch button 414, a PREV. touch button 415, a NEXT touch button 416, and a denomination indicator 412 are displayed.

The message region 503 is displayed with system fonts. This region is linked with the control panel 30 or the control panel 460. For this reason, when another pattern is used and the number is changed, the image display on the region is changed to the correct one in accordance with the change.

As indicated in the table shown in FIG. 103, when the player touches or presses the EXIT touch button 414 or the help button on the control panel, the lower image display panel 141 in HELP specification is changed to the normal screen. When the player touches or presses the PREV. touch button 415 or a BET×1 button on the control panel, the lower image display panel 141 in HELP specification is changed to the preceding HELP page. When the player touches or presses the NEXT touch button 416 or a BET×2 button on the control panel, the lower image display panel 141 in HELP specification proceeds to the next HELP page.

[Layout of Screen Touch Buttons]

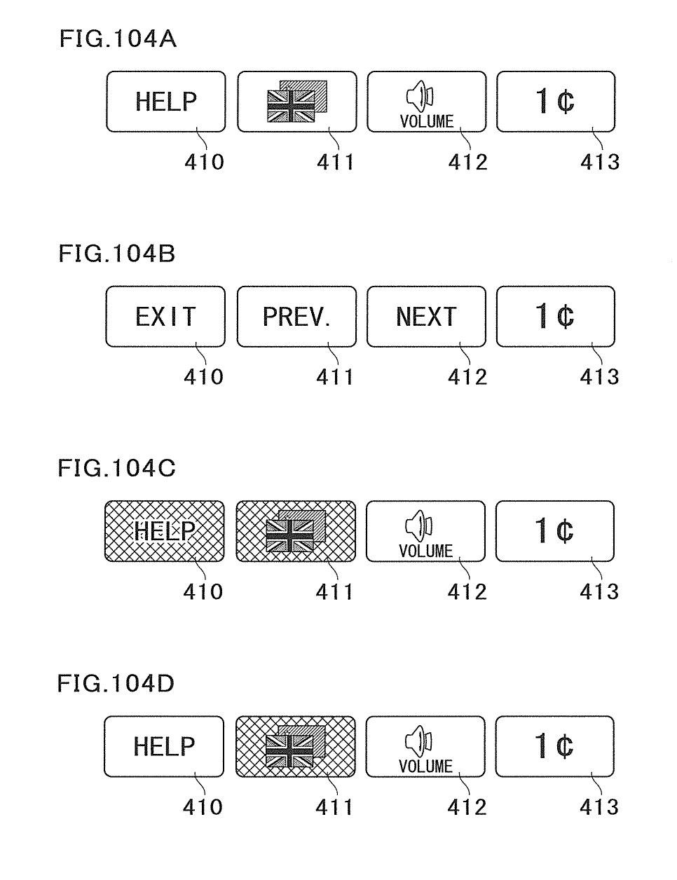

Now, the following will describe the layout of the screen touch buttons in the slot machine 1, with reference to FIG. 104 to FIG. 106. FIG. 104 to FIG. 106 show arrangement of screen touch buttons of the slot machine related to the embodiment of the present invention.

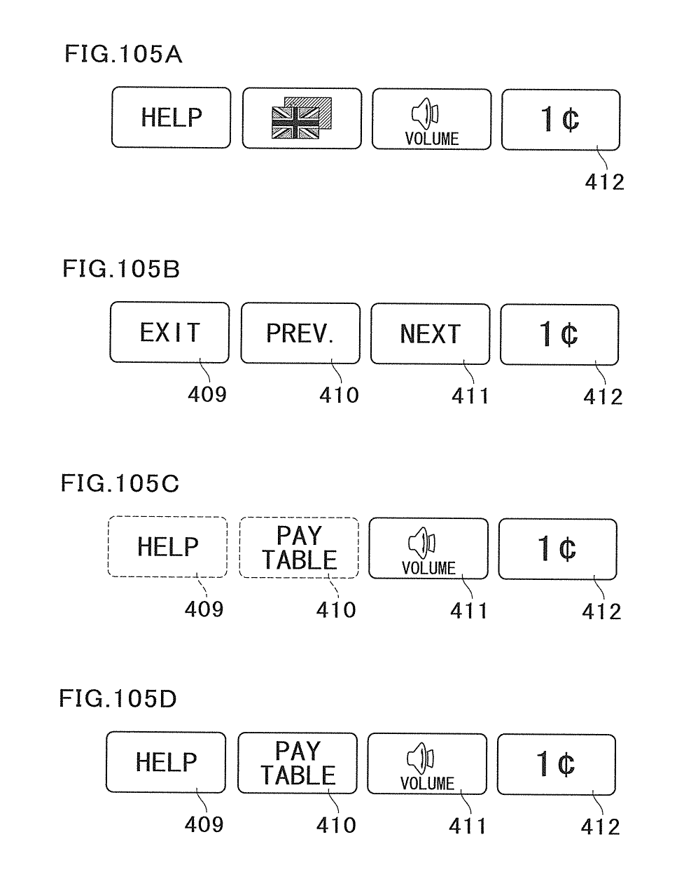

FIG. 104A shows the layout of the screen touch buttons during IDLE. FIG. 104B shows the layout of the screen touch buttons during HELP. FIG. 104C shows the layout of the screen touch buttons while the game is in progress. FIG. 104D is the layout of the screen touch buttons in the state of GAMBLE or TAKE WIN. FIG. 105A shows the layout of the screen touch buttons in IDLE (language switching disabled). FIG. 105B shows the layout of the screen touch buttons in HELP (language switching disabled). FIG. 105C shows the layout of the screen touch buttons during the game (language switching disabled). FIG. 105D shows the layout of the screen touch buttons in the state of GAMBLE or TAKE WIN (language switching disabled).

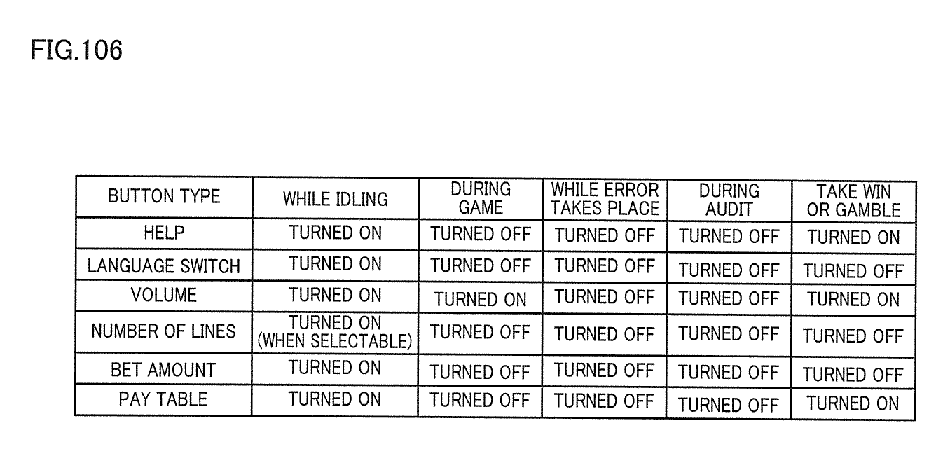

In the layout of the screen touch buttons in the slot machine 1, a help touch button 409, a language switching touch button 410, a sound volume switching touch button 411a, a denomination indicator 412, an EXIT touch button 414, a PREV. touch button 415, or NEXT touch button 416 is provided. In particular, when the language switching is disabled and the game is in progress or the state is in GAMBLE or TAKE WIN, as shown in FIGS. 105C and 105D, a paytable touch button 504 is provided. These touch buttons are active when turned on and inactive when turned off as shown in FIG. 106.

[Sound Volume Switching Touch Button]

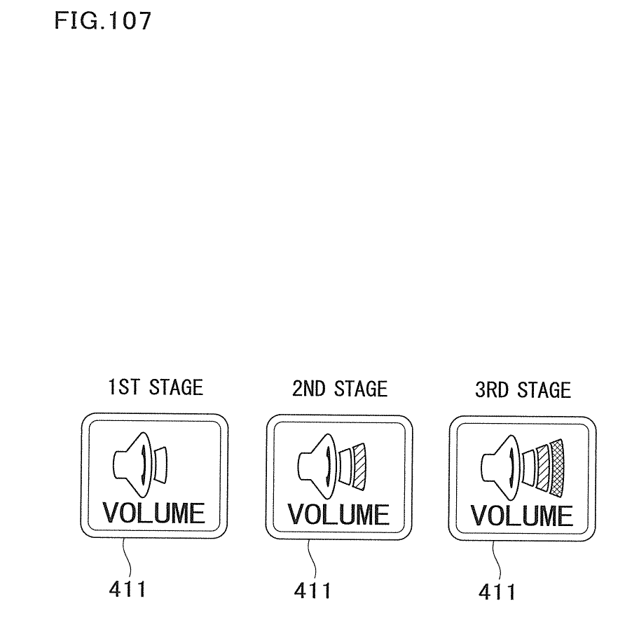

Now, referring to FIG. 107, the following will describe the sound volume switching touch button 411 of the slot machine 1. FIG. 107 illustrates the sound volume switching touch button of the slot machine of the embodiment of the present invention. As shown in FIG. 107, the sound volume switching touch button 411 is used for selecting one of the first-stage minimum volume, second-stage intermediate volume, and third-stage maximum volume. The sound volume is set at the first-stage minimum volume in the initial setting. Each time the player touches the sound volume switching touch button 411, the sound volume is changed to the second-stage intermediate volume, to the third-stage maximum volume, to the first-stage minimum volume, and to the second-stage intermediate volume, in a looped manner.

[AUDIT National Flag Switch Setting]

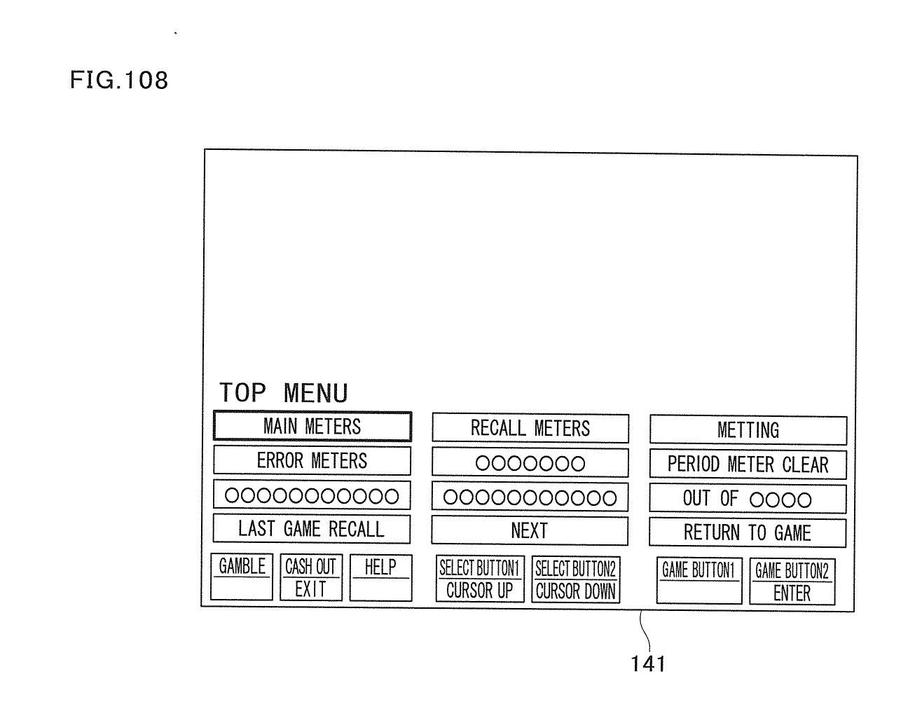

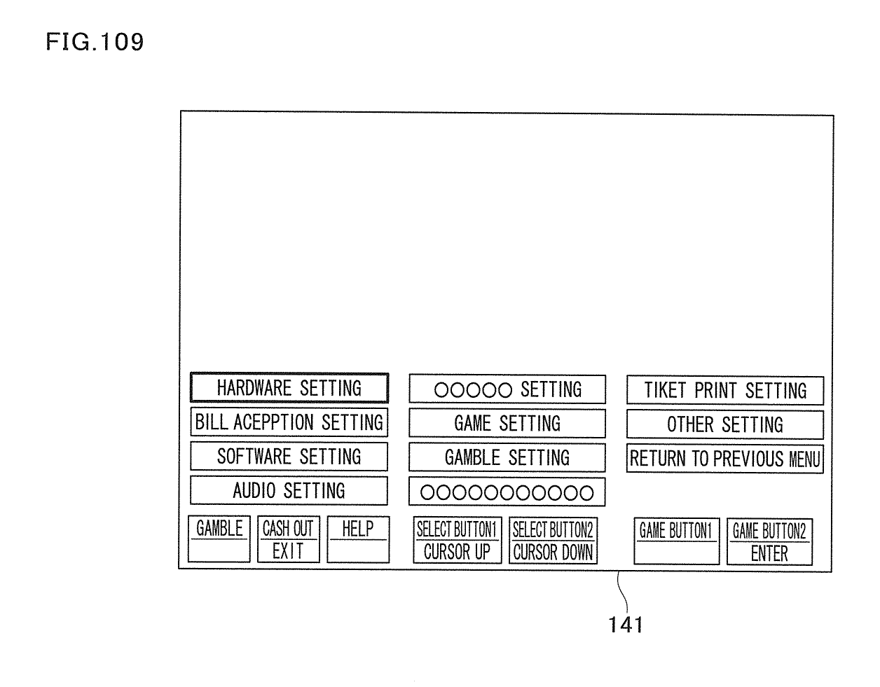

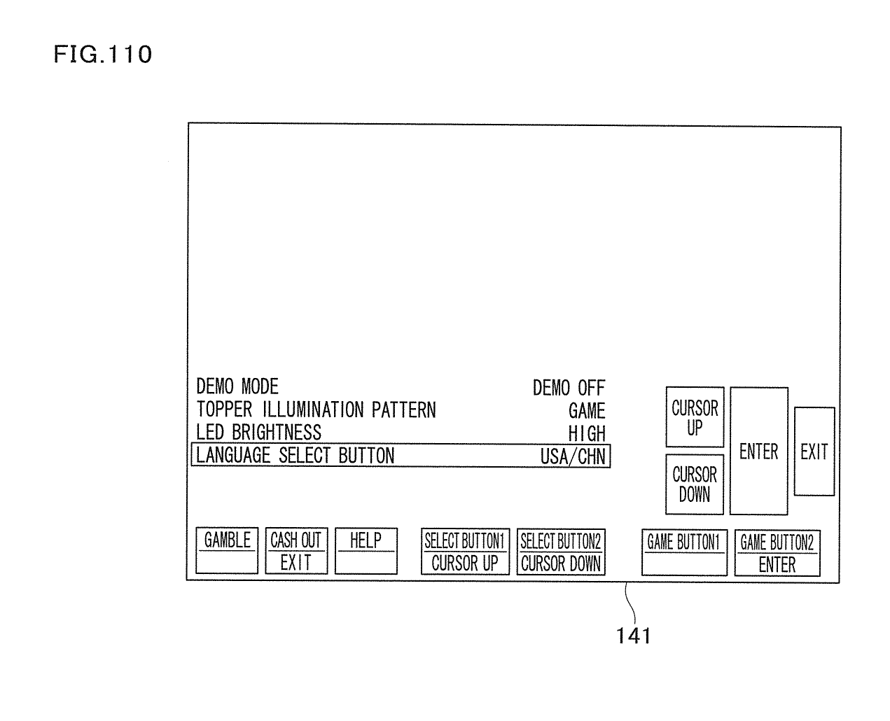

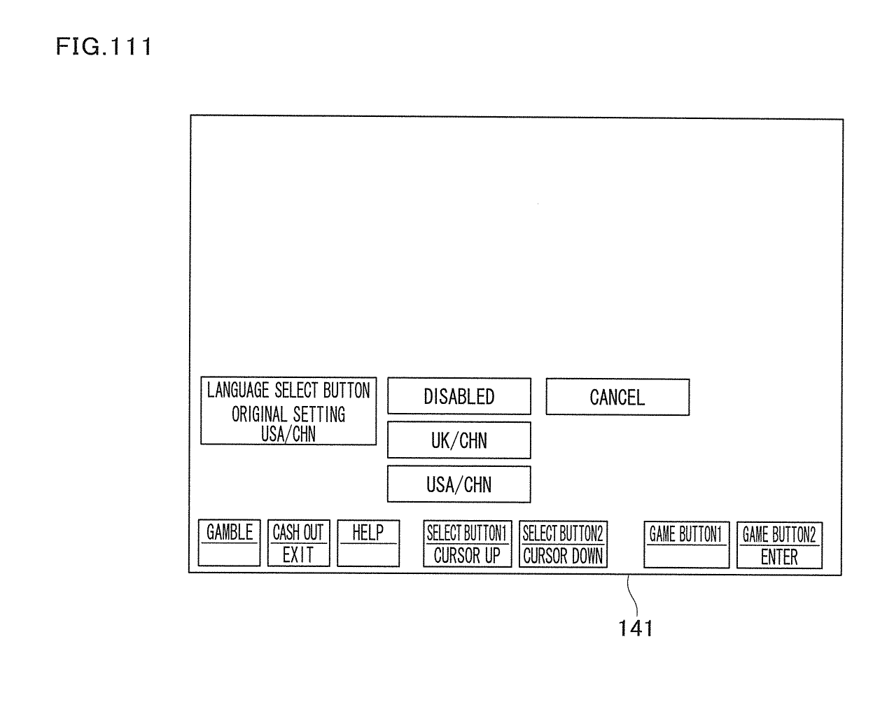

Now, referring to FIG. 108 to FIG. 111, AUDIT national flag switch setting of the slot machine 1 will be described. Each of FIG. 108 to FIG. 111 shows the AUDIT national flag switch setting in the slot machine of the embodiment of the present invention. On the lower image display panel 141 shown in FIG. 108 to FIG. 111, the AUDIT national flag switch setting of the slot machine of the embodiment of the present invention makes it possible to specify, by the AUDIT MENU, the “national flag” displayed on the language switching touch button 410 when switching the language. The “national flag” displayed on the language switching touch button 410 is one of the national flags, of U.S.A., U.K., and China.

(Outline of P15-0045)

P15-0045 relates to a gaming machine capable of running a free game.

Traditionally, in a facility where gaming machines such as slot machines and the like are set up, games are played by betting various types of gaming medium such as a credit and the like in the slot machines. In each slot machine are set a plurality of result determination areas (areas for which determination of win or loss is carried out) on which a bet is placeable, and a payout or a free game is awarded based on the number of result determination areas on which a bet is placed, the number of bet credits, and the game result.

Further, amongst the slot machines are those configured to perform an awarding (rescue) to the player, when the number of plays of the normal game resulting no benefit reaches a predetermined number. For example, a payout or a free game is awarded when the number of plays of the normal game resulting in no benefit reaches a predetermined value (so-called ceiling number).

However, a player may feel the sense of unfairness, if a free game awarded as rescue and a free game awarded based on a game result of a normal game are executed based on different payout amounts or different winning probabilities, even if they are both free games.

An object of the present invention is to provide a gaming machine capable of running a free game under the same condition irrespective of the way of shifting to the free game.

The present invention relates to a gaming machine including: a result determination area input device configured to allow selection of any of result determination areas;

a display device configured to display a result of a normal game and a result of a free game by rearranging symbols in the result determination area;
a storage unit configured to store, for the respective result determination areas, result determination area counters each counting the number of game play incremented at the start of the normal game,
for each of the result determination area counters, a threshold game play count indicating how long does it take until awarding of the right to run the free game,
free game payout rate random determination tables in which payout rates are associated with random determination probabilities, and
a free game payout rate random determination table determination table in which the free game payout rate random determination tables are associated with the result determination areas; and
a controller programmed to execute the processes of:
(1a) accepting the selection of a result determination area by the result determination area input device;
(1b) incrementing the number of game play in the result determination area counter corresponding to the result determination area selected in the process (1a), at the start of the normal game;
(1c) on the display device, displaying the result of the normal game by rearranging the symbols in the result determination area selected in the process (1a), and awarding the right to execute the free game when a predetermined condition is satisfied by the displayed result of the normal game;
(1d) determining whether the number of game play in the result determination area counter reaches the threshold game play count, and awarding the right to run the free game for a predetermined number of times when the number of game play reaches the threshold game play count;
(1e) when running the free game awarded in the process (1c), selecting one of the free game payout rate random determination tables based on the result determination area selected in the normal game in which the predetermined condition is satisfied and the free game payout rate random determination table determination table,
and when running the free game awarded in the process (1d), selecting one of the free game payout rate random determination tables based on the result determination area corresponding to the result determination area counter reaching the threshold game play count in the process (1d) and the free game payout rate random determination table determination table;
(1f) based on the free game payout rate random determination table selected in the process (1e), randomly determining the payout rate; and
(1g) running the free game and awarding, as a free game payout, a value calculated by multiplying the payout based on the result of the free game by the payout rate determined in the process (1f).

According to the arrangement above, the free game awarded when a predetermined condition is satisfied in the normal game and the free game awarded when the number of game play in the result determination area counter reaches the threshold game play count are able to share the free game payout rate random determination table for determining the payout rate for multiplication in the free game and the free game payout rate random determination table determination table for determining the free game payout rate random determination table.

On this account, the free game is run on the same conditions irrespective of the way of shifting to the free game (i.e., the free game is enjoyed without feeling the sense of unfairness).

In the present invention, the gaming machine is arranged such that,

the payout rates are provided in stages from a low payout rate to a high payout rate, and the controller is programmed to further execute the process of
after determining the payout rate in the process (1f), displaying the payout rates step by step on the display device from the low payout rate to the determined payout rate.

According to this arrangement, on the display device, a process that a low payout rate is changed to the determined payout rate is displayed step by step. In this way, an effect that the payout rate progresses is performed. This increases the expectation on the free game payout awarded in the free game.

In the present invention, the gaming machine is arranged such that,

the symbols include plural types of symbols from a symbol corresponding to the low payout rate to a symbol corresponding to the high payout rate, and
the controller is programmed to further execute the process of
after determining the payout rate in the process (1f), changing the type of the symbols from the symbol corresponding to the low payout rate to the symbol corresponding to the determined payout rate.

According to the arrangement above, the type of the symbols is changed from the symbol corresponding to the low payout rate to the symbol corresponding to the determined payout rate. As such, an effect that the symbol corresponding to the payout rate progresses is performed. This increases the expectation on the free game payout awarded in the free game.

The present invention relates to a method of controlling a gaming machine which includes: a result determination area input device configured to allow selection of any of result determination areas;

a display device configured to display a result of a normal game and a result of a free game by rearranging symbols in the result determination area;
a storage unit configured to store, for the respective result determination areas, result determination area counters each counting the number of game play incremented at the start of the normal game;
for each of the result determination area counters, a threshold game play count indicating how long does it take until awarding of the right to run the free game,
free game payout rate random determination tables in which payout rates are associated with random determination probabilities, and
a free game payout rate random determination table determination table in which the free game payout rate random determination tables are associated with the result determination areas; and a controller,
the method comprising, under control of the controller, the steps of:
(1a) accepting the selection of a result determination area by the result determination area input device;
(1b) incrementing the number of game play of the result determination area counter corresponding to the result determination area selected in the step (1a), at the start of the normal game;
(1c) on the display device, displaying the result of the normal game by rearranging the symbols in the result determination area selected in the step (1a), and awarding the right to execute the free game when a predetermined condition is satisfied by the displayed result of the normal game;
(1d) determining whether the number of game play in the result determination area counter reaches the threshold game play count, and awarding the right to run the free game for a predetermined number of times when the number of game play reaches the threshold game play count;
(1e) when running the free game awarded in the step (1c), selecting one of the free game payout rate random determination tables based on the result determination area selected in the normal game in which the predetermined condition is satisfied and the free game payout rate random determination table determination table, and
when running the free game awarded in the step (1d), selecting one of the free game payout rate random determination tables based on the result determination area corresponding to the result determination area counter reaching the threshold game play count in the step (1d) and the free game payout rate random determination table determination table;
(1f) based on the free game payout rate random determination table selected in the step (1e), randomly determining the payout rate; and
(1g) running the free game and awarding, as a free game payout, a value calculated by multiplying the payout based on the result of the free game by the payout rate determined in the step (1f).

According to the method above, the free game awarded when a predetermined condition is satisfied in the normal game and the free game awarded when the number of game play in the result determination area counter reaches the threshold game play count are able to share the free game payout rate random determination table for determining the payout rate for multiplication in the free game and the free game payout rate random determination table determination table for determining the free game payout rate random determination table.

On this account, the free game is run on the same conditions irrespective of the way of shifting to the free game (i.e., the free game is enjoyed without feeling the sense of unfairness).

[Other Notes]

Further, the detailed description above is mainly focused on characteristics of the present invention to for the sake of easier understanding. The present invention is not limited to the above embodiment, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the invention described in the present specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process executed in or by respective steps yielding one result or blocks with a predetermined processing function described in the present specification shall be understood as a process with no self-contradiction. Further, the electrical or magnetic signal is transmitted/received and written in the respective steps. It should be noted that such a signal is expressed in the form of bit, value, symbol, text, terms, number, or the like solely for the sake of convenience. Although the present specification occasionally personifies the processes carried out in the steps, these processes are essentially executed by various devices. Further, the other structures necessary for the steps are obvious from the above descriptions.

What is claimed is:

1. A gaming machine comprising:
an input device configured to allow selection of a condition required to start a normal game from plural start conditions;
a display device configured to display a result of the normal game and a result of a free game;
a storage unit configured to store, for the respective start conditions, counters each counting the number of game play incremented at the start of the normal game, and store, for each of the counters, a threshold game play count indicating how long does it take until awarding of the right to run the free game; and
a controller programmed to execute the processes of:
(1a) accepting the selection of a condition required to start the normal game from the plural start conditions by the input device;
(1b) incrementing the number of game play in the counter corresponding to the start condition selected in the process (1a), at the start of the normal game;
(1c) awarding a benefit based on the result of the normal game displayed on the display device and the start condition selected in the process (1a);
(1d) determining whether the number of game play in the counter reaches the threshold game play count, and awarding the right to run the free game for a predetermined number of times when the number of game play reaches the threshold game play count; and
(1e) in the free game, based on the result of the free game displayed on the display device and the start condition corresponding to the counter reaching the threshold game play count in the process (1d), awarding the benefit.

2. A gaming machine comprising:
a credit type input device configured to allow betting with plural credit types which are different in a credit amount;
a display device configured to display a result of a normal game and a result of a free game by rearranging symbols;
a storage unit configured to store, for the respective credit types, credit type counters each counting the number of game play incremented at the start of the normal game, and store, for each of the credit type counters, a threshold game play count indicating how long does it take until awarding of the right to run the free game; and
a controller programmed to execute the processes of:
(2a) accepting betting with a credit type by the credit type input device;
(2b) at the start of the normal game, incrementing the number of game play in the credit type counter corresponding to the credit type with which the betting is performed in the process (2a);
(2c) awarding a payout based on the result of the normal game displayed on the display device and the credit type with which the betting is performed in the process (2a);
(2d) determining whether the number of game play in the credit type counter reaches the threshold game play count, and awarding the right to run the free game for a predetermined number of times when the number of game play reaches the threshold game play count; and
(2e) in the free game, based on the result of the free game displayed on the display device and the credit type corresponding to the credit type counter reaching the threshold game play count in the process (2d), awarding the payout.

3. The gaming machine according to claim 2, wherein,
the controller is programmed to award the right to run the free game for the predetermined number of times when, in the process (2c), a predetermined condition is satisfied by the result of the normal game displayed on the display device.

4. The gaming machine according to claim 2, wherein,
the controller is programmed to further execute the processes of:
(2f) when the number of game play in the credit type counter reaches the threshold game play count, displaying a combination of predetermined symbols on the display device;
(2g) when a predetermined condition is satisfied by the result of the normal game, awarding the right to run the free game for the predetermined number of times; and
(2h) when the predetermined condition is satisfied by the result of the normal game, displaying the combination of the predetermined symbols on the display device.

5. A gaming machine comprising:
a result determination area input device configured to allow selection of any of result determination areas;
a display device configured to display a result of a normal game and a result of a free game by rearranging symbols in the selected result determination area;
a storage unit configured to store, for the respective result determination areas, result determination area counters each counting the number of game play incremented at the start of the normal game, and store, for each of the result determination area counters, a threshold game play count indicating how long does it take until awarding of the right to run the free game; and
a controller programmed to execute the processes of:
(3a) accepting the selection of a result determination area by the result determination area input device;
(3b) incrementing the number of game play in the result determination area counter corresponding to the result determination area selected in the process (3a), at the start of the normal game;
(3c) on the display device, displaying the result of the normal game by rearranging the symbols in the result determination area selected in the process (3a), and awarding a payout based on the displayed result of the normal game;
(3d) determining whether the number of game play in the result determination area counter reaches the threshold game play count, and awarding the right to run the free game for a predetermined number of times when the number of game play reaches the threshold game play count; and
(3e) in the free game, displaying, on the display device, the result of the free game by rearranging the symbols in the result determination area corresponding to the result determination area counter reaching the threshold game play count in the process (3d), and awarding the payout based on the displayed result of the free game.

6. The gaming machine according to claim 5, wherein,
in the process (3c), the controller awards the right to execute the free game for the predetermined number of times, when a predetermined condition is satisfied by the result of the normal game displayed on the display device.

7. The gaming machine according to claim 5, wherein,
the controller is programmed to further execute the processes of:
(3f) displaying a combination of predetermined symbols on the display device when the number of game play in the result determination area counter reaches the threshold game play count;
(3g) awarding the right to execute the free game for the predetermined number of times when a predetermined condition is satisfied by the result of the normal game; and
(3h) displaying the combination of the predetermined symbols on the display device when the predetermined condition is satisfied by the result of the normal game.

8. A gaming machine comprising:
a credit type input device configured to allow betting with plural credit types which are different in a credit amount;
a result determination area input device configured to allow selection of any of result determination areas;
a display device configured to display a result of a normal game and a result of a free game by rearranging symbols in the selected result determination area;
a storage unit configured to store, for the respective credit types corresponding to the result determination areas, game play counters each counting the number of game play incremented at the start of the normal game, and store, for each of the game play counters, a threshold game play count indicating how long does it take until awarding of the right to run the free game; and
a controller programmed to execute the processes of:
(4a) accepting betting with a credit type by the credit type input device, and accepting the selection of a result determination area by the result determination area input device;
(4b) incrementing the number of game play in the game play counter corresponding to the result determination area and the credit type accepted in the process (4a), at the start of the normal game;
(4c) awarding a payout based on the result of the normal game displayed on the display device and the credit type and the result determination area accepted in the process (4a);
(4d) determining whether the number of game play in the game play counter reaches the threshold game play count, and awarding the right to run the free game for a predetermined number of times when the number of game play reaches the threshold game play count; and
(4e) in the free game, awarding a payout based on the result of the free game displayed on the display device and the result determination area and the credit type corresponding to the game play counter reaching the threshold game play count in the process (4d).

9. The gaming machine according to claim 8, wherein,
in the process (4c), the controller awards the right to execute the free game for the predetermined number of times, when a predetermined condition is satisfied by the result of the normal game displayed on the display device.

10. The gaming machine according to claim 8, wherein,
the controller is programmed to further execute the processes of:
(4f) displaying a combination of predetermined symbols on the display device when the number of game play in the game play counter reaches the threshold game play count;
(4g) awarding the right to execute the free game for the predetermined number of times when a predetermined condition is satisfied by the result of the normal game; and
(4h) displaying the combination of the predetermined symbols on the display device when the predetermined condition is satisfied by the result of the normal game.

11. The gaming machine according to claim 8, wherein,
the controller is programmed to further execute the process of resetting the number of game play in the game play counter reaching the threshold game play count, after the process (4c).

12. A method of controlling a gaming machine which includes:
an input device configured to allow selection of a condition required to start a normal game from plural start conditions;
a display device configured to display a result of the normal game and a result of a free game;
a storage unit configured to store, for the respective start conditions, counters each counting the number of game play incremented at the start of the normal game, and store, for each of the counters, a threshold game play count indicating how long does it take until awarding of the right to run the free game; and
a controller,
the method comprising, under control of the controller, the steps of:
(1a) accepting the selection of a condition required to start the normal game from the plural start conditions by the input device;
(1b) incrementing the number of game play of the counter corresponding to the start condition selected in the step (1a), at the start of the normal game;
(1c) awarding a benefit based on the result of the normal game displayed on the display device and the start condition selected in the step (1a);
(1d) determining whether the number of game play in the counter reaches the threshold game play count, and awarding the right to run the free game for a predetermined number of times when the number of game play reaches the threshold game play count; and
(1e) in the free game, based on the result of the free game displayed on the display device and the start condition corresponding to the counter reaching the threshold game play count in the step (1d), awarding the benefit.

13. A gaming machine comprising:
a result determination area input device configured to allow selection of any of result determination areas;
a display device configured to display a result of a normal game and a result of a free game by rearranging symbols in the result determination area;
a storage unit configured to store,
for the respective result determination areas, result determination area counters each counting the number of game play incremented at the start of the normal game,
for each of the result determination area counters, a threshold game play count indicating how long does it take until awarding of the right to run the free game,
free game payout rate random determination tables in which payout rates are associated with random determination probabilities, and
a free game payout rate random determination table determination table in which the free game payout rate random determination tables are associated with the result determination areas; and
a controller programmed to execute the processes of:
(1a) accepting the selection of a result determination area by the result determination area input device;
(1b) incrementing the number of game play in the result determination area counter corresponding to the result determination area selected in the process (1a), at the start of the normal game;
(1c) on the display device, displaying the result of the normal game by rearranging the symbols in the result determination area selected in the process (1a), and awarding the right to execute the free game when a predetermined condition is satisfied by the displayed result of the normal game;
(1d) determining whether the number of game play in the result determination area counter reaches the threshold game play count, and awarding the right to run the free game for a predetermined number of times when the number of game play reaches the threshold game play count;
(1e) when running the free game awarded in the process (1c), selecting one of the free game payout rate random determination tables based on the result determination area selected in the normal game in which the predetermined condition is satisfied and the free game payout rate random determination table determination table, and when running the free game awarded in the process (1d), selecting one of the free game payout rate random determination tables based on the result determination area corresponding to the result determination area counter reaching the threshold game play count in the process (1d) and the free game payout rate random determination table determination table;
(1f) based on the free game payout rate random determination table selected in the process (1e), randomly determining the payout rate; and
(1g) running the free game and awarding, as a free game payout, a value calculated by multiplying the payout based on the result of the free game by the payout rate determined in the process (1f).

14. The gaming machine according to claim 13, wherein,
the payout rates are provided in stages from a low payout rate to a high payout rate, and
the controller is programmed to further execute the process of
after determining the payout rate in the process (1f), displaying the payout rates step by step on the display device from the low payout rate to the determined payout rate.

15. The gaming machine according to claim 14, wherein,
the symbols include plural types of symbols from a symbol corresponding to the low payout rate to a symbol corresponding to the high payout rate, and
the controller is programmed to further execute the process of,
after determining the payout rate in the process (1f), changing the type of the symbol step by step from the symbol corresponding to the low payout rate to the symbol corresponding to the determined payout rate.

16. A method of controlling a gaming machine which includes:
a result determination area input device configured to allow selection of any of result determination areas;
a display device configured to display a result of a normal game and a result of a free game by rearranging symbols in the result determination area;
a storage unit configured to store,
for the respective result determination areas, result determination area counters each counting the number of game play incremented at the start of the normal game,
for each of the result determination area counters, a threshold game play count indicating how long does it take until awarding of the right to run the free game,
free game payout rate random determination tables in which payout rates are associated with random determination probabilities, and
a free game payout rate random determination table determination table in which the free game payout rate random determination tables are associated with the result determination areas; and
a controller,
the method comprising, under control of the controller, the steps of:
(1a) accepting the selection of a result determination area by the result determination area input device;
(1b) incrementing the number of game play in the result determination area counter corresponding to the result determination area selected in the step (1a), at the start of the normal game;
(1c) on the display device, displaying the result of the normal game by rearranging the symbols in the result determination area selected in the step (1a), and awarding the right to execute the free game when a predetermined condition is satisfied by the displayed result of the normal game;
(1d) determining whether the number of game play in the result determination area counter reaches the threshold game play count, and awarding the right to run the free game for a predetermined number of times when the number of game play reaches the threshold game play count;
(1e) when running the free game awarded in the step (1c), selecting one of the free game payout rate random determination tables based on the result determination area selected in the normal game in which the predetermined condition is satisfied and the free game payout rate random determination table determination table, and when running the free game awarded in the step (1d), selecting one of the free game payout rate random determination tables based on the result determination area corresponding to the result determination area counter reaching the threshold game play count in the step (1d) and the free game payout rate random determination table determination table;
(1f) based on the free game payout rate random determination table selected in the step (1e), randomly determining the payout rate; and
(1g) running the free game and awarding, as a free game payout, a value calculated by multiplying the payout based on the result of the free game by the payout rate determined in the step (1f).
